(19) United States
(12) Patent Application Publication
(10) Pub. No.: US 2024/0406634 A1
(43) Pub. Date: Dec. 5, 2024

(54) VIBRATION COMPONENTS

(71) Applicant: SHENZHEN SHOKZ CO., LTD., Shenzhen (CN)

(72) Inventors: Wenbing ZHOU, Shenzhen (CN); Fengyun LIAO, Shenzhen (CN); Xin QI, Shenzhen (CN); Shanyong GU, Beijing (CN)

(73) Assignee: SHENZHEN SHOKZ CO., LTD., Shenzhen (CN)

(21) Appl. No.: 18/798,768

(22) Filed: Aug. 8, 2024

Related U.S. Application Data
(63) Continuation of application No. PCT/CN2023/113720, filed on Aug. 18, 2023.

(30) Foreign Application Priority Data
Aug. 20, 2022 (CN) 202211003675.2

(51) Int. Cl. H04R 7/06

(52) U.S. Cl. CPC H04R 7/06

(57) ABSTRACT

The present disclosure provides a vibration component, comprising an elastic element. The elastic element includes a central region, a folded ring region disposed at a periphery of the central region, and a fixed region disposed at a periphery of the folded ring region. The elastic element is configured to vibrate in a direction perpendicular to the central region. The central region includes an elastic member and a reinforcing member stacked in a vibration direction. The reinforcing member is provided with a plurality of groove structures whose openings face the elastic member.

### CROSS-REFERENCE TO RELATED APPLICATIONS

This application is a Continuation of International Application No. PCT/CN2023/113720, filed on Aug. 18, 2023, which claims priority to Chinese Application No. 202211003675.2, filed on Aug. 20, 2022, the entire contents of each of which are incorporated herein by reference.

### TECHNICAL FIELD

The present disclosure relates to the field of acoustic technology, and in particular, to a vibration component.

### BACKGROUND

The loudspeaker generally includes three core portions: the driving portion, the vibration portion, and the support auxiliary portion. The vibration portion is also the load portion of the loudspeaker, and mainly includes the vibration component, including an elastic element such as a diaphragm. The vibration portion is an important portion of the loudspeaker. If the driving force of the driving portion is determined, relatively good mechanical impedance matching between the load portion and the driving portion can be realized by reasonably designing the vibration portion, thereby achieving the output effect of high sound pressure level and wide bandwidth.

The stiffness of the central region of the vibration diaphragm can be increased by setting a layer of mass stiffness structure, usually metal, such as an aluminum alloy, stainless steel, a titanium alloy, a magnesium alloy, a magnesium-aluminum alloy, or the like, in the central region of the elastic element, to avoid the acoustic cancellation caused by the situation that different parts of the central region of the vibration diaphragm vibrates asynchronously within a range of 20 Hz-20 kHz. However, the overall mass of the vibration component may be increased by directly disposing the mass stiffness structure in the central region of the elastic element, causing an increase in the load of the loudspeaker and impedance mismatch between the driving portion and the load portion, thus reducing the sound pressure level output by the loudspeaker.

Therefore, it is desirable to provide a vibration component in which a reinforcing member including a plurality of groove structures is reasonably provided in the central region of the elastic element.

### SUMMARY

One of the embodiments of the present disclosure provides a vibration component, comprising: an elastic element including a central region, a folded ring region disposed at a periphery of the central region, and a fixed region disposed at a periphery of the folded ring region. The elastic element may be configured to vibrate in a direction perpendicular to the central region. The central region may include an elastic member and a reinforcing member stacked in a vibration direction. The reinforcing member may be provided with a plurality of groove structures whose openings face the elastic member.

In some embodiments, a hollow structure may be disposed in a region of the reinforcing member apart from the plurality of groove structures.

In some embodiments, in the vibration direction, a ratio of a projection area of the reinforcing member to a projection area of the central region may be within a range of 0.15-0.8.

In some embodiments, in the vibration direction, the ratio of the projection area of the reinforcing member to the projection area of the central region may be within a range of 0.35-0.65.

In some embodiments, when vibrating, the vibration component may have a resonance peak at least within a range of 10000 Hz-20000 Hz.

In some embodiments, each of the plurality of groove structures may have a height dimension in the vibration direction. A side wall of each of the plurality of groove structures may have a thickness dimension. A ratio of the height dimension to the thickness dimension may not be less than 7.14.

In some embodiments, the ratio of the height dimension to the thickness dimension may not be less than 9.

In some embodiments, when vibrating, the vibration component may have a resonance peak at least within a range of 5000 Hz-10000 Hz.

In some embodiments, each of the plurality of groove structures may have the height dimension in the vibration direction, and the height dimension may be within a range of 50 μm-500 μm.

In some embodiments, the height dimension may be within a range of 200 μm-350 μm.

In some embodiments, the side wall of each of the plurality of groove structures may have the thickness dimension, and the thickness dimension may not be greater than 50 μm.

In some embodiments, the thickness dimension may not be greater than 40 μm.

In some embodiments, a skirt structure extending along a surface of the elastic member may be disposed around the opening of each of the plurality of groove structures, and a width of the skirt structure may be within a range of 100 μm-300 μm.

In some embodiments, the width of the skirt structure may be within a range of 100 μm-200 μm.

In some embodiments, a shape of each of the plurality of groove structures may include at least one of a U-shape, a T-shape, an I-shape, and a cone.

In some embodiments, a Young's modulus of a material of the reinforcing member may be greater than a Young's modulus of a material of the elastic member.

In some embodiments, the material of the reinforcing member may be the same as the material of the elastic member.

In some embodiments, a filling material may be disposed in each of the plurality of groove structures. A Young's modulus of the filling material may be less than the Young's modulus of the material of the reinforcing member.

One of the embodiments of the present disclosure further provides a vibration component, comprising: an elastic element including a central region, a folded ring region disposed at a periphery of the central region, and a fixed region disposed at a periphery of the folded ring region. The elastic element may be configured to vibrate in a direction perpendicular to the central region. The central region may include an elastic region and a reinforcing region arranged side by side. The reinforcing region may be provided with a plurality of groove structures whose openings face the vibration direction.

In some embodiments, in the vibration direction, a ratio of a projection area of the reinforcing region to a projection area of the central region may be within a range of 0.15-0.8.

In some embodiments, in the vibration direction, the ratio of the projection area of the reinforcing region to the projection area of the central region may be within a range of 0.35-0.65.

In some embodiments, when vibrating, the vibration component may have a resonance peak at least within a range of 10000 Hz-20000 Hz.

In some embodiments, each of the plurality of groove structures may have a height dimension in the vibration direction. A side wall of each of the plurality of groove structures may have a thickness dimension. A ratio of the height dimension to the thickness dimension may not be less than 7.14.

In some embodiments, the ratio of the height dimension to the thickness dimension may not be less than 9.

In some embodiments, when vibrating, the vibration component may have a resonance peak at least within a range of 5000 Hz-10000 Hz.

In some embodiments, each of the plurality of groove structures may have the height dimension in the vibration direction, and the height dimension may be within a range of 50 μm-500 μm.

In some embodiments, the height dimension may be within a range of 200 μm-350 μm.

In some embodiments, the side wall of each of the plurality of groove structures may have the thickness dimension, and the thickness dimension may not be greater than 50 μm.

In some embodiments, the thickness dimension may not be greater than 40 μm.

In some embodiments, a skirt structure connected with the elastic region may be disposed around the opening of each of the plurality of groove structures, and a width of the skirt structure may be within a range of 100 μm-300 μm.

In some embodiments, the width of the skirt structure may be within a range of 100 μm-200 μm.

In some embodiments, a shape of each of the plurality of groove structures may include at least one of a U-shape, a T-shape, an I-shape, and a conc.

In some embodiments, a Young's modulus of a material of the reinforcing region may be greater than a Young's modulus of a material of the elastic region.

In some embodiments, the material of the reinforcing region may be the same as the material of the elastic region.

In some embodiments, a filling material may be disposed in each of the plurality of groove structures, and a Young's modulus of the filling material may be less than the Young's modulus of the material of the elastic region.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an exemplary vibration component and an equivalent vibration model thereof according to some embodiments of the present disclosure;

FIG. 2 is a schematic diagram illustrating a deformation of a first resonance peak of a vibration component according to some embodiments of the present disclosure;

FIG. 3 is a schematic diagram illustrating a deformation of a second resonance peak of a vibration component according to some embodiments of the present disclosure;

FIG. 4 is a schematic diagram illustrating a deformation of a third resonance peak of a vibration component according to some embodiments of the present disclosure;

FIG. 5A is a schematic diagram illustrating a frequency response curve of a vibration component according to some embodiments of the present disclosure;

FIG. 5B is a schematic diagram illustrating a frequency response curve of a vibration component without third resonance peak according to some embodiments of the present disclosure;

FIG. 6 is a schematic diagram illustrating frequency response curves of a vibration component including a plurality of groove structures and a vibration component not including the plurality of groove structures according to some embodiments of the present disclosure;

FIG. 7A is a schematic diagram illustrating a reinforcing member including a plurality of groove structures and an elastic element according to some embodiments of the present disclosure;

FIG. 7B is a schematic diagram illustrating a reinforcing member including a plurality of groove structures and an elastic element according to some embodiments of the present disclosure;

FIG. 7C is a schematic diagram illustrating a reinforcing member including a plurality of groove structures and an elastic element according to some embodiments of the present disclosure;

FIG. 7D is a schematic diagram illustrating a reinforcing member including a plurality of groove structures and an elastic element according to some embodiments of the present disclosure;

FIG. 7E is a schematic diagram illustrating a reinforcing member including a plurality of groove structures and an elastic element according to some embodiments of the present disclosure;

FIG. 7F is a schematic diagram illustrating a reinforcing member including a plurality of groove structures and an elastic element according to some embodiments of the present disclosure;

FIG. 7G is a schematic diagram illustrating a reinforcing member including a plurality of groove structures and an elastic element according to some embodiments of the present disclosure;

FIG. 8 is a schematic diagram illustrating a plurality of groove structures according to some embodiments of the present disclosure;

FIG. 9 is a schematic diagram illustrating a frequency response curve of a vibration component according to some embodiments of the present disclosure;

FIG. 10 is schematic diagram illustrating frequency response curves of a vibration component corresponding to different heights of a reinforcing member according to some embodiments of the present disclosure;

FIG. 11 is schematic diagram illustrating frequency response curves of a vibration component corresponding to different thicknesses of a reinforcing member according to some embodiments of the present disclosure;

FIG. 12 is a schematic diagram illustrating a skirt structure according to some embodiments of the present disclosure;

FIG. 13 is a schematic diagram illustrating frequency response curves of a vibration component corresponding to a reinforcing member with different widths of skirt structures according to some embodiments of the present disclosure;

FIG. 14A is a schematic diagram illustrating a process of preparing a reinforcing member made of a non-metallic material according to some embodiments of the present disclosure;

FIG. 14B is a schematic diagram illustrating a model corresponding to FIG. 14A;

FIG. 15A is a schematic diagram illustrating a process of preparing a reinforcing member made of a metallic material according to some embodiments of the present disclosure;

FIG. 15B is a schematic diagram illustrating a model corresponding to FIG. 14A;

FIG. 16 is a schematic diagram illustrating an exemplary vibration component including a reinforcing member with a single ring structure according to some embodiments of the present disclosure;

FIG. 17 is a schematic diagram illustrating a local structure of a vibration component according to some embodiments of the present disclosure;

FIG. 18 is a schematic diagram illustrating a deformation of a second resonance peak of a vibration component according to some embodiments of the present disclosure;

FIG. 19 is a schematic diagram illustrating a deformation of a third resonance peak of a vibration component according to some embodiments of the present disclosure;

FIG. 20 is a schematic diagram illustrating frequency response curves of a vibration component shown in FIG. 19;

FIG. 21 is a schematic diagram illustrating frequency response curves of a vibration component according to some embodiments of the present disclosure;

FIG. 22A is a schematic diagram illustrating an exemplary vibration component according to some embodiments of the present disclosure;

FIG. 22B is a schematic diagram illustrating an exemplary vibration component according to some embodiments of the present disclosure;

FIG. 23A is a schematic diagram illustrating an exemplary vibration component according to some embodiments of the present disclosure;

FIG. 23B is a schematic diagram illustrating an exemplary vibration component according to some embodiments of the present disclosure;

FIG. 23C is a schematic diagram illustrating an exemplary vibration component according to some embodiments of the present disclosure;

FIG. 23D is a schematic diagram illustrating an exemplary vibration component according to some embodiments of the present disclosure;

FIG. 24A is a schematic diagram illustrating an exemplary vibration component according to some embodiments of the present disclosure;

FIG. 24B is a schematic diagram illustrating an exemplary vibration component according to some embodiments of the present disclosure;

FIG. 25A is a schematic diagram illustrating an exemplary vibration component according to some embodiments of the present disclosure;

FIG. 25B is a schematic diagram illustrating an exemplary vibration component according to some embodiments of the present disclosure;

FIG. 25C is a schematic diagram illustrating an exemplary vibration component according to some embodiments of the present disclosure;

FIG. 25D is a schematic diagram illustrating an exemplary vibration component according to some embodiments of the present disclosure;

FIG. 25E is a schematic diagram illustrating an exemplary vibration component according to some embodiments of the present disclosure;

FIG. 26A is a schematic diagram illustrating an exemplary vibration component according to some embodiments of the present disclosure;

FIG. 26B is a schematic diagram illustrating an exemplary vibration component according to some embodiments of the present disclosure;

FIG. 27A is a schematic diagram illustrating an exemplary vibration component according to some embodiments of the present disclosure;

FIG. 27B is a schematic diagram illustrating an exemplary vibration component according to some embodiments of the present disclosure;

FIG. 27C is a schematic diagram illustrating an exemplary vibration component according to some embodiments of the present disclosure;

FIG. 28 is a schematic diagram illustrating an exemplary vibration component according to some embodiments of the present disclosure;

FIG. 29 is a schematic diagram illustrating an exemplary vibration component according to some embodiments of the present disclosure;

FIG. 30A is a schematic diagram illustrating an exemplary vibration component according to some embodiments of the present disclosure;

FIG. 30B is a schematic diagram illustrating an exemplary vibration component according to some embodiments of the present disclosure;

FIG. 30C is a schematic diagram illustrating an exemplary vibration component according to some embodiments of the present disclosure;

FIG. 30D is a schematic diagram illustrating an exemplary vibration component according to some embodiments of the present disclosure;

FIG. 30E is a schematic diagram illustrating an exemplary vibration component according to some embodiments of the present disclosure;

FIG. 31 is a schematic diagram illustrating an exemplary vibration component according to some embodiments of the present disclosure;

FIG. 32 is a schematic diagram illustrating an exemplary vibration component according to some embodiments of the present disclosure;

FIG. 33A is a schematic diagram illustrating an exemplary vibration component according to some embodiments of the present disclosure;

FIG. 33B is a schematic diagram illustrating an exemplary vibration component according to some embodiments of the present disclosure;

FIG. 34A is a schematic diagram illustrating an exemplary vibration component according to some embodiments of the present disclosure;

FIG. 34B is a schematic diagram illustrating an exemplary vibration component according to some embodiments of the present disclosure;

FIG. 34C is a schematic diagram illustrating an exemplary vibration component according to some embodiments of the present disclosure;

FIG. 35A is a schematic diagram illustrating an exemplary vibration component according to some embodiments of the present disclosure;

FIG. 35B is a schematic diagram illustrating an exemplary vibration component according to some embodiments of the present disclosure;

FIG. 35C is a schematic diagram illustrating an exemplary vibration component according to some embodiments of the present disclosure; and

FIG. 35D is a schematic diagram illustrating an exemplary vibration component according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person having ordinary skills in the art to apply the present disclosure to other similar scenarios in accordance with these drawings without creative labor. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, portions, portions or assemblies of different levels. However, the words may be replaced by other expressions if other words can achieve the same purpose.

As indicated in the disclosure and claims, the terms “a”, “an”, and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The flowchart is used in the present disclosure to illustrate the operations performed by the system according to the embodiments of the present disclosure. It should be understood that the preceding or following operations are not necessarily performed in the exact order. Instead, various steps may be processed in reverse order or simultaneously. Meanwhile, other operations may be added to these procedures, or a certain step or steps may be removed from these procedures.

The embodiments of the present disclosure provide a vibration component applicable to various acoustic output devices. The acoustic output devices may include, but are not limited to, a loudspeaker, a hearing aid, or the like. The vibration component provided in the embodiments of the present disclosure mainly includes an elastic element. The clastic element may be connected with a driving portion of the loudspeaker. An edge of the elastic element may be fixed (e.g., connected with a housing of the loudspeaker). In the loudspeaker, the driving portion of the loudspeaker may serve as an electrical energy-mechanical energy conversion unit to provide a driving force for the loudspeaker by converting electrical energy into mechanical energy. The vibration component may receive a force or displacement transmitted by the driving portion to generate a corresponding vibration output, thereby pushing the air to move to generate a sound pressure. The clastic element may be regarded as being connected with an air inertial load portion through a spring and damping component to realize radiation of the sound pressure by pushing the air to move.

The clastic element may mainly include a central region, a folded ring region disposed at a periphery of the central region, and a fixed region disposed at a periphery of the folded ring region. In some embodiments, in order to make the loudspeaker have a relatively flat sound pressure level output within a large range (e.g., 20 Hz-20 kHz), a preset pattern may be set in the folded ring region of the elastic element, so as to break a vibration mode of the folded ring region of the elastic element in a corresponding frequency band, thus avoiding acoustic cancellation due to local segmented vibrations of the clastic element. Also, it may increase a local stiffness of the clastic element by setting the pattern. Furthermore, by setting a layer of thickened structure in the central region of the elastic element, a stiffness of the central region of the clastic element may be increased, and the acoustic cancellation due to segmented vibrations formed by different parts of the central region of the elastic element of the loudspeaker within a range of 20 Hz-20 kHz may be avoided. However, the overall mass of the vibration component may be increased by directly setting the thickened structure in the central region of the elastic element, causing an increase in the load of the loudspeaker and impedance mismatch between a driving end and a load end, thus reducing the sound pressure level output by the loudspeaker. According to the vibration component provided by the embodiments of the present disclosure, the central region of the elastic element may be configured to include an clastic member and a reinforcing member stacked in a vibration direction, and the reinforcing member may be provided with a plurality of groove structures whose openings face the elastic member. According to the vibration component provided by the embodiments of the present disclosure, the central region of the elastic element may also be configured such that the central region may include a reinforcing region and an elastic region arranged side by side, and the reinforcing region may be provided with a plurality of groove structures whose openings face the vibration direction. The reinforcing region may correspond to a projection region of the reinforcing member on the elastic member in the vibration direction. With the configuration of the reinforcing member/reinforcing region with the plurality of groove structures, the vibration component may have a required high-order mode at middle and high frequencies (above 3 kHz). With the setting of the configuration and dimensions of the reinforcing member/reinforcing region with the plurality of groove structures, no more than three resonance peaks may appear in an appropriate frequency band on a frequency response curve of the vibration component, which leads to that the vibration component has a relatively high sensitivity within a relatively wide frequency band range. Meanwhile, by providing the reinforcing member/reinforcing region with the plurality of groove structures, the mass of the vibration component may be relatively small and the stiffness of the vibration component may be relatively large, such that the overall sensitivity of the loudspeaker can be improved. More descriptions regarding the vibration component, the clastic member, and the reinforcing member/reinforcing region may be found in the related descriptions below.

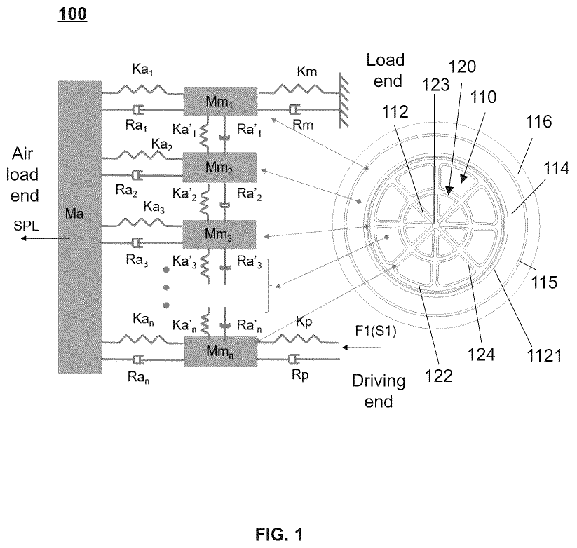

Referring to FIG. 1, FIG. 1 is a schematic diagram illustrating an exemplary vibration component and an equivalent vibration model thereof according to some embodiments of the present disclosure.

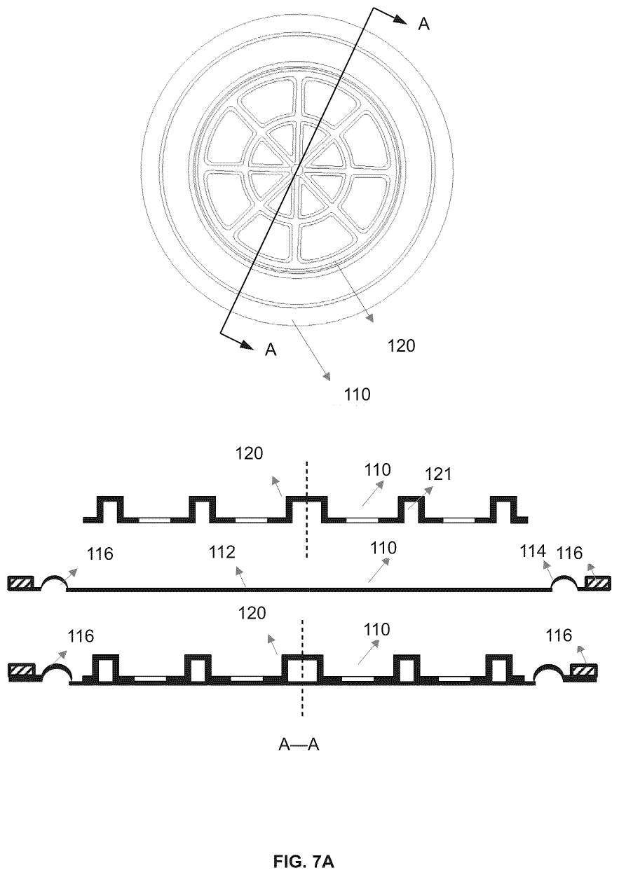

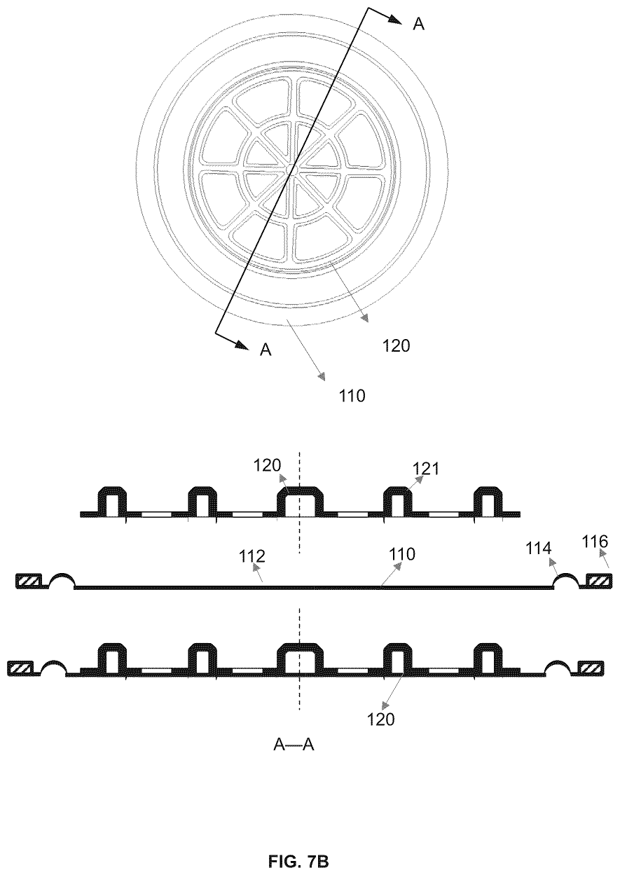

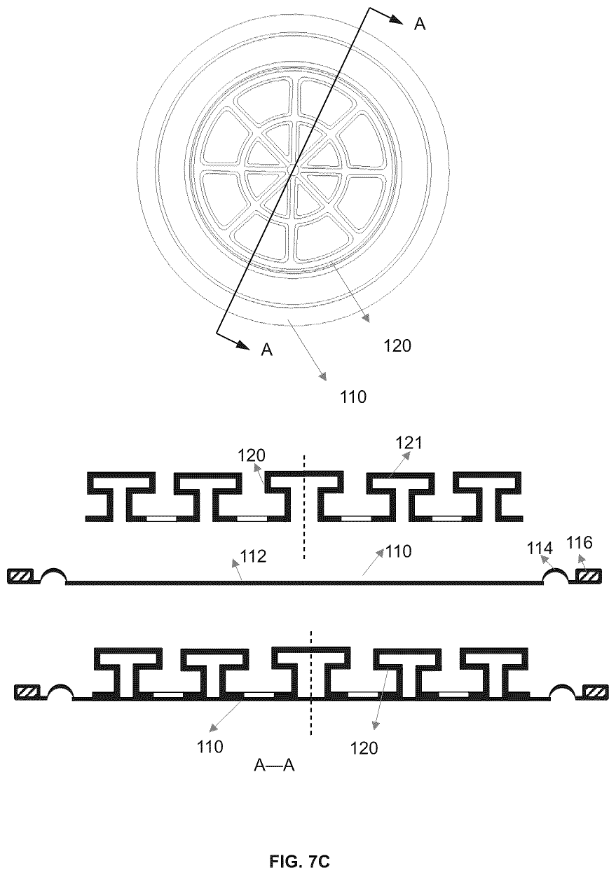

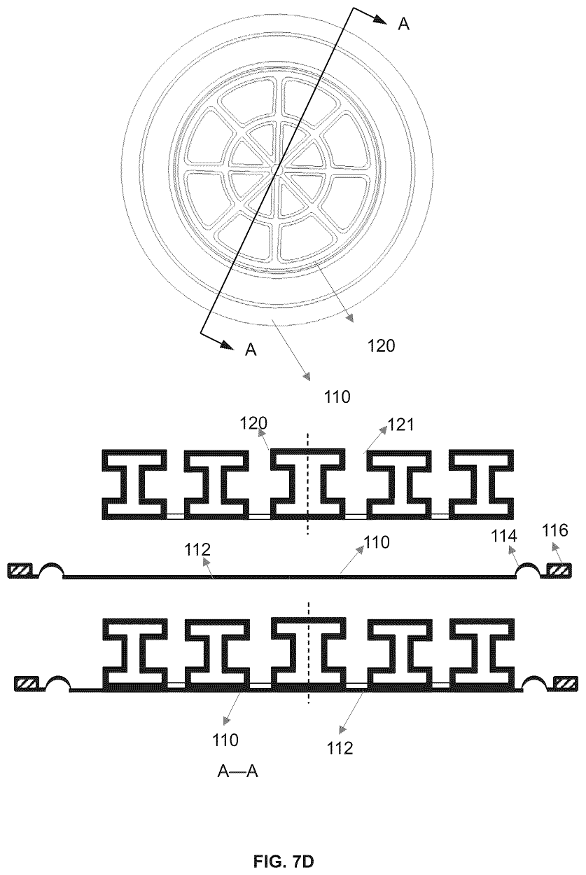

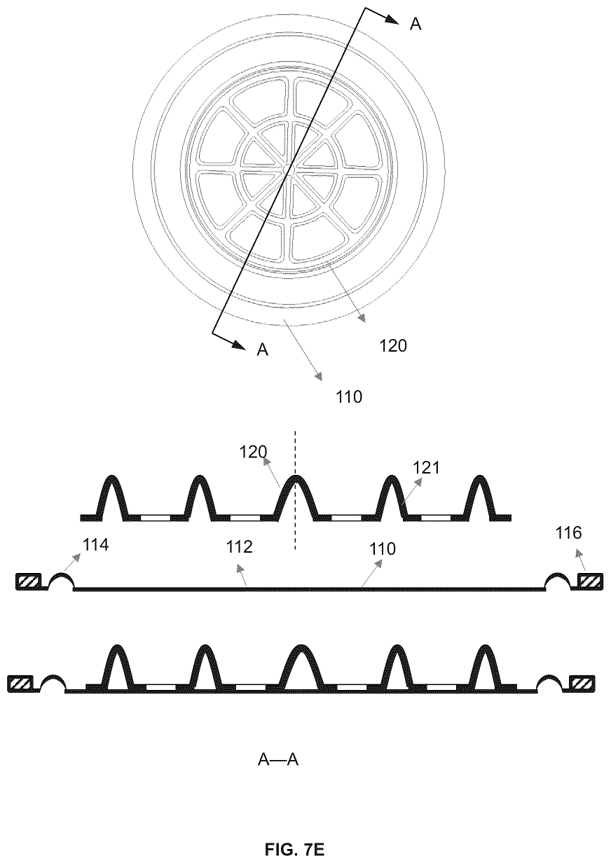

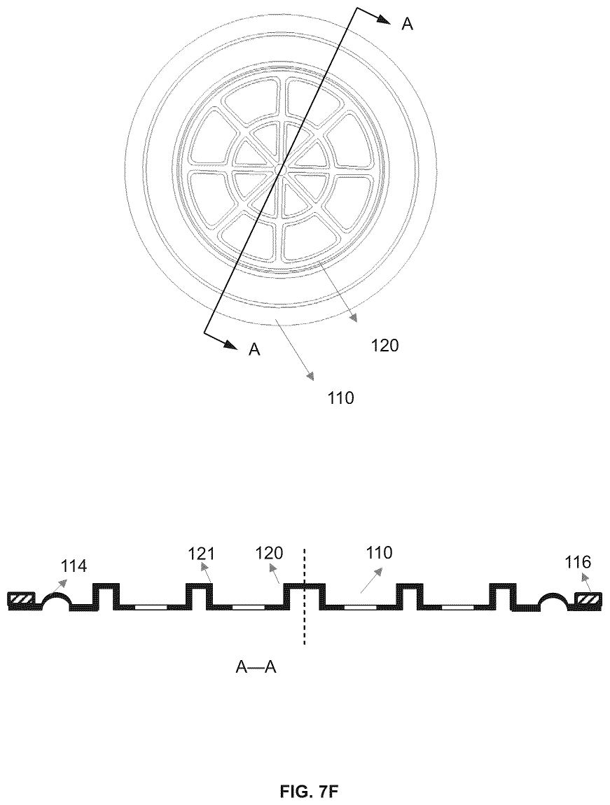

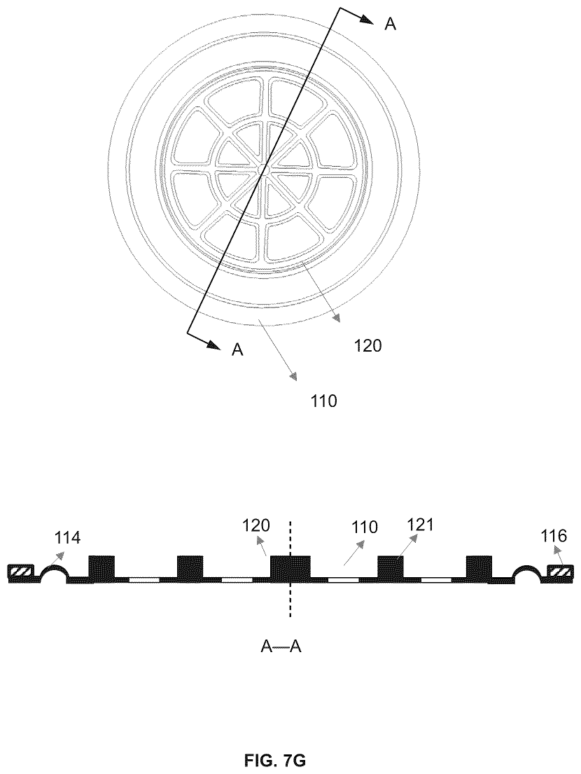

In some embodiments, a vibration component 100 may mainly include an clastic element 110. The clastic element 110 may include a central region 112, a folded ring region 114 disposed at a periphery of the central region 112, and a fixed region 116 disposed at a periphery of the folded ring region 114. The clastic element 110 may be configured to vibrate in a direction perpendicular to the central region 112 to transmit a force and displacement received by the vibration component 100 to push the air to move. The central region 112 may include an elastic member and a reinforcing member 120 stacked in a vibration direction. The vibration direction may be a vibration direction of the clastic member 110, i.e., a direction perpendicular to the central region 112. As shown in FIG. 1, the vibration direction may be a direction perpendicular to a drawing in which the FIG. 1 is located. In some embodiments, the clastic member refers to a portion of the clastic element 110 located in the central region. The reinforcing member 120 may be connected with the elastic element. The reinforcing member 120 may include a plurality of groove structures 121 (as shown in FIG. 7A). Openings of the plurality of structures 121 may face the clastic member. In some embodiments, the reinforcing member 120 may include one or more ring structures 122, and one or more strip structures 124. Each of the one or more strip structures 124 may be connected with at least one of the one or more of the ring structures 12. A cross section of each of the one or more strip structures 124 and/or each of the one or more ring structures 122 may be provided with the groove structure 121. By reasonably setting the reinforcing member 120, a local stiffness of the central region 112 of the clastic element 110 may be controllably adjustable, avoiding the formation of segmented vibrations leading to acoustic cancellation of the central region 112 of the clastic element 110 of the vibration component 100 within a wide range (e.g., 20 Hz-20 kHz), such that the vibration component 100 may have a relatively flat sound pressure level curve. Meanwhile, the one or more strip structures 124 and the one or more ring structures 122 may be interconnected to enclose a plurality of hollow structures, such that the reinforcing member 120 may have a suitable proportion of the plurality of groove structures (i.e., the one or more strip structures 124, or the one or more ring structures 122) and the plurality of hollow structures (i.e., a plurality of hollow portions), which reduces the mass of the reinforcing member 120, and enhances the overall sensitivity of the vibration component 100. Meanwhile, with the setting of the shapes, dimensions, and counts of the one or more strip structures 124 and/or the one or more ring structures 122 and the plurality of groove structure 121, positions of a plurality of resonance peaks of the vibration component 100 can be adjusted, thereby controlling the vibration output of the vibration component 100.

In some embodiments, the central region 112 may include a reinforcing region and an clastic region arranged side by side (as shown in FIG. 7F). The reinforcing region and the clastic region refer to the reinforcing member 120 and the elastic element, respectively. In this case, the clastic element may be connected with a side surface (e.g., skirt structures of the plurality of groove structures 121) of a structure of the reinforcing member 120. The reinforcing member 120 may include the one or more ring structures 122 and the one or more strip structures 124. Each of the one or more strip structures 124 may be connected with at least one of the one or more ring structures 122. The cross section of each of the one or more strip structures 124 and/or each of the one or more the ring structures 122 may be provided with the groove structure 121 whose the opening faces the vibration direction.

The elastic element 110 refers to an element capable of elastically deforming under an external load. In some embodiments, the clastic element 110 may be a material that is resistant to a high temperature, allowing the clastic element 110 to maintain the performance during processing and manufacturing when the vibration component 100 is applied to a vibration transducer or a loudspeaker. In some embodiments, a Young's modulus and a shear modulus of the elastic element 110 may have no change or have a small change (e.g., a change of 5% or less) when the clastic element 110 is in an environment of 200° C.-300° C. The Young's modulus is used to characterize the deformability of the elastic element 110 when subjected to tension or compression, and the shear modulus is used to characterize the deformability of the clastic element 110 when subjected to shear. In some embodiments, the elastic element 110 may be a material with good elasticity (i.e., susceptible to clastic deformation), allowing the vibration component 100 to have good vibration responsiveness. In some embodiments, the material of the clastic element 110 may be one or more of an organic polymer material, a gum material, or the like. In some embodiments, the organic polymeric material may be polycarbonate (PC), polyamides (PA), acrylonitrile butadiene styrene (ABS), polystyrene (PS), high impact polystyrene (HIPS), polypropylene (PP), polyethylene terephthalate (PET), polyvinyl chloride (PVC), polyurethanes (PU), polyethylene (PE), phenol formaldehyde (PF), urea-formaldehyde (UF), melamine-formaldehyde (MF), polyarylate (PAR), polyetherimide (PEI), polyimide (PI), polyethylene naphthalate two formic acid glycol ester (PEN), polyetheretherketone (PEEK), carbon fiber, graphene, silica gel, or the like, or a combination thereof. In some embodiments, the organic polymer material may also be a variety of glues, including, but not limited to, gels, silicone, acrylics, urethanes, rubbers, epoxies, hot melts, light curing, or the like. In some embodiments, the organic polymer material may be an organosilicone bonding glue and organosilicone scaling glue.

A Shore hardness of the elastic element 110 is used to characterize the ability to resist local deformation. The greater the Shore hardness, the greater the resistance to local deformation (especially plastic deformation) and the less likely the local deformation. In some embodiments, in order for the elastic element 110 to be able to vibrate under suitable driving, the Shore hardness of the clastic element 110 may be within a range of 1 HA-50 HA. In some embodiments, in order to reduce the difficulty of vibration of the clastic element 110, the Shore hardness of the clastic element 110 may be within a range of 1 HA-15 HA. In some embodiments, in order to provide the elastic element 110 with resistance to plastic deformation, the Shore hardness of the clastic element 110 may be within a range of 14.9 HA-15.1 HA. The Shore hardness of the clastic element 110 may be measured by a Shore hardness tester. Specifically, a sample of the elastic element 110 may be placed on a rigid platform, and the zeroed Shore hardness tester may be pressed against a sample surface with a needle vertically with appropriate force at an appropriate uniform speed, and when a needle end surface of the Shore hardness tester completely contacts the sample surface, a value measured on a dial of the Shore hardness tester, i.e., the Shore hardness of the elastic element 110 may be recorded. In some embodiments, if a thickness of the clastic element 110 is small, samples of the same specification and batch may be taken and stacked to a certain thickness (e.g., 3 mm or more) for measurement.

The Young's modulus of an elastic element 110 is used for characterize the ability to elastically deform when subjected to a force. The greater the Young's modulus, the greater the ability of the material to resist deformation, the better the rigidity, and the less likely the material is to deform. In some embodiments, in order for the clastic element 110 to be able to vibrate under appropriate driving, the Young's modulus of the clastic element 110 may be within a range of 5E8 Pa-1E10 Pa. In some embodiments, in order to make the ability of the elastic element 110 for elastic deformation appropriate, the Young's modulus of the clastic element 110 may be within a range of 1E9 Pa-5E9 Pa. In some embodiments, in order to make the ability of the clastic element 110 for clastic deformation appropriate, the Young's modulus of the clastic element 110 may be within a range of 1E9 Pa-4E9 Pa. In some embodiments, in order to make the ability of the clastic element 110 for elastic deformation appropriate, the Young's modulus of the clastic element 110 may be within a range of 2E9 Pa-5E9 Pa. In some embodiments, the Young's modulus of the clastic element 110 may be measured in various modes, such as a resonance mode, a nanoindentation mode, a dynamic expansion mode, a visual image tracking system, a microstretching recombination, or the like. Merely by way of example, as a thin film material, the clastic element 110 may excite surface acoustic waves on a surface of the thin film, using laser pulses. Since the dispersion relationship of the wave speed of the surface acoustic waves is determined by the elasticity modulus (Young's modulus), the density, and the thickness of the thin film and the substrate, based on the fact that the surface acoustic waves propagate with different velocities in different materials, the Young's modulus, the density, and the thickness of the thin film can be measured by detecting the wave speed of the surface acoustic waves. Specifically, information such as the Young's modulus, the density, and the thickness of the thin film can be obtained by comparing the dispersion relationship of the speed of the acoustic waves detected by an acoustic detector with a dispersion relationship computed by a theoretical model.

In some embodiments, if a volume of the clastic element 110 is constant, in order to make a mass of the clastic element 110 appropriate, a density of the elastic element 110 may be within a range of 1E3 kg/m³-4E3 kg/m³. In some embodiments, in order to make the mass of the clastic element 110 appropriate, the density of the elastic element 110 may be within a range of 1E3 kg/m³-2E3 kg/m³. In some embodiments, in order to make the mass of the clastic element 110 appropriate, the density of the clastic element 110 may be within a range of 1E3 kg/m³-3E3 kg/m³. In some embodiments, in order to avoid excessive mass of the elastic element 110, the density of the elastic element 110 may be within a range of 1E3 kg/m³-1.5 E3 kg/m³. In some embodiments, in order to avoid the mass of the elastic element 110 being too small, the density of the clastic element 110 may be within a range of 1.5 E3 kg/m³-2E3 kg/m³.

The central region 112 refers a region on the elastic element 110 that extends from a center (e.g., a centroid) to a peripheral side by a certain area. The central region 112 may include an elastic element and a reinforcing member 120. The reinforcing member 120 may be connected with the clastic member. In some embodiments, the clastic element refers to a portion of the elastic element 110 disposed in the central region 112. The clastic member and the reinforcing member 120 may be stacked in the vibration direction. A surface of the clastic member close to the reinforcing member 120 may be connected with a side of the plurality of structures 121 of the reinforcing member 120 provided with the openings. In this case, the surface of the clastic member may completely cover the reinforcing member 120, i.e., the clastic member may cover the openings of the plurality of structures 121 of the reinforcing member 120. In some embodiments, the clastic member (i.e., the clastic region of the central region) and the reinforcing member 120 (i.e., the reinforcing region of the central region) may be arranged side by side, and the clastic member may be connected with a side surface of the hollow structures of the reinforcing member 120. In this case, the clastic member may cover a remaining portion of the central region 112 not covered by the reinforcing member 120, i.e., the elastic member may not cover or partially cover the openings of the plurality of groove structures 121 of the reinforcing member 120.

In some embodiments, when the vibration component 100 is applied to the loudspeaker, the clastic member of the central region 112 may be directly connected with the driving portion of the loudspeaker. In some embodiments, the reinforcing member 120 of the central region 112 may be directly connected with the driving portion of the loudspeaker. The elastic element 110 may be configured to vibrate in the direction perpendicular to the central region 112. The elastic member and the reinforcing member 120 of the central region 112 may transmit the force and the displacement of the driving portion to push the air to move to output the sound pressure.

The folded ring region 114 may be disposed at an outer side of the central region 112. In some embodiments, the folded ring region 114 may be configured with a pattern of a characteristic shape to disrupt a vibration mode of the folded ring region 114 of the clastic element 110 in a corresponding frequency band and avoid acoustic cancellation caused by local segmented vibration of the clastic element 110. Meanwhile, the local stiffness of the clastic element 110 may be increased by setting the pattern.

In some embodiments, the folded ring region 114 may include a folded ring structure. In some embodiments, by adjusting parameters of the folded ring structure, such as a folded ring width, an arch height, etc., a stiffness of the folded ring region 114 corresponding to the folded ring structure may be different, and a corresponding frequency band of a high frequency local segmented vibration mode may be different. The folded ring width refers to a radial width of a projection of the folded ring region 114 in the vibration direction of the clastic element 110. The arch height refers to a height of the folded ring region 114 protruding from the central region 112 or a fixed region 116 in the vibration direction of the clastic element 110.

In some embodiments, a maximum area of a projection of an outermost ring structure 122 of the reinforcing member 120 in the vibration direction of the clastic element 110 may be less than an area of the central region 112. That is, a region not supported by the reinforcing member 120 may be disposed between an outermost side of the projection of the reinforcing member 120 and the folded ring region 114. According to the present disclosure, a portion of region of the central region 112 between the folded ring region 114 and the reinforcing member 120 is referred to as a suspension region 1121. A portion of the elastic element 110 corresponding to the suspension region 1121 may also serve as the elastic member. In some embodiments, by adjusting a maximum contour of the reinforcing member 120, an area of the suspension region 1121 can be adjusted, thereby adjusting a modal vibration mode of the vibration component.

The fixed region 116 may be disposed at the periphery of the folded ring region 114. The clastic element 110 may be connected and fixed through the fixed region 116. For example, the elastic element 110 may be connected with a housing of the loudspeaker, or the like, through the fixed region 116. In some embodiments, the fixed region 116 may be mounted and fixed in the housing of the loudspeaker and may be considered to be uninvolved in the vibration of the elastic element 110. In some embodiments, the fixed region 116 of the clastic element 110 may be connected with the housing of the loudspeaker through a support element. In some embodiments, the support element may include a soft material that is easily deformable, allowing the support element to deform during vibration of the vibration component 100 to provide a larger displacement for the vibration of the vibration component 100. In some embodiments, the support element may also include a hard material that is not easily deformable.

In some embodiments, the clastic element 110 may further include a connection region 115 provided between the folded ring region 114 and the fixed region 116. In some embodiments, the connection region 115 may provide additional stiffness and damping to the vibration of the clastic element 110, thereby adjusting the modal vibration mode of the vibration component 100.

In order to make the clastic element 110 provide an appropriate stiffness, a thickness and an elasticity coefficient of the clastic element 110 may be set to be within a reasonable range. In some embodiments, the thickness of the clastic element 110 may be within a range of 3 μm-200 μm. In some embodiments, in order to avoid excessive stiffness of the elastic element 110, the thickness of the clastic element 110 may be within a range of 3 μm-100 μm. In some embodiments, in order to avoid excessive stiffness of the clastic element 110, the thickness of the elastic element 110 may be within a range of 3 μm-50 μm

The reinforcing member 120 refers to an element used to enhance the stiffness of the clastic element 110. In some embodiments, the reinforcing member 120 may be connected with the central region 112, and the reinforcing member 120 and/or the central region 112 may be connected with the driving portion of the loudspeaker to transmit the force and/or the displacement such that the vibration component 100 may push the air to move to output the sound pressure.

In some embodiments, the reinforcing member 120 may include the one or more ring structures 122, and the one or more strip structures 124. Each of the one or more strip structures 124 may be connected with at least one of the one or more ring structures 122 form staggered supports in the central region 112 of the clastic element 110. At least one of the one or more strip structures 124 may extend toward a center of the central region 112. In some embodiments, the one or more strip structures 124 may pass through the center of the central region 112 to provide support to the center of the central region 112. In some embodiments, the reinforcing member 120 may also include a central connection portion 123. The one or more strip structures 124 may not pass through the center of the central region 112, and the central connection portion 123 may cover the center of the central region 112. The one or more strip structures 124 may be connected with the central connection portion 123.

In some embodiments, the cross section of each of the one or more ring structures 122 and/or each of the one or more strip structures 124 may be provided with the groove structure 121. The groove structure 121 may adjust the stiffness and the mass of the reinforcing member 120 to avoid excessively increasing the load of the loudspeaker, and avoid the impedance mismatch between the driving portion and the load portion, thereby improving the output effect of the vibration component 100.

The one or more ring structures 122 may be structures that extend around a specific center. In some embodiments, the center around which the one or more ring structures 122 extend may be the center of the central region 112. In some embodiments, the center around which the one or more ring structures 122 extend may also be another position off the center of the central region 112. In some embodiments, the one or more ring structures 122 may be structures with closed contour lines. In some embodiments, a projection shape of each of the one or more ring structures 122 in the vibration direction of the elastic element 110 may include, but is not limited to, one or more of a circular ring, a polygonal ring, a curved ring, or an elliptical ring, or any combination thereof. In some embodiments, the one or more ring structures 122 may also be structures with non-closed contour lines. For example, each of the one or more ring structures 122 may be a circular ring with a notch, a polygonal ring with a notch, a curved ring with a notch, or an elliptical ring, etc. In some embodiments, one ring structure 122 may be provided. In some embodiments, a plurality of ring structures 122 may be provided, and the plurality of ring structures may have the same centroid. In some embodiments, 1-10 ring structures 122 may be provided. In some embodiments, 1-5 ring structures 122 may be provided. In some embodiments, 1-3 ring structures 122 may be provided. If there are too many ring structures 122, the mass of the reinforcing member 120 may be excessive, which may result in a reduction in the overall sensitivity of the vibration component 100. In some embodiments, by setting the count of ring structures 122, the mass and the stiffness of the reinforcing member 120 may be adjusted. In some embodiments, a dimension of the ring structure 122 located at an outermost periphery of the reinforcing member 120 may be considered a maximum dimension of the reinforcing member 120. In some embodiments, by setting the dimension of the ring structure 122 located at the outermost periphery of the reinforcing member 120, a dimension (or an area) of the suspension region 1121 between the folded ring region 114 and the reinforcing member 120 may be adjusted, thereby changing the modal vibration mode of the vibration component 100.

In some embodiments, the one or more ring structures 122 may include a first ring structure and a second ring structure. A radial dimension of the first ring structure may be less than a radial dimension of the second ring structure. In some embodiments, the first ring structure may be disposed at an inner side of the second ring structure. In some embodiments, centroids of the first ring structure and the second ring structure may overlap. In some embodiments, the centroids of the first ring structure and the second ring structure may not overlap. In some embodiments, the first ring structure and the second ring structure may be connected by the one or more strip structures 124.

The one or more strip structures 124 may be structures obeying any extension rule. In some embodiments, the one or more strip structures 124 may extend along a straight line. In some embodiments, the one or more strip structures 124 may also extend along a curve. In some embodiments, extending along the curve may include, but is not limited to, an arcuate extension, a helical extension, a spline-shaped extension, a circular extension, an S-shaped extension, or the like. In some embodiments, the one or more strip structures 124 may be connected with the one or more ring structures 122 to divide the one or more ring structures 122 into a plurality of hollow structures. That is, a region of the reinforcing member 120 apart from the plurality of groove structures 121 may be provided with plurality of hollow structures. In some embodiments, portions of the central region 112 corresponding to the plurality of hollow structures are referred to as the hollow regions (i.e., the clastic regions). In some embodiments, one strip structure 124 may be provided. For example, one strip structure 124 may be disposed in any diameter direction of the one or more ring structures 122, and the strip structure 124 may be connected with the center of the central region (i.e., the centroid of each of the one or more ring structures 122) and the one or more ring structures 122. In some embodiments, a plurality of strip structures 124 may be provided. In some embodiments, the plurality of strip structures 124 may be disposed in a plurality of diameter directions of the one or more ring structures 122. In some embodiments, the plurality of strip structures 124 may extend toward the center of the central region 112. The center of the central region 112 may be the centroid of the elastic element 110. In some embodiments, the plurality of strip structures 124 may be connected with the center of the central region to form the central connection portion 123 at the center. In some embodiments, the central connection portion 123 may also be a separate structure, and the plurality of strip structures 124 may be connected with the central connection portion 123. In some embodiments, a shape of the central connection portion 123 may include, but is not limited to, a circle, a square, a polygon, or an ellipse, etc. In some embodiments, the shape of the central connection portion 123 may also be arbitrarily set.

In some embodiments, in order to enhance the stiffness of the clastic element 110, 1-100 strip structures 124 may be provided. In some embodiments, in order to avoid excessive stiffness of the clastic element 110, 1-50 strip structures 124 may be provided. In some embodiments, in order to avoid excessive stiffness of the clastic element 110, 1-30 strip structures 124 may be provided. By setting the count of the one or more strip structure 124, the overall mass of the vibration component 100, the stiffness of the reinforcing member 120 and the size of the areas of the hollow regions of the clastic element 110 may be adjusted, thereby changing the modal vibration mode of the vibration component.

In some embodiments, a projection shape of each of the one or more strip structures 124 in the vibration direction of the clastic element 110 may include at least one of a rectangle, a trapezoid, a curve, an hourglass, and a petal. By setting different shapes of the strip structures 124, a mass distribution (e.g., the position of the centroid) of the reinforcing member 120, the stiffness of the reinforcing member 120, and the size of the areas of the hollow regions may be adjusted, thereby changing the modal vibration mode of the vibration component.

It should be noted that the structural descriptions of the one or more ring structures 122 and the one or more strip structures 124 in the embodiments of the present disclosure are merely optional structures selected to facilitate the reasonable setting of the structure of the reinforcing member 120, and should not be construed as a restriction on the reinforcing member 120 and its various portions thereof should not be construed as a limitation on the shape of the reinforcing member 120 and the portions thereof. In fact, the reinforcing member 120 in the embodiments of the present disclosure may form the hollow structures (the hollow regions corresponding to the central region 112) located between the one or more ring structures 122 and the one or more strip structures 124 through the one or more ring structure 122 and the one or more strip structures 124 having the plurality of groove structures 121, and vibration features (e.g., a count and a frequency range of resonance peaks) of the vibration component 100 may be regulated by adjusting parameters (e.g., an area, a thickness of each of the plurality of groove structures, etc.) of the plurality of groove structures and the hollow structures. In other words, any shape of the reinforcing member having the plurality of groove structures and the hollow structures may be set using the parameter settings provided herein with respect to the plurality of groove structures and the hollow structures for the purpose of adjusting the vibration performance (e.g., the count and position of the resonance peaks, a morphology of a frequency response curve, etc.) of the vibration component. All these solutions should be included in the scope of the present disclosure.

In some embodiments, referring to FIG. 1, the connection region 115 between the fixed region 116 and the folded ring region 114 of the elastic element 110 may be provided in a suspension manner. The connection region 115 may have an equivalent mass Mm1 and may be fixedly connected with the housing through a spring Km and damping Rm. Meanwhile, the connection region 115 may be connected with a front end air load of the elastic element 110 through a spring Ka1 and damping Ra1 to transmit the force and the displacement to push the air to move.

In some embodiments, the folded ring region 114 of the elastic element 110 may have a local equivalent mass Mm2 and may be connected with the connection region 115 of the clastic element 110 through a spring Ka1′ and damping Ra1′. Meanwhile, the folded ring region 114 may be connected with the front end air load of the clastic element 110 through a spring Ka2 and damping Ra2 to transmit the force and the displacement to push the air to move.

In some embodiments, the central region 112 of the elastic element 110 may be provided with the reinforcing member 120. The reinforcing member 120 may be connected with the clastic member of the central region 112. The suspension region 1121 may be provided between the region of the elastic member supported by the reinforcing member 120 and the folded ring region 114. The region may have a local equivalent mass Mm3 and may be connected with the folded ring region 114 through a spring Ka2′ and damping Ra2′. Meanwhile, a region where the reinforcing member 120 is located may be connected with the front end air load of the clastic element 110 through a spring Ka3 and damping Ra3 to transmit the force and the displacement to push the air to move.

In some embodiments, the setting of the reinforcing member 120 is such that the central region 112 of the elastic element 110 corresponding to the reinforcing member 120 may have no less than one hollow region. Each of the hollow regions may be equivalent to a mass-spring-damping system having an equivalent mass Mmi, an equivalent stiffness Kai and Kai′, and equivalent damping Rai and Rai′. The hollow region may be connected with an adjacent hollow region through the spring Kai′ and the damping Rai′. The hollow region may also be connected with the suspension region 1121 provided between the region of the clastic member supported by the reinforcing member 120 and the folded ring region 114 through the spring Kai′ and damping Rai′. Meanwhile, the hollow region may also be connected with the front end air load through the spring Kai and the damping Rai to transmit the force and the displacement to push the air to move.

In some embodiments, the reinforcing member 120 may have an equivalent mass Mmn, and the reinforcing member 120 may be connected with the central region 112 through a spring Kan′ and damping Ran′. Meanwhile, the reinforcing member 120 may be connected with the front end air load of the clastic element 110 through a spring Kan′ and damping Ran′, such that when the reinforcing member 120 generates a resonance, the central region 112 may be driven to drive the clastic element 110 to generate a relatively large movement speed and displacement, thereby generating a relatively large sound pressure level.

According to the dynamic characteristics of the mass-spring-damping system, each mass-spring-damping system has its own resonance peak frequency f0, and a large movement speed and displacement may occur at f. By setting different parameters (e.g., the structural parameters of the elastic element 110 and/or the reinforcing member 120) of the vibration component 100, the mass-spring-damping system formed by the structures of different positions of the vibration component may generate a resonance within a desired frequency band, which makes a frequency response curve of the vibration component 100 have a plurality of resonance peaks, greatly broadening an effective frequency band of the vibration component 100. Meanwhile, by setting the reinforcing member 120, the vibration component 100 may have a lighter mass, making the vibration component 100 have a higher sound pressure level output.

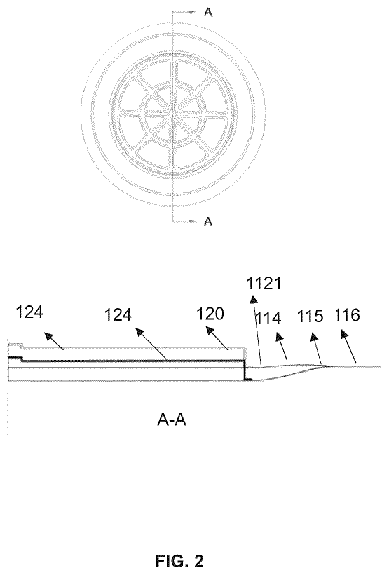

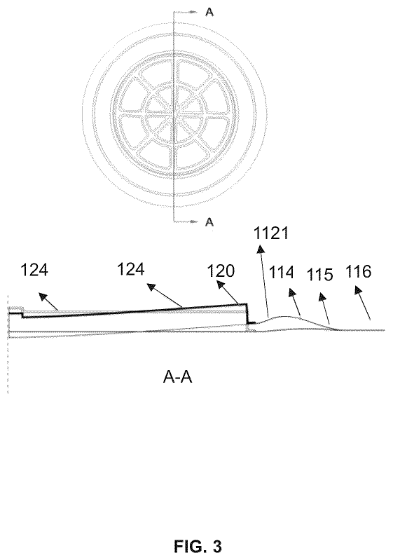

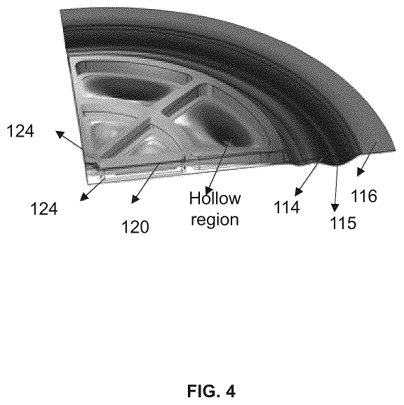

FIG. 2 is a schematic diagram illustrating a deformation of a first resonance peak of a vibration component according to some embodiments of the present disclosure. FIG. 3 is a schematic diagram illustrating a deformation of a second resonance peak of a vibration component according to some embodiments of the present disclosure. FIG. 4 is a schematic diagram illustrating a deformation of a third resonance peak of a vibration component according to some embodiments of the present disclosure.

According to the schematic diagram of an equivalent vibration model of the vibration component 100 shown in FIG. 1, various portions of the vibration component 100 may generate speed resonances within different frequency bands and cause a relatively large speed value to be output within the corresponding frequency band, thereby causing a frequency response curve of the vibration component 100 to output a relatively large sound pressure value within the corresponding frequency band and have a corresponding resonance peak. Meanwhile, the plurality of resonance peaks may cause a frequency response of the vibration component 100 to have a relatively high sensitivity within an audible sound range (e.g., 20 Hz-20 kHz).

Referring to FIG. 1 and FIG. 2, in some embodiments, a combination of a mass of the reinforcing member 120, a mass of the clastic element 110, an equivalent air mass, and an equivalent mass of a driving end may form a total equivalent mass Mt, and equivalent damping of the portions may form total equivalent damping Rt. The elastic element 110 (especially the folded ring region 114, and the elastic element 110 in the suspension region between the folded ring region 114 and the reinforcing member 120) may have a relatively large compliance that provides a stiffness Kt for the system, such that a mass Mt-spring Kt-damping Rt system may be formed. The mass Mt-spring Kt-damping Rt system may have a resonance frequency. When an excitation frequency of the driving end is close to a speed resonance frequency of the system, the system may generate a resonance (as shown in FIG. 2) and output a relatively large speed value va within a band near a speed resonance frequency of the Mt-Kt-Rt system. Since an amplitude of an acoustic pressure output by the vibration component 100 is positively correlated with the speed of sound (pa∝va), a resonance peak may appear in the frequency response curve, which is defined as a first resonance peak of the vibration component 100 in the present disclosure. In some embodiments, referring to FIG. 2, FIG. 2 illustrates vibration of the vibration component 100 at a cross-section A-A. A white structure in FIG. 2 indicates a shape and a position of the reinforcing member 120 prior to a deformation, and a black structure indicates a shape and a position of the reinforcing member 120 at the first resonance peak. It should be noted that FIG. 2 only shows a structure of the vibration component 100 on the A-A cross section from a center of the reinforcing member 120 to an edge of a side of the clastic element 110, i.e., half of the A-A cross section. The other half of the A-A cross section not shown is symmetrical to the situation shown in FIG. 2. According to the vibration of the vibration component 100 at the position of the A-A cross-section, at the position of the first resonance peak, a position of a main deformation of the vibration component 100 may be a portion of the elastic element 110 to which the fixed region 116 is connected. In some embodiments, a frequency (also referred to as the first resonance frequency) of the first resonance peak of the vibration component 100 may be related to a ratio of the mass of the vibration component 100 and an elasticity coefficient of the clastic element 110. In some embodiments, in order to enhance the sound pressure level output of a loudspeaker within a wide middle and low frequency range (e.g., 20 Hz-3500 Hz), the frequency of the first resonance peak may be within a range of 200 Hz-2500 Hz. In some embodiments, in order to focus on enhancing the sound pressure level output of the loudspeaker in a commonly used middle and low frequency range (e.g., 80 Hz-2500 Hz), the frequency of the first resonance peak may be within a range of 400 Hz-1500 Hz. In some embodiments, the frequency of the first resonance peak may be within a range of 500 Hz-1200 Hz. In some embodiments, the frequency of the first resonance peak may be within a range of 600 Hz-1000 Hz. In some embodiments, by providing the structure of the reinforcing member 120, the first resonance peak of the vibration component 100 may be within the frequency range described above.

Referring to FIG. 1 and FIG. 3, the reinforcing member 120 may have an equivalent mass Mmn, and the reinforcing member 120 may be connected with the central region 112 through a spring Kan′ and damping Ran′. Meanwhile, the reinforcing member 120 may be connected with the front end air load of the elastic element 110 through a spring Kan and damping Ran, such that when the reinforcing member 120 generates the resonance, the central region 112 may be driven to drive the clastic element to generate the relatively large movement speed and displacement, thereby generating the relatively large sound pressure level.

A combination the reinforcing member 120, the connection region 115, the folded ring region 114, the suspension region 1121 between a region of the central region 112 provided with the reinforcing member and the folded ring region 114, an equivalent air mass, and an equivalent mass of a driving end may form a total equivalent mass Mt1, and equivalent damping of the portions may form total equivalent damping Rt1. The reinforcing member 120 and the clastic element 110 (especially the region of the central region 112 covered by the reinforcing member 120) may have a relatively large stiffness to provide a stiffness Kt1 for the system, such that a mass Mt1-spring Kt1-damping Rt1 system may be formed. The mass Mt1-spring Kt1-damping Rt1 system may have a certain ring region along a diameter direction of the central region 112 as an equivalent fixed pivot, movements inside the ring region and outside the ring region being in opposite directions, thereby forming a vibration mode of flip movement with. The connection region 115, the folded ring region 114, and the suspension region 1121 between the region of the central region 112 provided with the reinforcing member and the folded ring region 114 may be driven to vibrate by the reinforcing member 120, to realize a resonance mode (as shown in FIG. 3) with the flip movement as a vibration mode. The resonance may also be a resonance frequency point of the equivalent mass Mt1-spring Kt1-damping Rt1 system. When an excitation frequency of a driving end is close to a speed resonance frequency of the system, the system may generate the resonance, and a relatively large speed value va may be output within a frequency band near the speed resonance frequency of the Mt1-Kt1-Rt1 system. Since an amplitude of an acoustic pressure output by the vibration component 100 is positively correlated with the speed of sound (pa∝va), a resonance peak may appear in a frequency response curve, which is defined as a second resonance peak of the vibration component 100 in the present disclosure. In some embodiments, referring to FIG. 3, FIG. 3 illustrates vibration of the vibration component 100 at a cross-section A-A. A white structure in FIG. 3 indicates a shape and a position of the reinforcing member 120 prior to a deformation, and a black structure indicates a shape and a position of the reinforcing member 120 at the first resonance peak. It should be noted that FIG. 3 only shows a structure of the vibration component 100 on the A-A cross section from a center of the reinforcing member 120 to an edge of a side of the clastic element 110, i.e., half of the A-A cross section. The other half of the A-A cross section not shown is symmetrical to the situation shown in FIG. 3. According to the vibration of the vibration component 100 at the position of the A-A cross section, before and after the frequency (also referred to as the second resonance frequency) of the second resonance peak, a position of a main deformation of the vibration component 100 may be a flip deformation of the reinforcing member 120. In some embodiments, the second resonance peak of the vibration component 100 may be related to rigidity of the reinforcing member 120. In some embodiments, in order to enhance the sound pressure level output of a loudspeaker within a wide middle and high frequency range (e.g., 3500 Hz-11000 Hz), the frequency of the second resonance peak may be within a range of 5000 Hz-10000 Hz. In some embodiments, in order to focus on enhancing the sound pressure level output of the loudspeaker in a commonly used middle and high frequency range (e.g., 4000 Hz-10000 Hz), the frequency of the second resonance peak may be within a range of 6000 Hz-8000 Hz. In some embodiments the frequency of the second resonance peak may be within a range of 6500 Hz-7500 Hz. In some embodiments, by providing the structure of the reinforcing member 120, the second resonance peak of the vibration component 100 may be within the frequency range described above.

Referring to FIG. 1 and FIG. 4. A region of the reinforcing member 120 corresponding to the central region 112 may be provided with no less than one hollow region. Each of the no less than one hollow region may be a mass-spring-damping system having an equivalent mass Mmi, an equivalent stiffness Kai and Kai′, and equivalent damping Rai and Rai′. The hollow region may be connected with an adjacent hollow region through a spring Kai′ and damping Rai′, and the hollow region may be connected with the suspension region 1121 between a region of the central region 112 supported by the reinforcing member 120 and the folded ring region 114 through a spring Kai′ and damping Rai′. Meanwhile, the hollow region may be connected with the front end air load of the elastic element 110 through a spring Kai and damping Rai to transmit the force and the displacement to push the air to move.

Since the hollow regions may be separated from each other by the one or more strip structures 124 and/or the one or more ring structures 122 of the reinforcing member 120, the hollow regions may form different resonance frequencies and individually push air domains connected thereto to move and generate corresponding sound pressures. Furthermore, by setting positions, dimensions, and counts of the one or more strip structures 124 and/or the one or more ring structures 122 of the reinforcing member 120, the hollow regions having different resonance frequencies may be realized, such that each of frequency response curves of the vibration component 100 may have no less than one high frequency resonance peak (i.e., a third resonance peak). In some embodiments, in order to the sound pressure level output of the loudspeaker within a wide high frequency range (e.g., 11000 Hz-20000 Hz), the no less than one high frequency resonance peak (i.e., the third resonance peak) as described above may be within a range of 12000 Hz-18000 Hz. In some embodiments, in order to focus on enhancing the sound pressure level output of the loudspeaker in a commonly used high frequency range (e.g., 12000 Hz-18000 Hz), a frequency of the third resonance peak may be within a range of 13000 Hz-17000 Hz. In some embodiments, the frequency of the third resonance peak may be within a range of 14000 Hz-16000 Hz. In some embodiments, the frequency of the third resonance peak may be within a range of 14500 Hz-15500 Hz.

In some embodiments, in order to enhance the output sound pressure level of the vibration component 100 at a high frequency (10000 Hz-20000 Hz), the resonance frequencies of the hollow regions may be equal or close to each other by setting the positions, the dimensions, and the counts of the one or more strip structures 124 and/or the one or more ring structures 122. In some embodiments, a difference of the resonance frequencies of the hollow regions may be 4000 Hz, such that the frequency response curve of the vibration component 100 may have a high frequency resonance peak with a large output sound pressure level, which is defined as the third resonance peak of the vibration component 100 in the present disclosure. In some embodiments, the frequency of the third resonance peak may be within a range of 12000 Hz-18000 Hz.

In some embodiments, by setting an area of the one or more hollow regions and a thickness of the clastic element 110, the resonance frequency of the each of the hollow regions may be adjusted such that the third resonance peak of the vibration component 100 may be located in the frequency range described above. That is, by setting a ratio of the area of each of the hollow regions to the thickness of the clastic element 110, the frequency of the third resonance peak may be adjusted. The unit of the area of each of the hollow regions may be mm², the unit of the thickness of the clastic element 110 may be mm, and the ratio of the area of each of the hollow regions to the thickness of the clastic element 110 may be mm. Merely by way of example, when the area of a hollow region is 20 mm² and the thickness of the clastic element 110 is 0.2 mm, the ratio of the area of the hollow region to the thickness of the clastic element 110 may be 100 mm. In some embodiments, in order for the third resonance peak of the vibration component 100 to be within a frequency range of 12000 Hz-18000 Hz, the ratio of the area of each of the hollow regions to the thickness of the clastic element 110 may be within a range of 100 mm-1000 mm. In some embodiments, in order for the third resonance peak of the vibration component 100 to be within a frequency range of 14000 Hz-16000 Hz, the ratio of the area of each of the hollow regions to the thickness of the clastic element 110 may be within a range of 120 mm-900 mm. In some embodiments, in order for the third resonance peak of the vibration component 100 to be in a frequency range of 14500 Hz-15500 Hz, the ratio of the area of each of the hollow regions to the thickness of the elastic element 110 may be within a range of 150 mm-800 mm. In some embodiments, in order for the third resonance peak of the vibration component 100 to be in a frequency range of 14700 Hz-15200 Hz, the ratio of the area of each of the hollow regions to the thickness of the elastic element 110 may be within a range of 150 mm-700 mm.

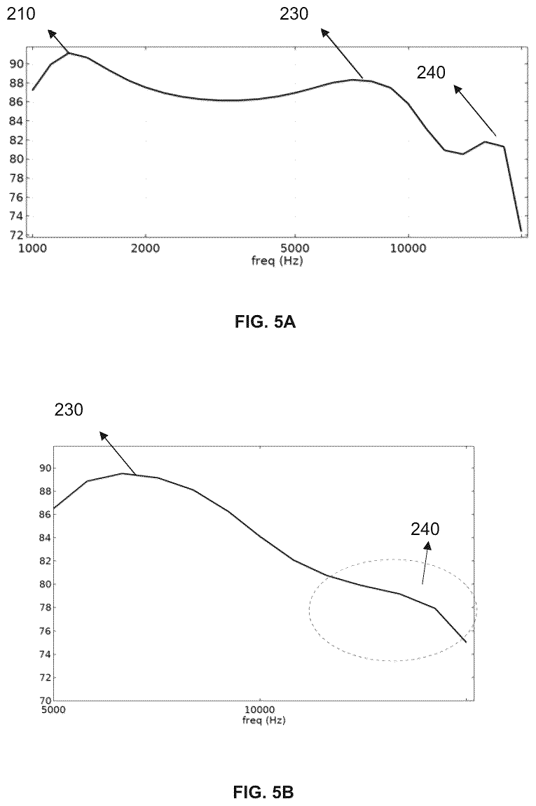

Referring to FIG. 5A, FIG. 5A is a schematic diagram illustrating a frequency response curve of a vibration component according to some embodiments of the present disclosure. By setting structures of the reinforcing member 120 and the clastic element 110, the vibration component 100 may have a plurality of resonance peaks within an audible acoustic range. Furthermore, by combining the plurality of resonance peaks, or the like, the vibration component 100 may have a relatively high sensitivity within the entire audible sound range. By setting the structure of the reinforcing member 120, the third resonance peak 240 of the vibration component 100 may be located in different frequency ranges. By setting a frequency difference between the third resonance peak 240 and the second resonance peak 230, a frequency band between the third resonance peak 240 and the second resonance peak 230 may output a relatively flat frequency response curve and a relatively high sound pressure level, avoiding a trough in the frequency response curve.

Referring to FIG. 5A, by setting the reinforcing member 120 and the clastic element 110, the vibration component 100 may have a required high order mode within the audible acoustic range (20 Hz-20000 Hz), and the first resonance peak 210, the second resonance peak 230, and the third resonance peak 240 described above may appear on the frequency response curve of the vibration component 100, i.e., the frequency response curve of the vibration component 100 may have three resonance peaks within the frequency range of the 20 Hz-20000 Hz, which in turn enables the vibration component 100 to have a relatively high sensitivity in a relatively wide frequency band range.

In some embodiments, by setting the structures of the reinforcing member 120 and the clastic element 110, the vibration component 100 may have only two resonance peaks within the audible sound range (20 Hz-20000 Hz). For example, by setting the structure (including an overall dimension of the reinforcing member 120, counts, dimensions, etc., of the one or more strip structures 124 and/or the one or more ring structures 122 having the plurality of groove structures 121 on a cross section) of the reinforcing member 120, the size of each of the hollow regions may be set, to adjust a resonance frequency corresponding to the suspension region 1121, such that the third resonance peak 240 of the vibration component 100 formed at the high frequency may not be obvious and may not be reflected in the frequency response. When the resonance frequency of the suspension region 1121 is higher than the audible acoustic range, or the resonance frequency of the suspension region 1121 is different, and vibration phases of different suspension regions 1121 are different in different frequency bands within a high frequency range (10000 Hz-18000 Hz), to form an effect of sound superposition and cancellation, a high frequency roll-off effect may be obtained, and the third resonance peak 240 may not be reflected in the sound pressure level frequency response curve of the vibration component 100.

Referring to FIG. 5B, FIG. 5B is a schematic diagram illustrating a frequency response curve of a vibration component without third resonance peak according to some embodiments of the present disclosure. By setting the one or more ring structures 122 and the one or more strip structures 124 of the reinforcing member 120, the reinforcing member 120 may have one or more hollow regions corresponding to the central region 112. Each of the one or more hollow regions may be a mass-spring-damping system. By setting positions, dimensions, and counts of the one or more strip structures 124 of the reinforcing member 120, the resonance frequencies of the hollow regions may be equal or close to each other. In some embodiments, a difference of the resonance frequencies of the hollow regions may be 4000 Hz, which in turn results in one or more high frequency resonance peaks (i.e., the third resonance peak) with a relatively large output sound pressure level on the frequency response curve of the vibration component 100.

In some embodiments, referring to FIG. 5B, by setting the positions, the dimensions, and the counts of the one or more strip structures 124 and/or the one or more ring structures 122 of the reinforcing member 120, the resonance frequencies of the hollow regions may be higher than the audible sound range, or the resonance frequencies of the hollow regions may be different, and vibration phases of the different hollow regions within different frequency bands of a high frequency range (10000 Hz-18000 Hz) may be different, such that an effect of sound superposition and cancellation may be formed, a high frequency roll-off effect may be obtained, and the third resonance peak 240 may not be reflected in the sound pressure level frequency response curve of the vibration component 100.

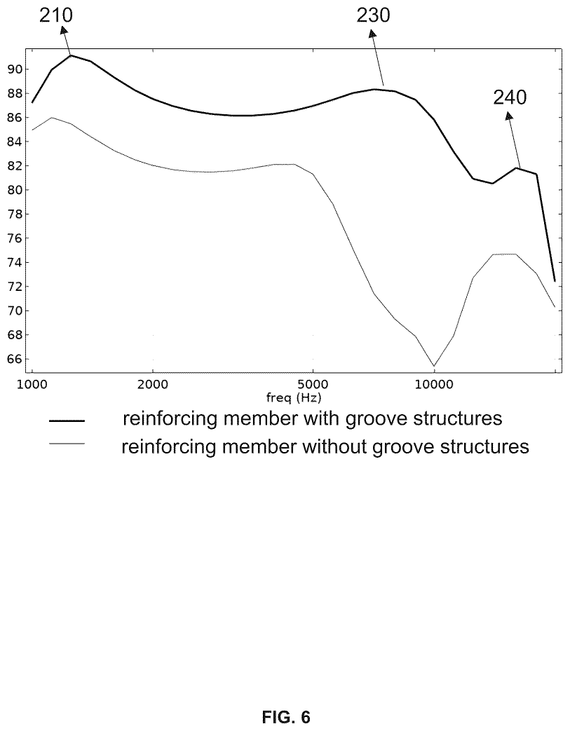

Referring to FIG. 6, FIG. 6 is a schematic diagram illustrating frequency response curves of a vibration component including a plurality of groove structures and a vibration component not including the plurality of groove structures according to some embodiments of the present disclosure. In some embodiments, by setting a structural dimension and shape of the reinforcing member 120 having the plurality of groove structures 121, a mass and stiffness distribution of the reinforcing member 120 may be effectively adjusted. In some embodiments, a stiffness of the reinforcing member 120 may be changed without changing or changing a mass of the reinforcing member 120 such that a stiffness Kt1 provided to the system by the reinforcing member 120 and the clastic element 110 (especially the central region 112 of the elastic element 110) may be changed, which further causes a change in a resonance frequency of a flip movement of a mass Mt1-spring Kt1-damping Rt1 system, thereby causing a change in a position of the third resonance peak 240 of the vibration component 100. In some embodiments, the mass of the reinforcing member 120 may be reduced without reducing the stiffness of the reinforcing member 120, thereby enhancing the output of the vibration component 100.

As shown in FIG. 6, by setting the plurality of groove structures 121, the vibration component 100 may have a relatively flat frequency response output within a range of 1 kHz-6 kHz, and the vibration component 100 may form the second resonance peak 230 and the third resonance peak 240 within a range of 6 kHz-10 kHz and 12 k-18 kHz, respectively, improving the sensitivity of high frequency output. In addition, by setting the plurality of groove structures 121, the vibration component 100 may have no less than one resonance peak at a high frequency, making the vibration component 100 have a relatively high sensitivity output within a wide frequency band range.

In some embodiments, by setting the plurality of groove structures 121, stiffnesses of the reinforcing member 120 and the clastic element 110 may be ensured while reducing a mass of the reinforcing member 120, thereby improving the output of the vibration component 100, which has a positive effect on the performance enhancement of the vibration component 100.

FIG. 7A-FIG. 7G are schematic diagrams illustrating a reinforcing member including different groove structures and an elastic element according to some embodiments of the present disclosure. As shown in FIGS. 7A-7E, in some embodiments, the reinforcing member 120 including the plurality of groove structures 121 may be a separate structure from the elastic element 110, and both of the reinforcing member 120 including the plurality of groove structures and the clastic element 110 may be assembled and molded to form a hollow stiffness reinforced structure. In some embodiments, widths of the plurality of groove structures 121 may be consistent in a vibration direction. For example, the plurality of groove structures 121 shown in FIG. 7A may be square U-shaped structures, the plurality of groove structure 121 shown in FIG. 7B may be rounded U-shaped structures. In some embodiments, the widths of the plurality of groove structures 121 may be gradually decreased or increased in the vibration direction. For example, the plurality of groove structures 121 shown in FIG. 7C may be T-shaped structures, and the plurality of groove structures 121 shown in FIG. 7E may be conical raised structures. In some embodiments, the widths of the plurality of groove structures 121 may vary arbitrarily (e.g., decrease and then increase, etc.). For example, the plurality of groove structures 121 shown in FIG. 7D may be I-shaped structures. The setting of the plurality of groove structures 121 may be realized by adopting inner hollow structures, and the stiffnesses of the reinforcing member 120 and the clastic element 110 may be ensured while reducing the mass of the reinforcing member 120, thereby enhancing the output of the vibration component 100.

As shown in FIG. 7F, in some embodiments, the reinforcing member 120 including the plurality of groove structures 121 may be integrated with the elastic element 110 as an integrated structure. For example, the reinforcing member 120 including the plurality of groove structures 121 and the clastic element 110 may be processed and molded at one time. In some embodiments, if the integrated structure is used, the plurality of groove structures 121 may be the U-shaped structures (e.g., the square U-shaped structures shown in FIG. 7F) to facilitate setting and processing and reduce the difficulty of processing and manufacturing. In this case, the clastic member of the central region 112 of the elastic element 110 may be provided between the plurality of groove structures 121 of the reinforcing member 120, and the elastic member serving as an elastic region and the reinforcing member 120 serving as a reinforcing region may be arranged side by side. In some embodiments, the plurality of groove structures 121 may also be other types of hollow structures (e.g., the I-shaped structures, the T-shaped structures, etc.), as long as that the stiffnesses of the reinforcing member 120 and the elastic element 110 may be ensured while reducing the mass of the reinforcing member 120.

As shown in FIG. 7G, in some embodiments, hollow portions of the plurality of groove structures 121 of the reinforcing member 120 may be provided with a filling material to adjust the mass and the stiffness of the reinforcing member 120 and enhance the output of the vibration component 100. In some embodiments, a Young's modulus of the filling material may be less than a Young's modulus of a material of the elastic element 110 to reduce interference of the filling material on a vibration deformation of the elastic element 110. In some embodiments, the filling material may include a non-metallic material or a metallic material. In some embodiments, the non-metallic material used as the filling material may include, but is not limited to, any one of polycarbonate (PC), polyamides (PA), acrylonitrile butadiene styrene (ABS), polystyrene (PS), high impact polystyrene (HIPS), polypropylene (PP), polyethylene terephthalate (PET), polyvinyl chloride (PVC), polyurethanes (PU), polyethylene (PE), phenol formaldehyde (PF), urea-formaldehyde (UF), melamine-formaldehyde (MF), polyarylate (PAR), polyetherimide (PEI), polyimide (PI), polyethylene naphthalate two formic acid glycol ester (PEN), polyetheretherketone (PEEK), carbon fiber, graphene, silica gel, etc., or any combination thereof. In some embodiments, the metallic material used as the filling material may include an aluminum alloy, a magnesium-lithium alloy, copper, stainless steel, or the like.

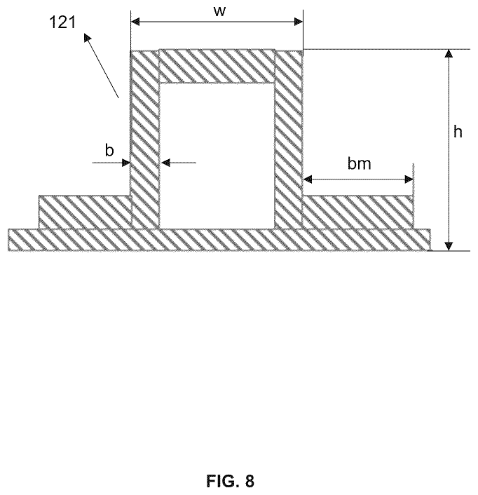

Referring to FIG. 7A and FIG. 8, FIG. 8 is a schematic structural diagram illustrating a plurality of groove structures according to some embodiments of the present disclosure. In some embodiments, structural and dimensional parameters of the plurality of structures 121 may have a very large effect on a stiffness of the reinforcing member 120, and thus the stiffness and a mass the reinforcing member 120 may be adjusted by adjusting the structural and dimensional parameters of the plurality of structures 121. As shown in FIG. 8, the plurality of structures 121 may have a height dimension h in a vibration direction, the plurality of structures 121 may have a width dimension w in a direction perpendicular to the vibration direction, a sidewall of each of the plurality of structures 121 may have a thickness dimension b, and an opening of each of the plurality of structures 121 may be provided with a skirt structure in the direction (e.g., extending in a surface of an elastic member) perpendicular to the vibration direction, and a width of the skirt structure may be bm. The stiffness of the reinforcing member 120 including the plurality of groove structures 121 may be mainly provided by the plurality of groove structures 121. For the internally hollow groove structures 121, the stiffness may be mainly a flexural stiffness EI, E may be the Young's modulus, and I may be an inertia moment. For the plurality of groove structures 121 as shown in FIG. 7A and FIG. 8, the corresponding inertia moment I of the reinforcing member 120 may be calculated by the following Equation:

$$I = [ wh \hat{} 3 - ( w - 2 b ) 〚 ( h - 2 b ) 〛 \hat{} 3 ] \qquad ( Equation 1 )$$

According to the Equation 1, the inertia moment I of the reinforcing member 120 including the plurality of groove structures 121 may be determined only by the height h, the width w, and the thickness b of the reinforcing member 120, wherein both h and b belong to cubic quantity parameters, which have significant effect on the stiffness of the stiffening member 120 including the plurality of groove structures 121.

If the parameter h increases, the inertia moment I may increase, which further causes an increase in the stiffness of the reinforcing member including the plurality of groove structures 121, which in turn causes the second resonance peak 230 of a loudspeaker to move backward; or if the parameter h decreases, the stiffness of the reinforcing member 120 may decrease, and the second resonance peak 230 of the vibration component 100 may move forward. Similarly, if the parameter b increases, the inertia moment I may increase, which further causes an increase in the stiffness of the reinforcing member 120 including the plurality of groove structures 121, and causes the second resonance peak 230 of the vibration component 100 to move backward; or if the parameter b decreases, the stiffness of the reinforcing member 120 may decrease, and the second resonance peak 230 of the vibration component 100 may move forward.

In some embodiments, the parameters h and b may be simultaneously optimized. By optimizing and increasing the value of h and synchronously optimizing and decreasing the value of b, the stiffness of the reinforcing member 120 including the plurality of groove structures 121 may remain constant and the mass may decrease, a frequency value of the second resonance peak 230 of the vibration component 100 may remain constant, and the output frequency response of the vibration component 100 may be enhanced; or, by optimizing and decreasing the value of h and synchronously optimizing and increasing the value of b, the stiffness of the reinforcing member 120 including the plurality of groove structures 121 may remain constant and the mass may increase, the frequency value of the second resonance peak 230 of the vibration component 100 may remain constant, and the output frequency response of the vibration component 100 may be reduced.

In some embodiments, by simultaneously optimizing the parameters h and b, such as optimizing and increasing the value of h and synchronously optimizing and decreasing the value of b, the stiffness of the reinforcing member 120 including the plurality of groove structures 121 may be reduced and the mass may be reduced, causing the second resonance peak 230 of the vibration component 100 to move forward, and enhancing the output frequency response of the vibration component 100.

In some embodiments, by simultaneously optimizing the parameters h and b, such as optimizing and increasing the value of h and synchronously optimizing and decreasing the value of b, the stiffness of the reinforcing member 120 including the plurality of groove structures 121 may be reduced and the mass may be increased, causing the second resonance peak 230 of the vibration component 100 to move forward, and enhancing the output frequency response of the vibration component 100.

A physical quantity λ is defined to be a ratio of a height h to a thickness b of the reinforcing member 120 including the plurality of groove structures 121, i.e.

$$λ = h / b \qquad ( Equation 2 )$$

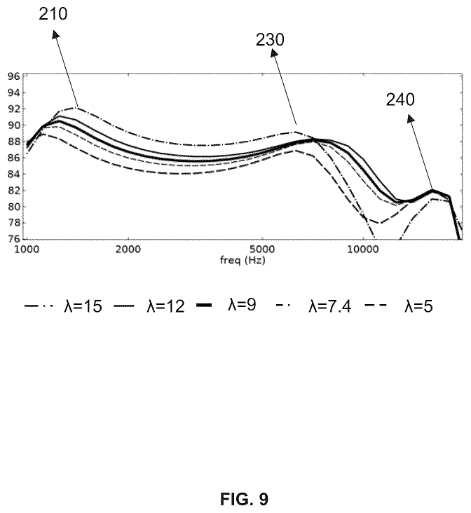

Referring to FIG. 9, FIG. 9 is a schematic diagram illustrating a frequency response curve of a vibration component according to some embodiments of the present disclosure. According to FIG. 9, in some embodiments, a curve λ=5 may be compared with a curve λ=15, or λ=7.14 with λ=9 and λ=12, it can be obtained that, by increasing the ratio A, the effect that the frequency value of the second resonance peak 230 of the vibration component 100 may be constant and the output may be increased. For example, the parameters h and b may be simultaneously optimized. By optimizing and increasing the value of h and synchronously optimizing and decreasing the value of b, the stiffness of the reinforcing member 120 including the plurality of groove structures 121 may remain constant and the mass may be reduced. In some embodiments, according to FIG. 9, the output of the vibration component 100 may gradually increase with an increase in λ. Specifically, when A is small, for example, when λ=5, the output sound pressure level may be significantly lower as compared to λ=12, λ=9, λ=7.14, and λ=15, and the frequency of the second resonance peak 230 may be reduced such that a relatively flat bandwidth between the first resonance peak 210 and the second resonance peak 230 may be reduced. When λ=15, although the reduced frequency of the second resonance peak 230 makes the relatively flat bandwidth between the first resonance peak 210 and the second resonance peak 230 reduced compared to λ=12, λ=9, or λ=7.14, it is advantageous in some narrow-band application scenarios due to the substantial enhancement of the output sound pressure level. To this end, λ may take a relatively large value.

By setting the ratio 2, the frequency value of the second resonance peak 230 of the vibration component 100 and the output sensitivity may be effectively adjusted, such that the second resonance peak 230 of the vibration component 100 may be located in a range of 6000 Hz-8000 Hz and may have a high sensitivity. In some embodiments, the ratio A of the height h to the thickness b of the reinforcing member 120 including the plurality of groove structures 121 may not be less than 7.14. In some embodiments, more preferably, the ratio 2 of the height h to the thickness b of the reinforcing member 120 including the plurality of groove structures 121 may not be less than 9.

According to Equation 1 and FIG. 9, the height h and the thickness b of the reinforcing member 120 may both belong to a cubic quantity parameter, which has a significant effect on the stiffness of the reinforcing member 120 including the plurality of groove structures 121. In addition, as the ratio λ of the height h to the thickness b of the reinforcing member 120 including the plurality of groove structures 121 increases, the reinforcing portion 120 may have smaller mass and the reinforcing portion 120 may have a larger stiffness, making the vibration component 100 have a larger output. However, as the height h and the thickness b of the reinforcing member 120 including the plurality of groove structures 121 change, the process difficulty and the overall reliability of the reinforcing member 120 may be affected.

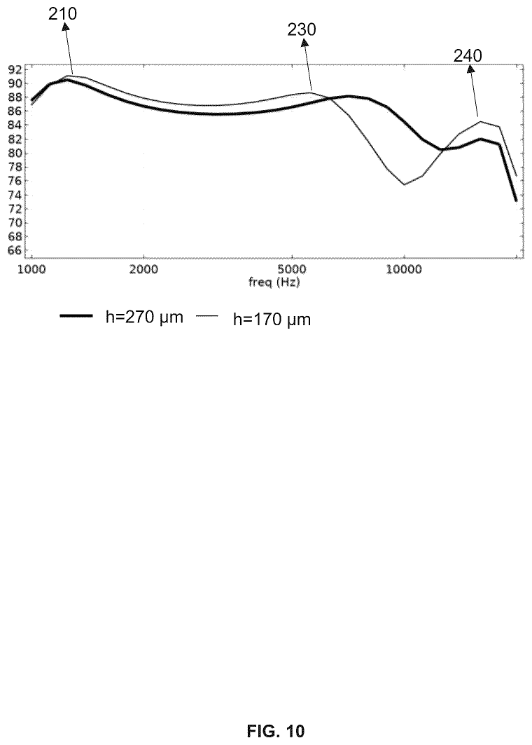

Referring to FIG. 10, FIG. 10 is schematic diagram illustrating frequency response curves of a vibration component corresponding to different heights of a reinforcing member according to some embodiments of the present disclosure. According to FIG. 10, as the height h of the reinforcing member 120 including the plurality of groove structures 121 decreases, a stiffness of the reinforcing member 120 including the plurality of groove structures 121 may decrease, and the second resonance peak 230 of the vibration component 100 may move forward, and the sensitivity may correspondingly increase. In addition, the height h of the reinforcing member 120 including the plurality of groove structures 121 may be within a range of 170 μm-270 μm, both realizing a relatively good output.

A relatively high height h may be beneficial for the performance of a loudspeaker. However, as the height h of the reinforcing member 120 including the plurality of groove structures 121 increases, the difficulty of the processing process (e.g., chemical etching, tool processing, laser cutting, electrochemical processing, or injection molding, thermoforming, etc., for non-metallic materials) of the reinforcing member 120 may increase dramatically. With the increase of h, the processing accuracy may not be guaranteed. Considering the actual processing process, in some embodiments, the height h of the reinforcing member 120 including the plurality of groove structures 121 may be within a range of 50 μm-500 μm. In some embodiments, in order to further reduce the actual processing difficulty, the height h of the reinforcing member 120 including the plurality of groove structures 121 may be within a range of 200 μm-350 μm.

Referring to FIG. 11, FIG. 11 is schematic diagram illustrating frequency response curves of a vibration component corresponding to different thicknesses of a reinforcing member according to some embodiments of the present disclosure. From FIG. 11, it can be seen that as the thickness b of the reinforcing member 120 including the plurality of groove structures 121 may decrease, a stiffness of the reinforcing member 120 including the plurality of groove structures 121 may decrease, a mass of the reinforcing member 120 including the plurality of groove structures 121 may decrease, the second resonance peak 230 of the vibration component 100 may move forward, and the sensitivity may correspondingly increase. When the thickness b of the reinforcing member 120 is large, the stiffness and the mass of the reinforcing member 120 may increase, a load formed by the reinforcing member 120 for the vibration component 100 may also increase, which in turn causes the second resonance peak 230 to move back ward, and the output sensitivity of the vibration component 100 may be significantly reduced. For example, when the thickness b is 100 μm, the output may be significantly reduced compared to other thicknesses (e.g., 20 μm, 30 μm, 50 μm, etc.). As the value of the thickness b gradually increases, although the second resonance peak 230 may gradually move forward, the output sensitivity may be greatly improved, and thus the increase in the value of the thickness b may have an advantage in some narrow frequency band application scenarios. To this end, the thickness b may be a relatively small value.

The relatively small thickness b may be beneficial for the performance of a loudspeaker. However, as the thickness b of the reinforcing member 120 including the plurality of groove structures 121 decreases, the reliability of the reinforcing member 120 including the plurality of groove structures 121 may be greatly affected. Considering the reliability of an actual product, in some embodiments, the thickness b of the reinforcing member 120 including the plurality of groove structures 121 may not be greater than 50 μm. In some embodiments, in order to make the reinforcing member 120 including the plurality of groove structures 121 have a high reliability while having a small mass, the thickness b of the reinforcing member 120 including the plurality of groove structures 121 may not be greater than 40 μm.

Referring to FIG. 7G, FIG. 8, and FIG. 12, FIG. 12 is a schematic diagram illustrating a skirt structure according to some embodiments of the present disclosure. A shaded region shown in FIG. 12 represents the skirt structure. From a process perspective, the larger the value of a width bm of the skirt structure, the larger the connection area between the reinforcing member 120 including the plurality of groove structures 121 and the central region 112 of the clastic element 110, thus obtaining a higher bonding strength, and enhancing the reliability of the vibration component 100. Meanwhile, the width bm of the skirt structure may directly determine an area of the suspension region 1121 of the elastic element 110, determine an equivalent mass Mmi, equivalent stiffnesses Kai and Kai′, equivalent damping Rai and Rai′, and other values, and further affect the position of the third resonance peak 240 of the vibration component 100 and the frequency response output of the vibration component 100.

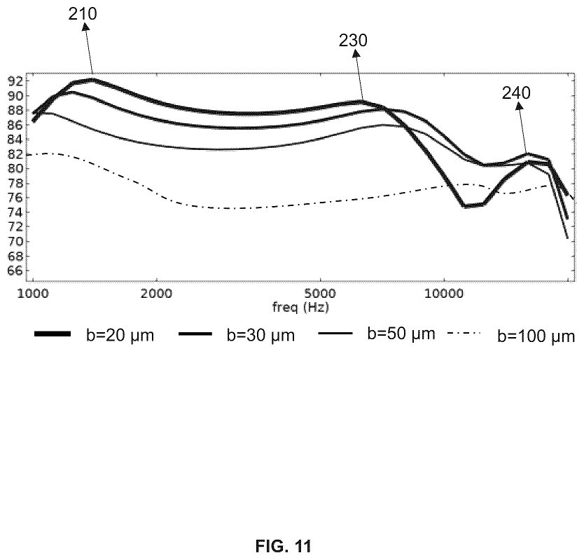

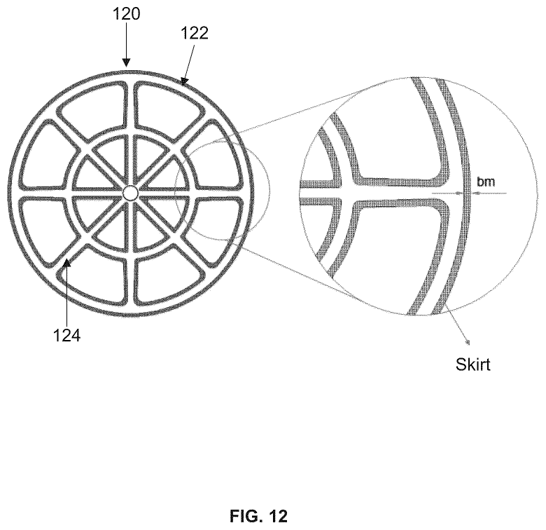

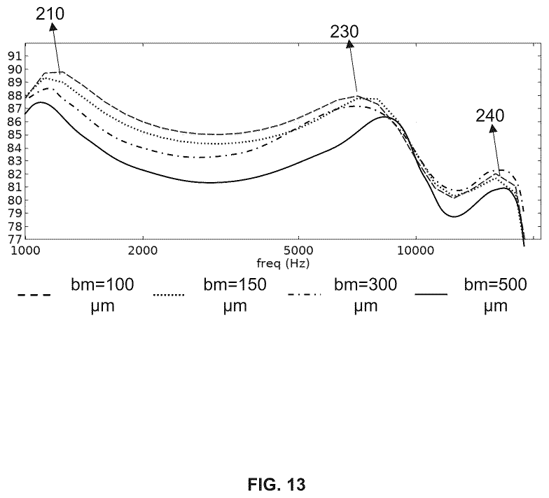

Referring to FIG. 13, FIG. 13 is a schematic diagram illustrating frequency response curves of a vibration component corresponding to a reinforcing member with different widths of skirt structures according to some embodiments of the present disclosure. According to FIG. 13, as the width bm of the skirt structure increases, an output of the vibration component 100 decreases significantly, and an output of the third resonance peak 240 decreases. When the width bm of the skirt structure is set, for the consideration of the performance, the smaller the value of bm, the better the performance. As shown in FIG. 13, when the width bm of the skirt structure is 500 μm, an output SPL is significantly reduced compared with when the width bm is other values (e.g., 100 μm, 150 μm, 300 μm, etc.); meanwhile, the decrease in the value of the width bm of the skirt structure may increase the difficulty of the process. To balance the performance and the process, in some embodiments, the width bm of the skirt structure of the reinforcing member 120 including the plurality of groove structures 121 may be within a range of 100 μm-300 μm. In some embodiments, in order to make the vibration component 100 have relatively good output performance while reducing the process difficulty, the width bm of the skirt structure of the reinforcing member 120 including the plurality of groove structures 121 may be within a range of 100 μm-200 μm.

In some embodiments, when the elastic member or the reinforcing member 120 of the central region 112 is connected within a driving portion of the loudspeaker, a portion of the clastic member at a connection may be subjected to the greatest stress and have the greatest amplitude, and along a direction from the connection to the surrounding region (hereinafter referred to as an extension direction(s)), the farther away from the connection, to the smaller the stress and amplitude of the elastic member. To adapt to different amplitudes or stresses applied to the clastic member at various positions within the central region 112, the stiffnesses of the reinforcing member 120 may be different at various positions within the central region 112 in the extension direction of the reinforcing member 120. In some embodiments, dimensions of the plurality of groove structures 121 of the one or more strip structures 124 and the one or more ring structures 122 at various positions in the extension direction of the reinforcing member 120 may be different, and/or distances between adjacent groove structures 121 of the plurality of groove structures 121 may be different. In some embodiments, when the central connection portion 123 is connected with the driving portion of the loudspeaker, from a groove structure 121 close to the central connection portion 123 to a groove structure 121 close to the folded ring region 114 in the extension direction, stiffnesses of the grooves structures 121 may gradually decrease. For example, in the extension direction, from the groove structure 121 close to the central connection portion 123 to the groove structure 121 close to the folded ring region 114, the parameters h of the groove structures 121 may gradually decrease. As another example, in the extension direction, from the groove structure 121 close to the central connection portion 123 to the groove structure 121 close to the folded ring region 114, the parameters b of the groove structures 121 may gradually decrease. As another example, in the extension direction, from the groove structure 121 close to the central connection portion 123 to the groove structure 121 close to the folded ring region 114, the parameters bm of the groove structures 121 may gradually decrease. In some embodiments, in the extension direction, the distance between the groove structure 121 close to the central connection portion 123 and an adjacent groove structure 121 (an adjacent ring structure 122) away from the central connection portion 123 may gradually increase to a distance between the groove structure 121 close to the folded ring region 114 and an adjacent groove structure 121 (the adjacent ring structure 122) away from the folded ring region 114. The distance between the adjacent groove structures 121 herein refers to a distance between centers (centroids) of the adjacent groove structures 121 (the adjacent ring structures 122).

Some embodiments of the present disclosure further provide a preparation process for a reinforcing member 120 including a plurality of groove structures 121. In some embodiments, the reinforcing member 120 including the plurality of groove structures 121 may be made of a non-metallic material or a metallic material.

In some embodiments, in order to increase a stiffness of the reinforcing member 120 and increase an amplitude of the reinforcing member 120 by increasing an elasticity of an elastic member, thereby improving an output of the vibration component 100, a Young's modulus of a material of the reinforcing member 120 (also referred to as a reinforcing region) may be higher than a Young's modulus of a material of the clastic member (also referred to as an elastic region). In some embodiments, the material of the reinforcing member 120 may be different from the material of the clastic member. For example, the reinforcing member 120 may be made of a metallic material with a relatively large stiffness, and the elastic member may be made of a non-metallic material with a relatively small stiffness. In some embodiments, the material of the reinforcing member 120 may be the same as the material of the clastic member. For example, both the reinforcing member 120 and the clastic member may be made of the non-metallic material. In this case, the reinforcing member 120 may be regarded as a structure that increases the stiffness of the clastic element 110 by structural setting.

In some embodiments, the material of the reinforcing member 120 including the plurality of groove structures 121 may be a composite of one or more of polyether ether ketone (PEEK), polyimide (PI), polyethylene naphthalene (PEN), polyurethane (PU), thermoplastic elastomers (TPE), polyetherimide (PEI), silica gel, carbon fibers, polypropylene (PT), parchment fibers, or the like. The material of the clastic element 110 may include, but is not limited to, one or more of PEEK, PI, PEN, PU, PEI, and silicone. The non-metallic material has less processing difficulty and easier guarantee in processing consistency.

In some embodiments, the vibration component may be prepared by the following steps. A plurality of groove structures and hollow structures may be prepared on the reinforcing member; and the vibration component may be prepared by connecting the reinforcing member and the clastic element. In some embodiments, the plurality of groove structures may be prepared by a first process. In some embodiments, the first process may include one or more of injection molding, thermoforming, etching, tool processing, laser cutting, and electrochemical processing. In some embodiments, the hollow structures may be prepared by a second process. In some embodiments, the second process may include laser cutting. In some embodiments, the plurality of groove structures and the hollow structures may also be prepared by an integrated molding process. In some embodiments, after the reinforcing member is prepared, the vibration component may be prepared by gluing (e.g., spraying adhesive gluc) on the reinforcing member or the clastic element and connecting the reinforcing member and the elastic element by hot press molding.

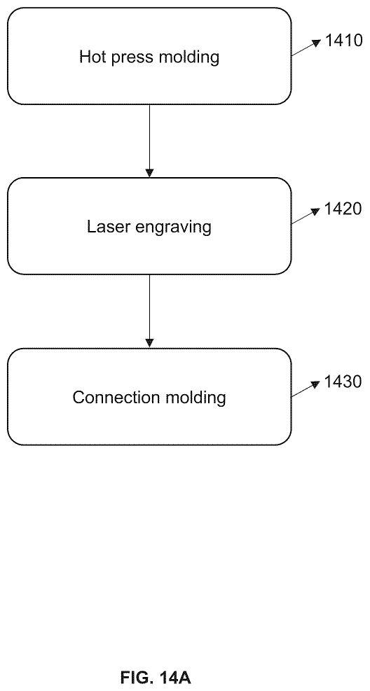

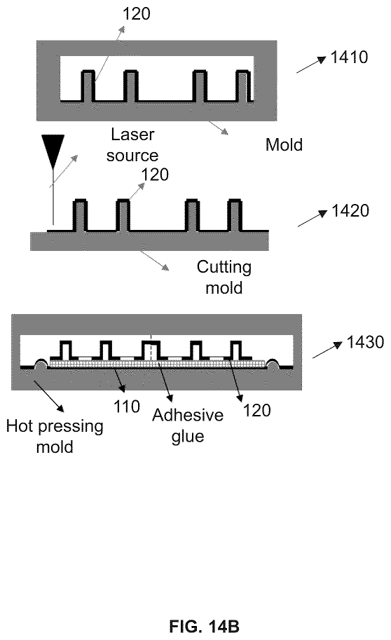

Referring to FIG. 14A and FIG. 14B, FIG. 14A is a schematic diagram illustrating a process of preparing a reinforcing member made of a non-metallic material and a vibration component according to some embodiments of the present disclosure, and FIG. 14B is a schematic diagram illustrating a model corresponding to FIG. 14A. In some embodiments, when a material of the reinforcing member 120 (also referred to as a reinforcing region) is the same as a material of the clastic member (also referred to as the clastic region), the reinforcing member 120 may be made of a non-metallic material. For the non-metallic reinforcing member 120 including the plurality of groove structures 121, the processing process may include the following steps.

In 1410, hot press molding may be performed.

In some embodiments, the reinforcing member 120 may be prepared using hot press molding. For example, after a processing mold is heated, a liquid specimen may be injected or a solid specimen may be placed, and a model may be fixed on a heating plate by a solid contact pressure or a gas pressure. A melting temperature and time of the specimen may be controlled to achieve hardening and cooling after melting, and then a finished model may be taken out to obtain an initial reinforcing member 120. In some embodiments, the reinforcing member 120 may also be prepared by other processes capable of treating the non-metallic materials, which is not repeated in the present disclosure. In some embodiments, during the hot press molding process, the plurality of groove structures 121 may be directly obtained by performing hot pressing by setting the corresponding mold (i.e., a plurality of grooves are hot-pressed on the reinforcing member 120). In some embodiments, the plurality of grooves may be obtained by removing a material from a preset region of the reinforcing member 120 using laser engraving, such that the reinforcing member 120 may include the plurality of groove structures 121. In some embodiments, the plurality of groove structures 121 may also be processed in the reinforcing member 120 through other processes, such as rot engraving, etc., which are not described in the present disclosure.

In 1420, laser engraving may be performed.

In some embodiments, hollow structures may be obtained by removing the material from preset regions of the reinforcing member 120 using laser engraving. In some embodiments, the hollow structures on the reinforcing member 120 may be obtained through other processes, such as rot engraving, etc., which are not described in the present disclosure.

In 1430, connection molding may be performed.

In some embodiments, the reinforcing member 120 including the plurality of groove structures 121 may be connected with the clastic element 110 for final molding. In some embodiments, an adhesive glue may be sprayed on a surface of the clastic element 110 or the reinforcing member 120, and then connection between the clastic element 110 and the reinforcing member 120 may be realized by hot processing and molding. In some embodiments, the connection between the elastic element 110 and the reinforcing member 120 may also be realized by direct hot press fitting without coating the adhesive glue. In some embodiments, the reinforcing member 120 and the elastic element 110 may be connected, processed, and fixed by other means, which are not repeated in the present disclosure.

In some embodiments, the material of the reinforcing member 120 may include, but is not limited to, an aluminum alloy, copper and an alloy thereof, stainless steel, gold and an alloy thereof, tungsten, or the like. Compared with the reinforcing member 120 made of the non-metallic material, the reinforcing member 120 made of the metallic material may have higher stiffness for the same mass, thereby enhancing the output of the vibration component 100.

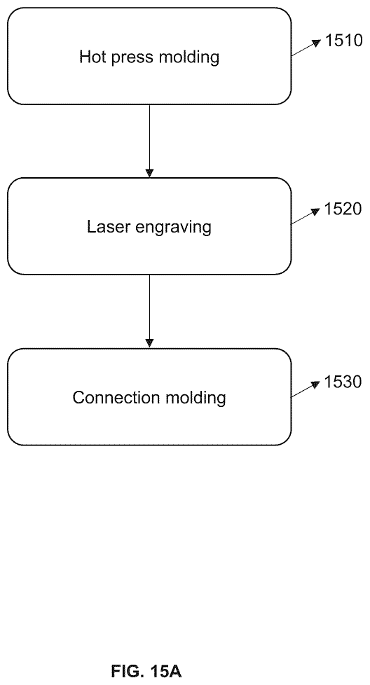

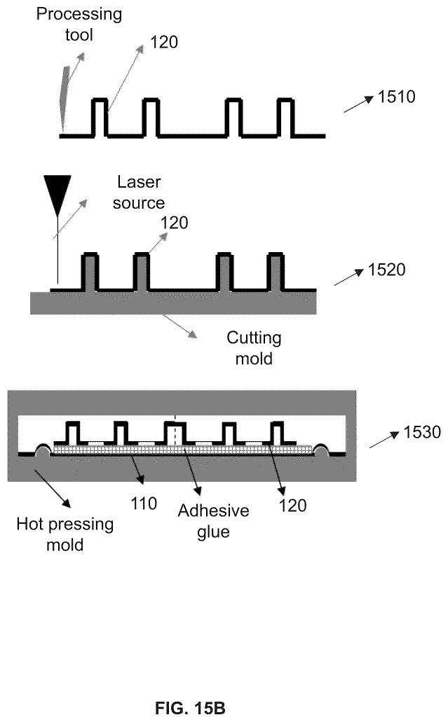

Referring to FIG. 15A and FIG. 15B, FIG. 15A is a schematic diagram illustrating a process of preparing a reinforcing member made of a metallic material according to some embodiments of the present disclosure, and FIG. 15B is a schematic diagram illustrating a model corresponding to FIG. 14A. In some embodiments, when the material of the reinforcing member 120 (also referred to as a reinforcing region) is different from the material of the elastic element (also referred to as an elastic region), the reinforcing member 120 may be made of the metallic material. For the reinforcing member 120 made of the metallic material and including the plurality of groove structures 121, the processing process may generally include the following steps.

In 1510, processing and molding may be performed.

In some embodiments, processing and molding may include one or more processes capable of processing the metallic material, such as chemical etching, tooling, laser cutting, electrochemical processing, or the like.

In 1520, laser engraving may be performed.

In some embodiments, operation 1520 may be the same as operation 1420, which is not repeated here.

In some embodiments, operation 1520 may be performed synchronously with operation 1510, i.e., the plurality of groove structures 121 of the reinforcing member 120 may be directly integrated with the reinforcing member 120.

In 1530, connection molding may be performed.

In some embodiments, operation 1530 may be the same as operation 1430, which is not repeated here.

In some embodiments, a relationship between an area of the suspension region 1121 and the folded ring region 114 and a thickness of the elastic element 110 may affect the local equivalent mass Mm3, the local equivalent mass Mm2, the local regional stiffness Ka2′, and the local regional stiffness Ka1′, thus affecting a range in which the second resonance peak 230 of the vibration component 100 is located.

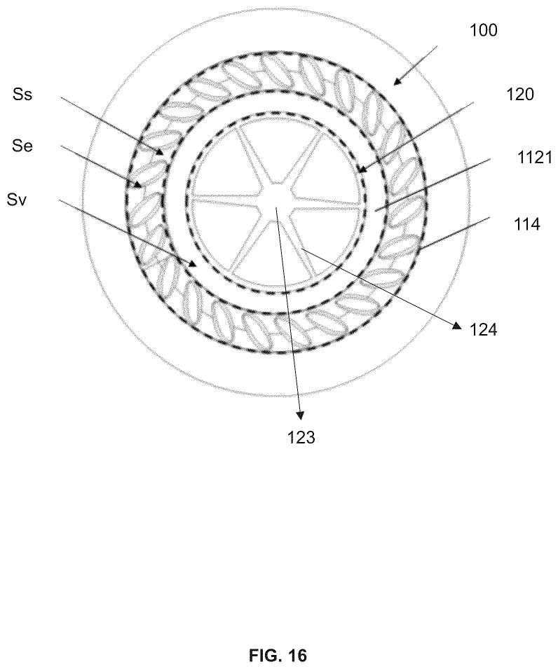

Referring to FIG. 16, FIG. 16 is a schematic diagram illustrating an exemplary vibration component including a reinforcing member with a single ring structure according to some embodiments of the present disclosure. In some embodiments, the reinforcing member 120 may include a central connection portion 123 and the one or more strip structures 124. The one or more strip structures 124 may extend from the central connection portion 123 of the reinforcing member 120 to the surroundings. Cross sections of the one or more strip structures 124 may be provided with the plurality of groove structures 121. A horizontal projection area of the suspension region 1121 is defined as Sv and a horizontal projection area of the folded ring region 114 is defined as Se, and a sum of the horizontal projection area Sv of the suspension region 1121 and the horizontal projection area Se of the folded ring region 114 is defined as Ss. A physical quantity α (in mm) is defined as a ratio of Ss to a thickness (also referred to as a thickness of a vibration diaphragm) Hi of the elastic element 110:

$$α = Ss / Hi . \qquad ( Equation 3 )$$

In some embodiments, in order to cause the second resonance peak 230 to be within a range of 5000 Hz-10000 Hz, the ratio α of Ss to the thickness Hi of the vibration diaphragm may be within a range of 5000 mm-12000 mm. In some embodiments, in order to cause the second resonance peak 230 to be within a range of 6000 Hz-9000 Hz, a may be within a range of 6000 mm-10000 mm. In some embodiments, in order to cause the second resonance peak 230 to be within a range of 6000 Hz-8500 Hz, a may be within a range of 6000 mm-9000 mm. In some embodiments, in order to cause the second resonance peak 230 to be within a range of 6000 Hz-8000 Hz, a may be within a range of 6000 mm-8000 mm. In some embodiments, in order to cause the second resonance peak 230 to be within a range of 6000 Hz-7500 Hz, a may be within a range of 6000 mm-7000 mm. In some embodiments, in order to cause the second resonance peak 230 to be within a range of 7000 Hz-8500 Hz, a may be within a range of 7000 mm-9000 mm. In some embodiments, in order to cause the second resonance peak 230 to be within a range of 7000 Hz-8000 Hz, a may be within a range of 7000 mm-8000 mm.

In some embodiments, by setting a folded ring arch height of the folded ring region 114, a three-dimensional dimension of the folded ring region 114 of the vibration component 100 may be changed without changing a projection area of the folded ring region 114 and the suspension region 1121 of the vibration component 100 in a horizontal direction, thereby changing the stiffness Ka1′ of the folded ring region 114, and thus realizing the control of the second resonance peak of the vibration component 100.

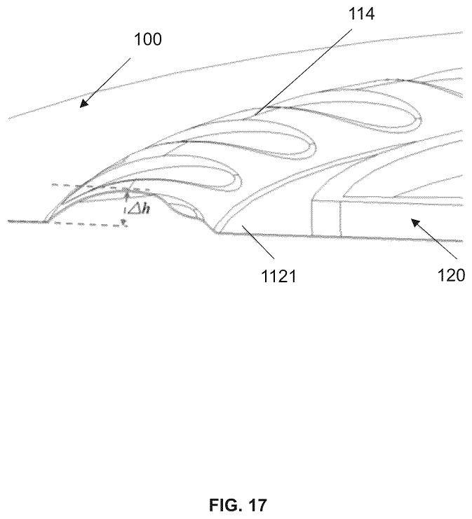

Referring to FIG. 17, FIG. 17 is a schematic diagram illustrating a local structure of a vibration component according to some embodiments of the present disclosure. In the present disclosure, a folded ring arch height of the folded ring region 114 is defined as Δh, and a physical quantity δ (in mm) is defined as a ratio of Ss to the folded ring arch height Δh of the vibration diaphragm:

$$δ = Ss / Δ h . \qquad ( Equation 4 )$$

In some embodiments, δ may be within a range of 50 mm-600 mm. In some embodiments, in order to make the folded ring region 114 have an appropriate three-dimensional dimension, δ may be within a range of 100 mm-500 mm. Preferably, 8 may be within a range of 200 mm-400 mm. More preferably, δ may be within a range of 250 mm-400 mm. In some embodiments, in order to make the folded ring region 114 have an appropriate stiffness, δ may be within a range of 250 mm-350 mm. Preferably, δ may be within a range of 250 mm-300 mm. More preferably, δ may be within a range of 200 mm-300 mm.

In some embodiments, a dimension (or an area) of the suspension region 1121 between the folded ring region 114 and the reinforcing member 120 may be adjusted by setting a horizontal projection area of a maximum contour of the reinforcing member 120 (i.e., a dimension of the outermost ring structure 122), thereby changing the equivalent mass Mt1 and the equivalent stiffness Kt1, and adjusting a range in which the second resonance peak 230 of the vibration component 100 is located.

In the present disclosure, a horizontal projection area of the central region 112 is defined as Sc, the horizontal projection area of the maximum contour of the reinforcing member 120 is defined as Srm, and a horizontal projection area of the suspension region 1121 is defined as Sv, wherein Srm=Sc-Sv.

In the present disclosure, a physical quantity l (in unit of 1) is defined as a ratio of the horizontal projection area Sv of the suspension region 1121 to the horizontal projection area Sc of the central region 112:

$$ϑ = Sv / Sc . \qquad ( Equation 5 )$$

In some embodiments, l may be within a range of 0.05-0.7. In some embodiments, in order to make the suspension region 1121 have an appropriate dimensional or area, l may be within a range of 0.1-0.5. Preferably, l may be within a range of 0.15-0.35. More preferably, l may be within a range of 0.15-0.5. In some embodiments, in order to make the equivalent mass Mt1 and the equivalent stiffness Kt1 have appropriate values, l may be within a range of 0.2-0.5. Preferably, l may be within a range of 0.15-0.25. More preferably, l may be within a range of 0.15-0.2.

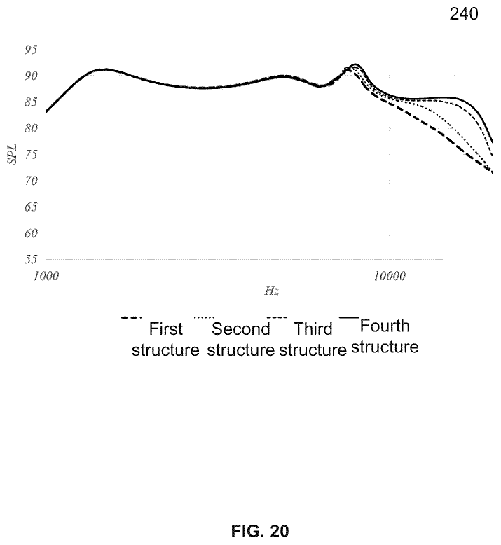

In some embodiments, the one or more strip structures 124 may have different widths, shapes, and counts to change hollow regions (corresponding to a suspension region of the central region 112) of the reinforcing member 120, so as to adjust a frequency of a frequency response of a loudspeaker. More descriptions may be found in FIG. 20-FIG. 25E and related descriptions thereof.

In some embodiments, a resonance frequency of the vibration component 100 may be adjusted by setting areas (e.g., by setting the counts and positions of the one or more strip structures 124 of the reinforcing member 120, counts and positions of the one or more ring structures 122, etc.) of the hollow regions, thereby improving the use performance of the vibration component 100.

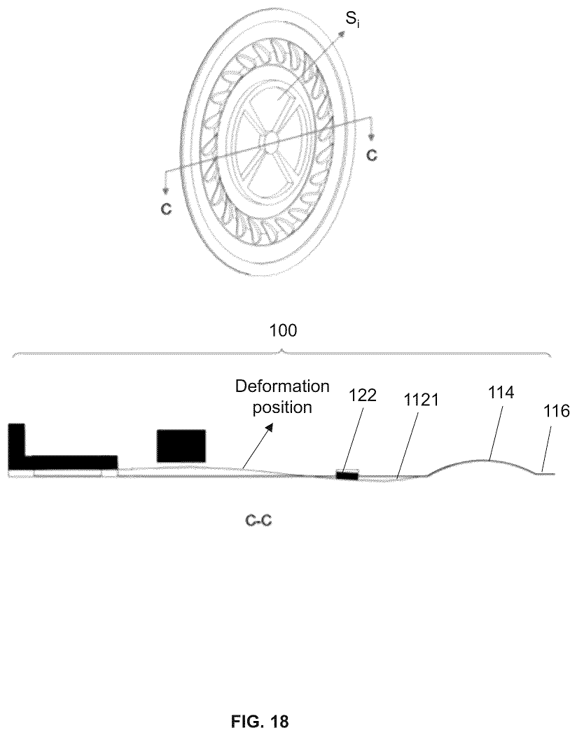

Referring to FIG. 5A and FIG. 18, FIG. 18 is a schematic diagram illustrating a deformation of a C-C cross-section of a vibration component near a third resonance peak according to some embodiments of the present disclosure. According to FIG. 5A, a difference between frequencies of the third resonance peak 240 and the second resonance peak 230 may have a relatively large effect on the flatness of a frequency response curve of the vibration component 100 within a high frequency band. In some embodiments, referring to FIG. 18, as can be seen from the vibration of the vibration component 100 in the C-C cross-section, near the frequency of the third resonance peak, a main deformation position of the vibration component 100 may be a deformation generated by the hollow regions of the central region 112. In some embodiments, the third resonance peak 240 of the vibration component 100 may be controlled by controlling the equivalent mass Mmi and the equivalent stiffness Kai of the mass-spring-damping system corresponding to each of the hollow regions of the central region 112 corresponding to the reinforcing member 120. For example, an area of each of the hollow regions of the central region 112 may be adjusted by setting counts and dimensions of the one or more strip structures 124 and the one or more ring structures 122. The area of each of the hollow regions is defined as Si. It should be noted that while FIG. 18 illustrates the deformation of the vibration component 100 including the reinforcing member 120 with a single ring structure at the third resonance peak, this conclusion still applies to the vibration component including the reinforcing member 120 with a plurality of ring structures.

In order to cause the third resonance peak to be within an appropriate frequency range (12000 Hz-18000 Hz), the present disclosure defines a physical quantity: a ratio of the area Si of any of the hollow regions to the thickness Hi of the vibration diaphragm in the hollow region is denoted as an area-thickness ratio μ (in mm):

$$μ = Si / Hi . \qquad ( Equation 6 )$$

A frequency position of the third resonance peak of the vibration component may be adjusted by setting a value of μ.

In some embodiments, the area-thickness ratio μ may be within a range of 100-1000. In some embodiments, in order to cause each of the hollow regions to have an appropriate equivalent mass Mmi and equivalent stiffness Kai, the area-thickness ratio μ may be within a range of 150-700. In some embodiments, in order to cause each of the hollow regions to have the appropriate equivalent mass Mmi and equivalent stiffness Kai, the area-thickness ratio μ may be within a range of 150-950. In some embodiments, in order to cause each of the hollow regions to have the appropriate equivalent mass Mmi and equivalent stiffness Kai, the area-thickness ratio μ may be within a range of 150-900. In some embodiments, the area-thickness ratio μ may be within a range of 150-800. In some embodiments, in order to cause each of the hollow regions to have the appropriate equivalent mass Mmi and equivalent stiffness Kai, the area-thickness ratio μ may be within a range of 100-700. More preferably, the area-thickness ratio μ may be within a range of 300-500. More preferably, the area-thickness ratio μ may be within a range of 400-600.

It should be noted that the structure shown in FIG. 18 is the single ring structure. The above value of the area-thickness ratio μ is still applicable to the reinforcing member 120 with a plurality of ring structures.

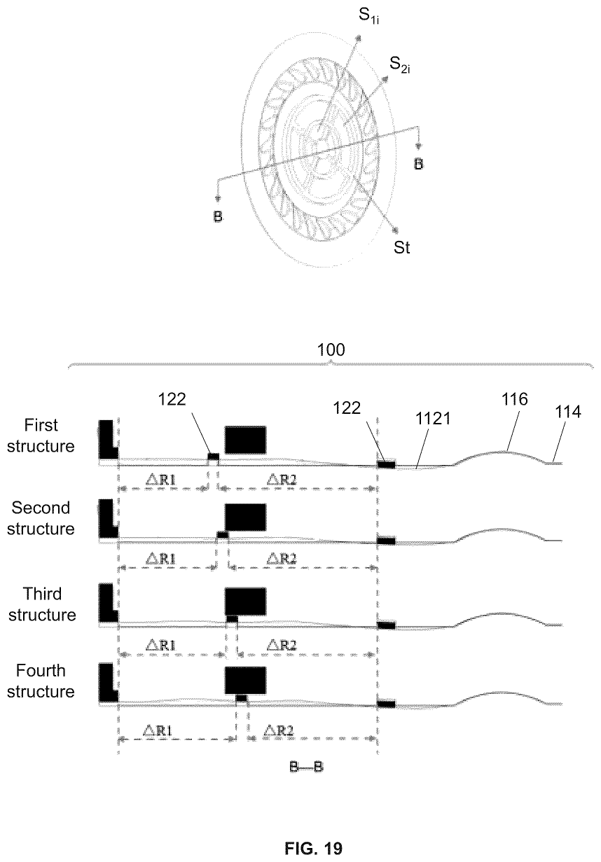

As shown in FIG. 19, in some embodiments, the reinforcing member 120 may have a double ring structure. The present disclosure defines an area of each of the hollow regions of the elastic element 110 within a first ring structure as S1i, and an area of each of the hollow regions of the elastic element 110 between the first ring structure and a second ring structure as S2i. In some embodiments, the reinforcing member 120 may have more ring structures 122. An area of each of the hollow regions of the elastic element 110 between a (n−1)th ring structure and an nth ring structure is defined as Sni. The present disclosure defines a physical quantity γ (in unit of 1) of the ratio of the areas of the hollow regions of the clastic element 110 as a ratio of an area Ski to an area Sji of any two of the hollow regions:

$$γ = Ski / Sji . \qquad ( Equation 7 )$$

Where, k>j. The frequency position of the third resonance peak of the vibration component may be adjusted by setting the value of γ.

As shown in FIG. 19 and FIG. 20, FIG. 20 is a schematic diagram illustrating frequency response curves of a vibration component corresponding to FIG. 19. From a first structure to a fourth structure, an area ratio γ of an area S2i of each of hollow regions between a first ring region and a second ring region to an area S1i of each of the hollow areas within the first ring region may be 5.9, 4.7, 3.9, and 3.2 in sequence. According to FIG. 19, at a position of a third resonance peak of the vibration component 100, from the first structure to the fourth structure, as γ decreases, a radius ΔR1 of a first hollow region within the ring structure 122 located at an inner side gradually increases, and a radius ΔR2 of a second hollow region between the ring structure 122 located at the inner side and the ring structure 122 located at an outer side gradually decreases. In some embodiments, referring to FIG. 20, from the first structure to the fourth structure, sound pressure amplitude outputs of frequency response curves of the vibration component at the position of the third resonance peak gradually increase. Thus, the ratio of the areas of the hollow regions of the central region 112 may affect the resonance frequency of each of the hollow regions, and the effect of superposition of the acoustic pressure in a high frequency band may be obtained. That is, a high frequency sensitivity of the vibration component 100 may be adjusted by setting the value of γ.

In some embodiments, according to FIG. 20, as γ gradually decreases, the more obvious the third resonance peak, the higher the output sound pressure level of the corresponding frequency band. When γ is 5.9 (corresponding to the first structure), the third resonance peak can not be formed, resulting in a significant decrease in the output sound pressure level of the frequency band. In contrast, when γ is less than or equal to 4.7 (e.g., γ=4.7 corresponding to the second structure, γ=3.9 corresponding to the third structure, and γ=3.2 corresponding to the fourth structure), the existence of the third resonance peak may significantly enhance the output of the frequency band. In some embodiments, the ratio γ of the area Ski to the area Sji of any two of the hollow regions may be less than or equal to 4.7. In some embodiments, in order to further enhance the high frequency sensitivity of the vibration component 100, the ratio γ of the area Ski to the area Sji of any two of the hollow regions may be less than or equal to 3.9. In some embodiments, in order to further enhance the high frequency sensitivity of the vibration component 100, the ratio γ of the area Ski to the area Sji of any two of the hollow regions may be less than or equal to 3.5. In some embodiments, the ratio γ of the area Ski to the area Sji of any two of the hollow regions may be less than or equal to 3.2. In some embodiments, in order to further enhance the high frequency sensitivity of the vibration component 100, the ratio γ of the area Ski to the area Sji of any two of the hollow regions may be less than or equal to 3.

In some embodiments, by setting a projection area of the reinforcing member 120 in a vibration direction and a projection area of a maximum contour of the reinforcing member 120 on the central region 112 in the vibration direction, a mass, a centroid, and a stiffness of the reinforcing member 120, and a mass and a stiffness of a suspension region of the central region 112 may be adjusted, thereby adjusting a first resonance peak, a second resonance peak, and a third resonance peak of the vibration component 100.

To facilitate setting of the reinforcing member 120, in the present disclosure, referring to FIG. 19, a ratio β (in unit of 1) of a transverse area of the plurality of groove structures of the reinforcing member 120 to a transverse area of the reinforcing member 120 is defined as a ratio of a projection area Sr of the plurality of groove structures to a projection area St of a maximum contour of the reinforcing member 120 on the central region 112 in a projection shape of the reinforcing member 120 in the vibration direction:

$$β = Sr / St . \qquad ( Equation 8 )$$

In some embodiments, a projection of the reinforcing member 120 in the vibration direction may be a projection of the plurality of groove structures of the reinforcing member 120. A projection of the maximum contour of the reinforcing member 120 may be consistent with a projection of the central region 112.

Referring to FIG. 21, FIG. 21 is a schematic diagram illustrating frequency response curves of a vibration component according to some embodiments of the present disclosure. According to FIG. 21, if a value of the ratio β of the projection area Sr of the reinforcing member 120 to the projection area St of the maximum contour of the reinforcing member 120 changes, an output of the third resonance peak of the loudspeaker may obviously change. When the ratio β is relatively small, the equivalent stiffness Kai′ may decrease and the equivalent mass Mmi may increase, thereby making the third resonance peak move forward (to the low frequency). When the ratio β is relatively large, the equivalent stiffness Kai′ may increase and the equivalent mass Mmi may decrease, thereby making the third resonance peak move backward (to the high frequency).

By setting the value of β, the equivalent stiffness Kai′ and the equivalent mass Mmi may be adjusted such that the third resonance peak of a high frequency of the vibration component may be within an appropriate frequency range, and a difference of resonance frequencies of the hollow structures may be within an appropriate range (e.g., less than or equal to 4000 Hz). In some embodiments, the ratio β of the transverse area of the plurality of groove structures of the reinforcing member 120 to the transverse area of the reinforcing member 120 may be within a range of 0.15-0.8. Preferably, the ratio β of the transverse area of the plurality of groove structures of the reinforcing member 120 to the transverse area of the reinforcing member 120 may be within a range of 0.35-0.65.

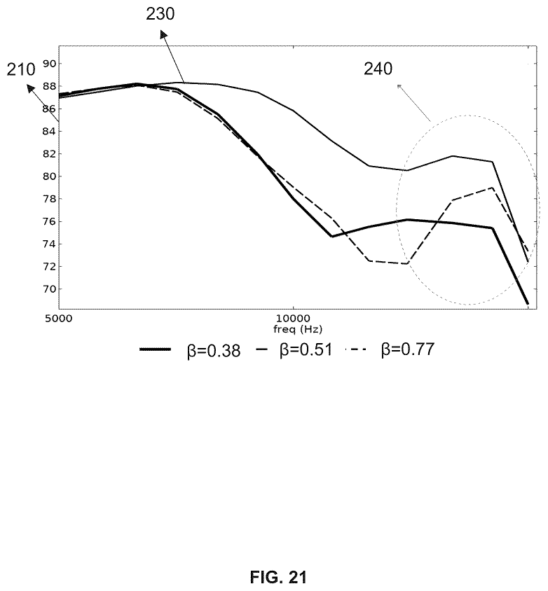

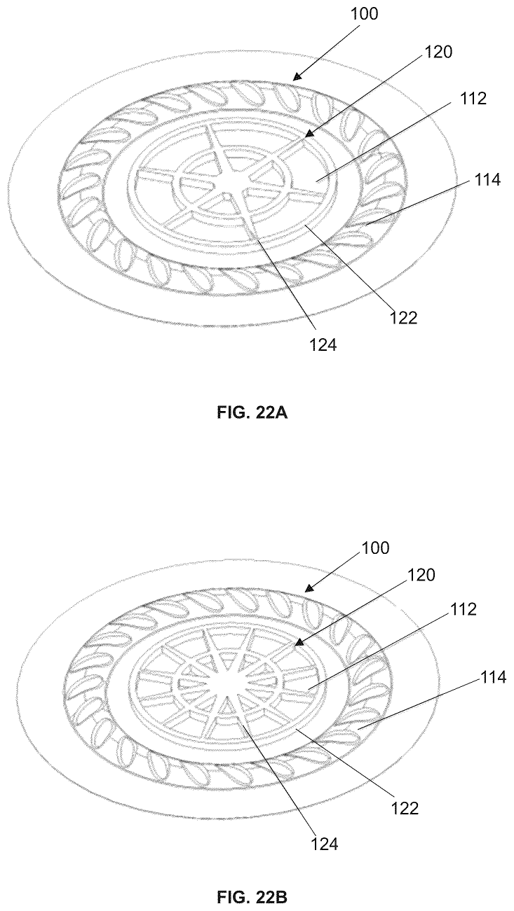

Referring to FIG. 22A and FIG. 22B, FIG. 22A and FIG. 22B are schematic structural diagrams illustrating exemplary vibration components including different counts of strip structures according to some embodiments of the present disclosure. In some embodiments, an overall mass of the vibration component 100 may be adjusted by adjusting a count of the one or more strip structures 124 such that a total equivalent mass Mt formed by a mass of the reinforcing member 120, a mass of the clastic element 110, an equivalent air mass, and a driving end equivalent mass may change, such that a resonance frequency of a mass Mt-spring Kt-damping Rt system may change, which in turn causes a first-order resonance frequency of the vibration component 100 to change, and causes a sensitivity of a low frequency band before a first resonance frequency of the vibration component 100 and a sensitivity of a middle frequency band after the first resonance frequency to change. In some embodiments, a larger number of strip structures 124 may be set such that the total equivalent mass Mt may increase, the first resonant frequency of the vibration component 100 may move forward, and the sensitivity of the low frequency band before the first resonance frequency of the vibration component 100 may enhance, such as a frequency band before 3000 Hz, a frequency band before 2000 Hz, a frequency band before 1000 Hz, a frequency band before 500 Hz, and a frequency band before 300 Hz. In some embodiments, a small number of strip structures 124 may be set, such that the total equivalent mass Mt may decrease and the first resonant frequency of the vibration component 100 may move backward, and the sensitivity of the middle frequency band after the first resonance frequency of the vibration component 100 may be improved. For example, the sensitivity of a frequency band after 3000 Hz may be improved. As another example, the sensitivity of a frequency band after 2000 Hz may be improved. As another example, the sensitivity of a frequency band after 1000 Hz may be improved. As another example, the sensitivity of a frequency band after 500 Hz may be improved. As another example, the sensitivity of a frequency band after 300 Hz may be improved.

In some embodiments, by adjusting the count of the one or more strip structures 124, the stiffness of the reinforcing member 120 may be adjusted, such that the stiffness Kt1 provided to the system by the reinforcing member 120 and the clastic element 110 may change, and the reinforcing member 120, the connection region 115, the folded ring region 114, the suspension region between a region of the central region 112 covered by the reinforcing member 120 and the folded ring region 114, the equivalent air mass, and the driving end equivalent mass may be combined to form the total equivalent mass Mt1, equivalent damping of the portions may form the total equivalent damping Rt1, and the mass Mt1-spring Kt1-damping Rt1 system may be formed. A resonance frequency of a flip movement formed with a certain ring region of the reinforcing member 120 in a diameter direction as an equivalent fixed pivot may change, thereby causing a second resonance position of the vibration component 100 to change.

In some embodiments, by adjusting the count of the one or more strip structures 124, an area of no less than one hollow region the central region 112 corresponding to the reinforcing member 120 may be adjusted such that the equivalent mass Mmi, the equivalent stiffness Kai and Kai′, and equivalent damping Rai and Rai′ of each of the hollow regions may change, thereby causing a position of a third resonance peak of the vibration component to change. In some embodiments, by adjusting the count of the one or more strip structures 124, the area-thickness ratio μ of the vibration component and the ratio β of the transverse area of the plurality of groove structures of the reinforcing member 120 to the transverse area of the reinforcing member 120 may also be adjusted, thereby adjusting the position of the third resonance peak of the vibration component.

In some embodiments, the count of the one or more strip structures 124 of the reinforcing member 120 is adjustable, such that the positions of the first resonance peak, the second resonance peak, and the third resonance peak of the vibration component 100 may be adjusted according to the actual application requirements, thereby realizing controllable adjustment of the frequency response of the vibration component 100.

In some embodiments, the projection shapes of the one or more strip structures 124 in the vibration direction of the clastic element 110 include at least one of a rectangle, a trapezoid, a curve, an hourglass, and a petal, and areas of the hollow regions (corresponding to the suspension region of the central region 112 within a projection range of the reinforcing member 120) of the reinforcing member 120 may be adjusted by adjusting the shapes of the one or more strip structures 124, thereby adjusting a relationship (the area-thickness ratio μ) between the areas of the hollow regions and the thickness of the elastic element 110, thereby adjusting the third resonance peak. The relationship (the ratio γ of the areas of the hollow regions) between the areas of the hollow regions between different ring structures 122 of the reinforcing member 120 may also be changed to adjust the third resonance peak. The relationship (the ratio β of the transverse area of the plurality of structure of the reinforcing member 120 to the transverse area of the reinforcing member 120) between the transverse areas of the plurality of structure of the reinforcing member 120 and the reinforcing member 120 may also be changed to adjust the first resonance peak, the second resonance peak, and the third resonance peak.

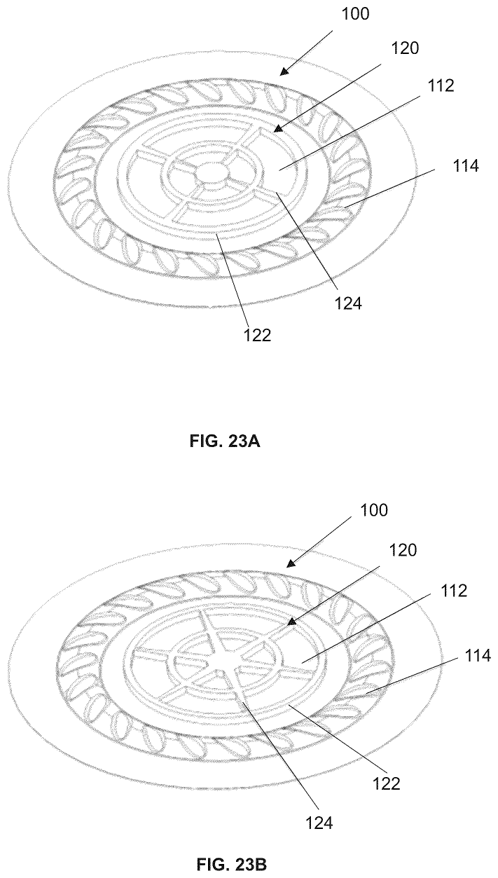

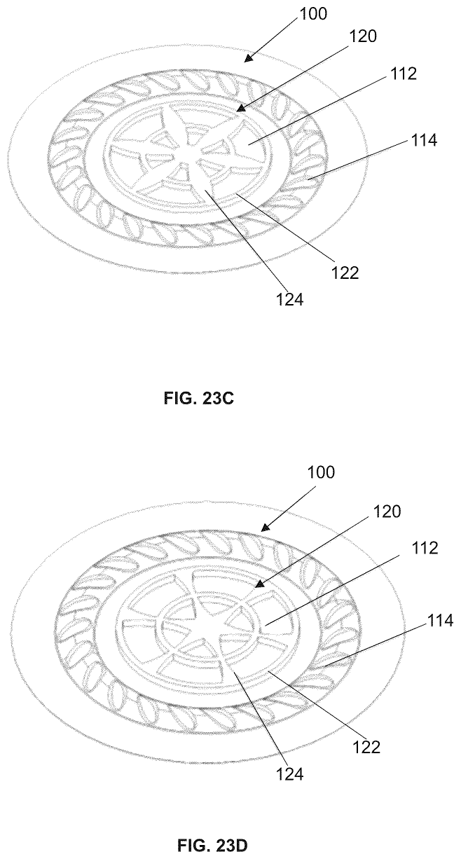

Referring to FIGS. 23A-23D, FIGS. 23A-23D are schematic diagrams illustrating vibration components including different widths of strip structures according to some embodiments of the present disclosure. The one or more strip structures 124 in FIG. 23A may have an inverted trapezoidal shape (i.e., a short side of the trapezoidal shape may be close to a center of the reinforcing member 120). The one or more strip structures 124 in FIG. 23B may have a trapezoidal shape (i.e., the short side of the trapezoidal shape may be away from the center of the reinforcing member 120). The one or more strip structures 124 in FIG. 23C may have an outer arc shape. The one or more strip structures 124 in FIG. 23D may have an inner arc shape. In some embodiments, a position of a centroid of the reinforcing member 120 may be efficiently adjusted by setting the one or more strip structures 124 with different transverse widths. In some embodiments, a stiffness of the reinforcing member 120 may be changed without changing a mass of the reinforcing member 120, such that the stiffness Kt1 provided to the system by the reinforcing member 120 and the clastic element 110 (especially a region of the central region 112 covered by the reinforcing member 120) may change, which causes a resonance frequency of a flip movement of the mass Mt1-spring Kt1-damping Rt1 system to change, thereby causing a second resonance frequency of the vibration component 100 to change.

In some embodiments, by changing the width of the one or more strip structures 124, local stiffnesses of different positions of the one or more strip structures 124 extending from a center to the surroundings may be different. When a driving end frequency is close to a resonance frequency of the Mt1-spring Kt1-damping Rt1 system, the connection region 115 between the fixed region 116 and the folded ring region 114, the folded ring region 114, and the suspension region between the region of the central region 112 covered by the reinforcing member 120 and the folded ring region 114 may be driven to vibrate by the reinforcing member 120, and a resonance peak with an adjustable bandwidth of 3 dB may be generated.

As shown in FIGS. 23 A-23 D, in some embodiments, by setting the inverted trapezoidal strip structures 124, the outer arc-shaped (wherein the outward protrusion forms an outer arc shape and the inward recessing forms as an inner arc shape, and the outer arc shape may include a circular arc, an ellipse, a higher order function arc, and any other arbitrary arc) strip structures 124, the second resonance peak of the vibration component 100 with a relatively large 3 dB bandwidth may be obtained, which may be applied in a scenario requiring a low Q value and a wide bandwidth. In some embodiments, by setting the one or more strip structures 124 having the trapezoidal shape, the rectangular shape, or the inner arc shape (wherein the outward protrusion forms as an outer arc shape and the inward recessing forms as an inner arc shape, and the outer arc shape may include a circular arc, an ellipse, a higher order function arc, and any other arbitrary arc), the second resonance peak of the vibration component 100 with a high sensitivity and a small 3 dB bandwidth may be obtained, which may be applied to a scenario requiring a high Q value and a local high sensitivity.

By setting the one or more strip structures 124 with different transverse widths, the area of not less than one hollow region of the central region 112 corresponding to the reinforcing member 120 may also be adjusted, such that the equivalent mass Mmi, the equivalent stiffness Kai and Kai′, and the equivalent damping Rai and Rai′ may change, which causes the position of the third resonance peak of the vibration component 100 to change.

Therefore, by setting the one or more strip structures 124 with different transverse widths, the frequency position of the second resonance peak of the vibration component 100, the 3 dB bandwidth at the resonance peak, the sensitivity of the vibration component 100 at the resonance peak, and the position of the third resonance peak of the vibration component 100 may change.

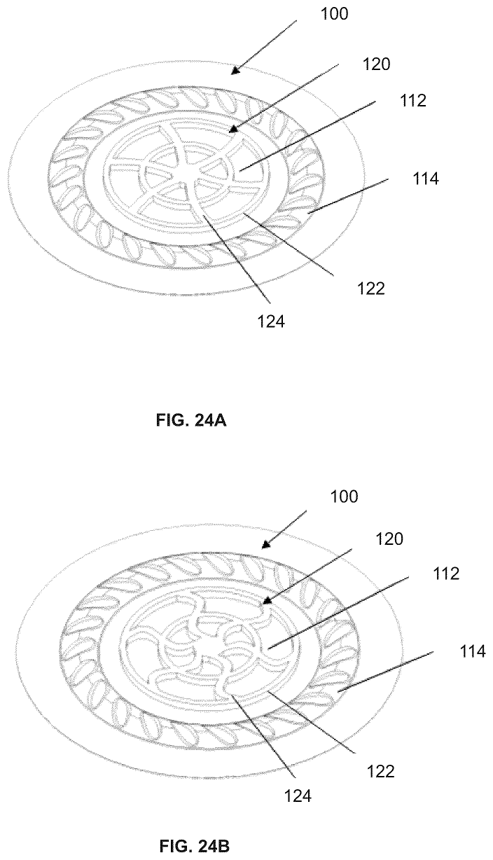

Referring to FIG. 24A and FIG. 24B, FIG. 24A and FIG. 24B are schematic diagrams illustrating vibration components including one or more strip structures with different shapes according to some embodiments of the present disclosure. The one or more strip structure 124 in FIG. 24 A may have a rotary shape, and the one or more strip structures 124 in FIG. 24B may have an S shape. In some embodiments, a stiffness of the reinforcing member 120 may be adjusted by setting the one or more strip structures 124 with different transverse shapes, such that the stiffness Kt1 provided to the system by the reinforcing member 120 and the elastic element 110 (especially the region of the central region 112 covered by the reinforcing member 120) may change, which causes a resonance frequency of a flip movement of the mass Mt1-spring Kt1-damping Rt1 system to change, thereby causing a position of a second resonance peak of the vibration component 100 to change. In some embodiments, an area of no less than one hollow region of the central region 112 corresponding to the reinforcing member may also be adjusted, such that the equivalent mass Mmi, the equivalent stiffness Kai and Kai′, and the equivalent damping Rai and Rai′ may change, thereby causing a position of a third resonance peak of the vibration component 100 to change. In some embodiments, by setting the one or more strip structure 124 with different transverse shapes, a stress distribution within the reinforcing member 120 may be adjusted, and a processing deformation of the reinforcing member 120 may be controlled.

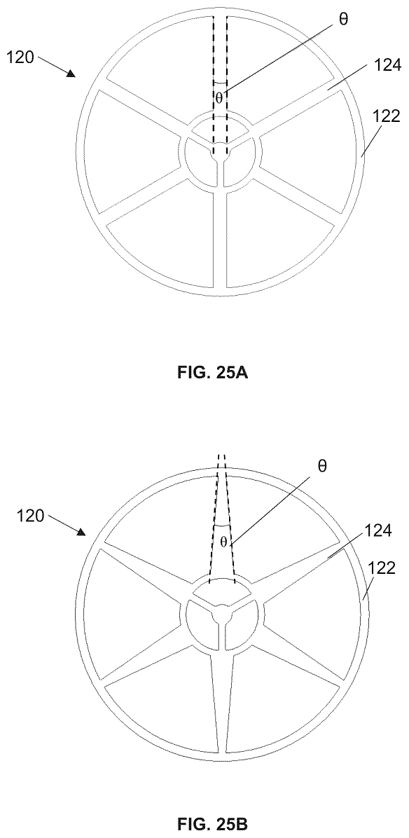

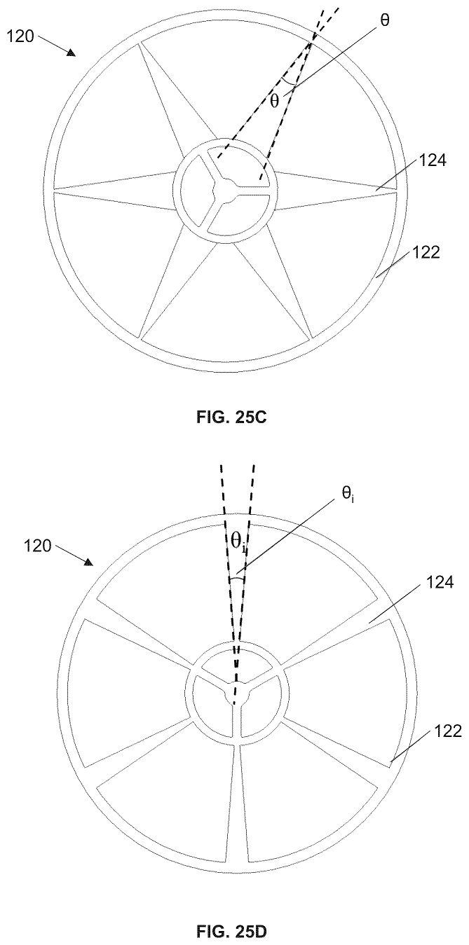

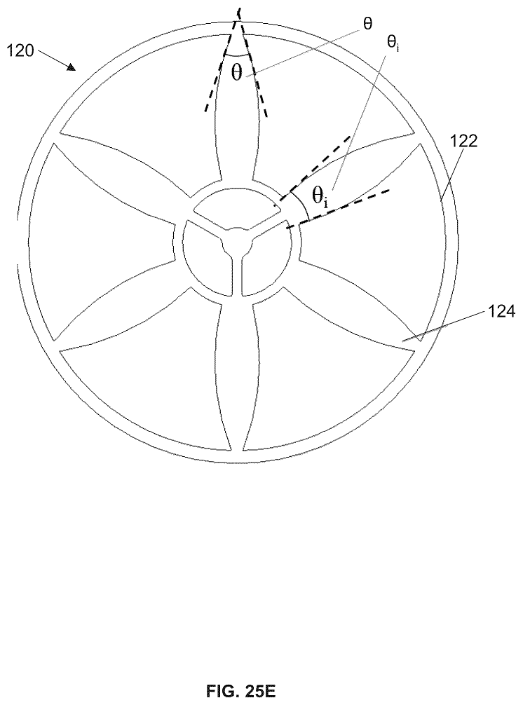

Referring to FIGS. 25A-25E, FIGS. 25A-25E are schematic diagrams illustrating reinforcing members including one or more strip structures of different shapes according to some embodiments of the present disclosure. In some embodiments, in order to accurately adjust the effect of the one or more strip structures of different shapes on a resonance peak (e.g., a first resonance peak, a second resonance peak, and a third resonance peak) of a vibration component, for a strip structure 124 whose width gradually decreases from the center to the edge, a spoke angle is defined as θ. The resonance peak of the vibration component may be adjusted by setting the value of θ. In some embodiments, for a strip structure 124 (as shown in FIGS. 25A-25C) with straight sides, the angle θ may be an angle between two sides of the strip structure 124. In some embodiments, for a strip structure 124 (as shown in FIG. 25E) with curved sides, the angle θ may be an angle between tangent lines of the two sides of the strip structure 124. In some embodiments, in order to accurately adjust the effect of the one or more strip structures of different shapes on the resonance peak (e.g., the first resonance peak, the second resonance peak, and the third resonance peak) of the vibration component, as shown in FIG. 25D, for the strip structure whose width gradually increases from the center to the edge, a spoke angle is defined as θi, and the resonance peak of the vibration component may be adjusted by setting a value of θi. In some embodiments, for the strip structure 124 with straight sides, the angle θi may be an angle between the two sides of the strip structure 124. In some embodiments, for the strip structure 124 with curved sides, the angle θi may be an angle between the tangent lines of the two sides of the strip structure 124.

In some embodiments, by setting the angle θ (or θi) of the one or more strip structures 124, a stiffness of the reinforcing member 120 may be changed without changing or changing a mass of the reinforcing member 120, which causes the stiffness Kt1 provided to the system by the reinforcing member 120 and the clastic element 110 to change, and further causes a resonance frequency of a flip movement of the mass Mt1-spring Kt1-damping Rt1 system to change, thereby causing the position of the second resonance peak of the vibration component 100 to change, and controlling a 3 dB bandwidth of the second resonance peak of the vibration component 100. In some embodiments, the 3 dB bandwidth of the third resonance peak of the vibration component 100 may be effectively increased by increasing the angle θ (or θi) of the one or more strip structures 124.

Corresponding to a certain frequency response of the vibration component 100 requiring a low Q value and a broad bandwidth, a relatively large angle θ (or θi) of the one or more strip structures 124 may be set. In some embodiments, the angle θ of the one or more strip structures 124 may be within a range of 0°-150°. In some embodiments, the angle θ of the one or more strip structures 124 may be within a range of 0°-120°. In some embodiments, the angle θ of the one or more strip structures 124 may be within a range of 0°-90°. In some embodiments, the angle θ of the one or more strip structures 124 may be within a range of 0°-80°. In some embodiments, the angle θ of the one or more strip structures 124 may be within a range of 0°-60°. In some embodiments, the angle θi of the one or more strip structures 124 may be within a range of 0°-90°. In some embodiments, the angle θi of the one or more strip structures 124 may be within a range of 0°-80°. In some embodiments, the angle θi of the one or more strip structures 124 may be within a range of 0°-70°. In some embodiments, the angle θi of the one or more strip structures 124 may be within a range of 0°-60°. In some embodiments, the angle θi of the one or more strip structures 124 may be within a range of 0°-45°.

Corresponding to a certain frequency response of the vibration component 100 requiring a high Q value and a narrow bandwidth, a relatively small angle θ (or θi) of the one or more strip structures 124 may be set. In some embodiments, the angle θ of the one or more strip structures 124 may be within a range of 0°-90°. In some embodiments, the angle θ of the one or more strip structures 124 may be within a range of 0°-80°. In some embodiments, the angle θ of the one or more strip structures 124 may be within a range of 0°-70°. In some embodiments, the angle θ of the one or more strip structures 124 may be within a range of 0°-60°. In some embodiments, the angle θ of the one or more strip structures 124 may be within a range of 0°-45°. In some embodiments, the angle θi of the one or more strip structures 124 may be within a range of 0°-60°. In some embodiments, the angle θi of the one or more strip structures 124 may be within a range of 0°-80°. In some embodiments, the angle θi of the one or more strip structures 124 may be within a range of 0°-90°. In some embodiments, the angle θi of the one or more strip structures 124 may be within a range of 0°-120°. In some embodiments, the angle θi of the one or more strip structures 124 may be within a range of 0-150°.

In some embodiments, a relationship between θ and θi is defined as:

$$θ = - θ i . \qquad ( Equation 9 )$$

Corresponding to a certain frequency response of a loudspeaker requiring a low Q value and a broad bandwidth, a relatively large angle θ of the one or more strip structures 124 may be set. In some embodiments, the angle θ of the one or more strip structures 124 may be within a range of −90°-150°. In some embodiments, the angle θ of the one or more strip structures 124 may be within a range of −45°-90°. In some embodiments, the angle θ of the one or more strip structures 124 may be within a range of 0°-60°.

Corresponding to a certain frequency response of the loudspeaker requiring a high Q value and a narrow bandwidth, a relatively small angle θ of the one or more strip structures 124 may be set. In some embodiments, the angle θ of the one or more strip structures 124 may be within a range of −150°-90°. In some embodiments, the angle θ of the one or more strip structures 124 may be within a range of 90°-45°. In some embodiments, the angle θ of the one or more strip structures 124 may be within a range of −60°-0°.

In some embodiments, for strip structures 124 of irregularly shapes, the angle of the strip structures 124 cannot be set. In this case, a stiffness of the reinforcing member 120 may be changed by adjusting an area of the strip structures 124 without changing or changing a mass of the reinforcing member 120, such that the stiffness Kt1 provided to the system by the reinforcing member 120 and the clastic element 110 may change, which further causes a resonance frequency of a flip movement of the mass Mt1-spring Kt1-damping Rt1 system to change, thereby causing a position of a second resonance peak of the vibration component 100 to change. Furthermore, a 3 dB bandwidth of the second resonance peak of the vibration component 100 may also be controlled.

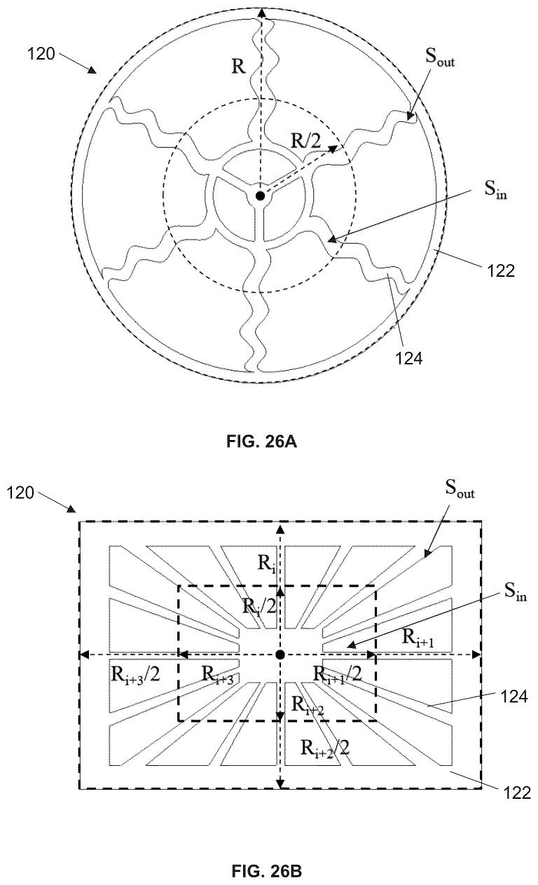

Referring to FIGS. 26A-26B, FIGS. 26A-26B are schematic diagrams illustrating reinforcing members including irregular strip structures according to some embodiments of the present disclosure. In some embodiments, in order to adjust a resonance peak of a vibration component by accurately setting the irregular strip structures, referring to FIG. 26A, a circle with a radius R is defined by a maximum contour of the reinforcing member 120. Meanwhile, ½ of the radius R of the circle defined by the maximum contour is defined as a radius R/2, a horizontal projection area of the reinforcing member 120 within the range of the radius R/2 is defined as Sin, a horizontal projection (i.e., a projection in the vibration direction) area of the reinforcing member 120 within a range between the circle with the radius R/2 and the circle with the radius R is defined as Sout, and the physical quantity t is defined as a ratio of the horizontal projection area Sout of the reinforcing member 120 to the horizontal projection area Sin of the reinforcing member 120:

$$τ = Sout / Sin . \qquad ( Equation 10 )$$

In some embodiments, a mass distribution of the reinforcing member 120 may be controlled by adjusting the ratio τ of the horizontal projection area Sout of the reinforcing member 120 to the horizontal projection area Sin of the reinforcing member 120, thereby controlling the bandwidth of the third resonance peak of the vibration component 100. For other types of reinforcing member 120 having regular structures, referring to FIG. 26B, such as an elliptical, rectangular, square, and other polygonal structures, the maximum contour of the reinforcing member 120 is used to define a graph similar to the reinforcing member 120 for enveloping, a central region of the graph is defined as a reference point, and a distance from the reference point to each point on a contour envelope line is R (e.g., as shown in FIG. 26B, the distances from the reference point to four sides of a rectangular contour envelope line are Rᵢ, Rᵢ₊₁, Rᵢ₊₂, and Rᵢ₊₃). All points corresponding to R/2 (e.g., as shown in FIG. 26B, the points at distances Rᵢ/2, Rᵢ₊₁/2, Rᵢ₊₂/2, and Rᵢ₊₃/2) may form the horizontal projection area Sin of the reinforcing member 120, and the horizontal projection area Sout is between the distance R/2 and the distance R. For other reinforcing member 120 having irregular structures, the maximum contour may be used to define a regular graph with a similar structure for enveloping, and Sin, Sout, and the ratio τ are defined in the same manner as above.

Corresponding to a certain frequency response of the vibration component 100 frequency requiring a low Q value and a broad bandwidth, a relatively large mass may be set to be concentrated in the central region of the reinforcing member 120. In some embodiments, in order to make the central region of the reinforcing member 120 have a relatively large mass, the ratio τ of the horizontal projection area Sout to the horizontal projection area Sin may be within a range of 0.3-2. In some embodiments, in order to make the central region of the reinforcing member 120 have a relatively large mass, the ratio τ of the horizontal projection area Sout to the horizontal projection area Sin may be within a range of 0.5-1.5. In some embodiments, in order to make the central region of the reinforcing member 120 have a relatively large mass, the ratio τ of the horizontal projection area Sout to the horizontal projection area Sin may be within a range of 0.5-1.2. In some embodiments, in order to make the central region of the reinforcing member 120 have a relatively large mass, the ratio τ of the horizontal projection area Sout to the horizontal projection area Sin may be within a range of 0.5-1.3. In some embodiments, in order to make the central region of the reinforcing member 120 have a relatively large mass, the ratio τ of the horizontal projection area Sout to the horizontal projection area Sin may be within a range of 0.5-1.4. In some embodiments, in order to make the central region of the reinforcing member 120 have a relatively large mass, the ratio τ of the horizontal projection area Sout to the horizontal projection area Sin may be within a range of 0.3-1.2. In some embodiments, in order to make the central region of the reinforcing member 120 have a relatively large mass, the ratio τ of the horizontal projection area Sout to the horizontal projection area Sin may be within a range of 0.3-1.6. In some embodiments, in order to make the central region of the reinforcing member 120 have a relatively large mass, the ratio τ of the horizontal projection area Sout to the horizontal projection area Sin may be within a range of 0.5-2. In some embodiments, in order to make the central region of the reinforcing member 120 have a relatively large mass, the ratio τ of the horizontal projection area Sout to the horizontal projection area Sin may be within a range of 0.5-2.2. In some embodiments, in order to make the central region of the reinforcing member 120 have a relatively large mass, the ratio τ of the horizontal projection area Sout to the horizontal projection area Sin may be within a range of 0.3-2.2. In some embodiments, in order to make the central region of the reinforcing member 120 have a relatively large mass, the ratio τ of the horizontal projection area Sout to the horizontal projection area Sin may be within a range of 0.3-2.

Corresponding to a certain frequency response of the vibration component 100 requiring a high Q value and a narrow bandwidth, a relatively large mass may be set to be concentrated in an edge region of the reinforcing member 120. In some embodiments, in order to make the edge region of the reinforcing member 120 have a relatively large mass, the ratio τ of the horizontal projection area Sout to the horizontal projection area Sin may be within a range of 1-3. In some embodiments, in order to make the edge region of the reinforcing member 120 have a relatively large mass, the ratio τ of the horizontal projection area Sout to the horizontal projection area Sin may be within a range of 1.2-2.8. In some embodiments, in order to make the edge region of the reinforcing member 120 have a relatively large mass, the ratio τ of the horizontal projection area Sout to the horizontal projection area Sin may be within a range of 1.4-2.6. In some embodiments, in order to make the edge region of the reinforcing member 120 have a relatively large mass, the ratio τ of the horizontal projection area Sout to the horizontal projection area Sin may be within a range of 1.6-2.4. In some embodiments, in order to make the edge region of the reinforcing member 120 have a relatively large mass, the ratio τ of the horizontal projection area Sout to the horizontal projection area Sin may be within a range of 1.8-2.2. In some embodiments, in order to make the edge region of the reinforcing member 120 have a relatively large mass, the ratio τ of the horizontal projection area Sout to the horizontal projection area Sin may be within a range of 1.2-2. In some embodiments, in order to make the edge region of the reinforcing member 120 have a relatively large mass, the ratio τ of the horizontal projection area Sout to the horizontal projection area Sin may be within a range of 1-2. In some embodiments, in order to make the edge region of the reinforcing member 120 have a relatively large mass, the ratio τ of the horizontal projection area Sout to the horizontal projection area Sin may be within a range of 2-2.8. In some embodiments, in order to make the edge region of the reinforcing member 120 have a relatively large mass, the ratio τ of the horizontal projection area Sout to the horizontal projection area Sin may be within a range of 2-2.5.

In some embodiments, an area of hollow regions (corresponding to a suspension region of the central region 112 within a projection range of the reinforcing member 120) of the reinforcing member 120 may be changed by adjusting a count of the one or more ring structures 122 (which needs to be within a range of 1-10), which may adjust a relationship (the area-thickness ratio μ) between the area of the hollow regions and a thickness of the clastic member 110, thereby adjusting the third resonance peak. The third resonance peak may also be adjusted by changing the relationship (the ratio γ of the areas of the hollow regions) between the areas of the hollow regions between different ring structures 122 of the reinforcing member 120. The first resonance peak, the second resonance peak, and the third resonance peak may be adjusted by changing a relationship (the ratio β of the transverse area of the groove structures of the reinforcing member 120 to a transverse area of the reinforcing member 120) between the transverse area of the plurality of groove structures of the reinforcing member 120 and the transverse area of the reinforcing member 120.

In some embodiments, the one or more ring structures 122 may include a first ring structure and a second ring structure whose centroids coincide with each other. In this case, a radial dimension of the first ring structure may be less than a radial dimension of the second ring structure. In some embodiments, the one or more strip structures 124 may further include at least one first strip structure and at least one second strip structure. The at least one first strip structure may be disposed at an inner side of the first ring structure and connected with the first ring structure. The at least one second strip structure may be disposed between the first ring structure and the second ring structure and may be connected with the first ring structure and the second ring structure, respectively, such that the reinforcing member 120 may form a plurality of different hollow regions.

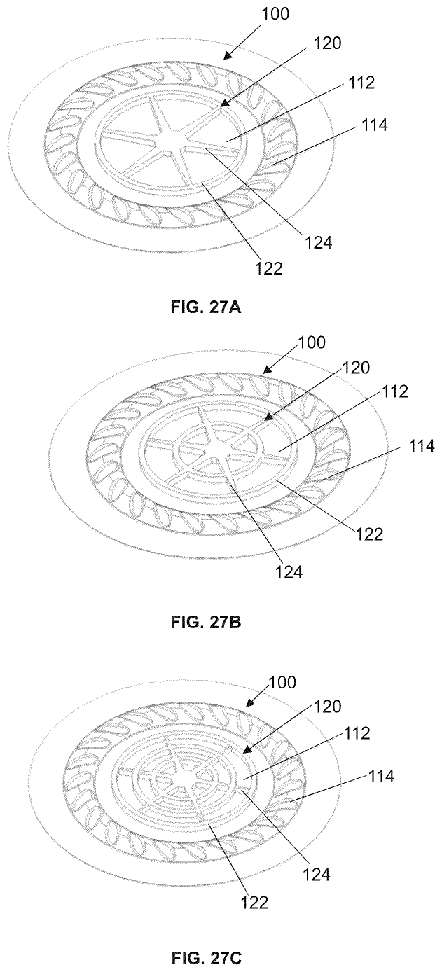

Referring to FIGS. 27A-27C, FIGS. 27A-27C are schematic diagrams illustrating vibration components including different counts of ring structures according to some embodiments of the present disclosure. The one or more ring structures 122 in FIG. 27A may be a single ring structure. The one or more ring structures 122 in FIG. 27B may be a double ring structure. The one or more ring structures 122 in FIG. 27C may be a triple ring structure. By setting the count of the one or more ring structures 122, a mass and a stiffness of the reinforcing member 120 may be adjusted, and the area of the hollow regions of the central region 112 may be adjusted. In some embodiments, the count of the one or more ring structures 122 may be within a range of 1-10. In some embodiments, the count of the one or more ring structures 122 may be within a range of 1-5. In some embodiments, the count of the one or more ring structures 122 may be within a range of 1-3.

In some embodiments, the mass of the reinforcing member 120 may be adjusted by adjusting the count of the one or more ring structures 122, such that the total equivalent mass Mt formed by the combination of the mass of the reinforcing member 120, the mass of the clastic element 110, the equivalent air mass, and the driving end equivalent mass may change, and a resonance frequency of the mass Mt-spring Kt-damping Rt system may change, which in turn causes a first-order resonance frequency of the vibration component 100 to change.

In some embodiments, by adjusting the count of the one or more ring structures 122, the stiffness of the reinforcing member 120 may be adjusted such that the stiffness Kt1 provided to the system by the reinforcing member 120 and the clastic element 110 (especially a region of the central region 112 covered by the reinforcing member 120) may change, which further causes a resonance frequency of a flip movement of the mass Mt1-spring Kt1-damping Rt1 system to change, thereby causing a position of a second resonance peak of the vibration component 100 to change. In some embodiments, by adjusting the count of the one or more ring structures 122, stiffnesses of different positions of the one or more strip structures 124 extending from a center to the surroundings may be different, such that when a driving end frequency is close to the resonance frequency of the Mt1-spring Kt1-damping Rt1 system, the connection region 115, the folded ring region 114, and the local suspension region between the region of the central region 112 covered by the reinforcing member 120 and the folded ring region 114 may be driven to vibrate by the reinforcing member 120, and a resonance peak with an adjustable 3 dB bandwidth may be obtained.

In some embodiments, by adjusting the count of the one or more ring structures 122, areas of the hollow regions of the central region 112 may be adjusted, such that the equivalent mass Mmi, the equivalent stiffness Kai and Kai′, and the equivalent damping Rai and Rai′ of each of the hollow regions may change, thereby causing a position of a third resonance peak of the vibration component 100 to change.

In some embodiments, by adjusting the count of the one or more ring structures 122, the third resonance peak of the vibration component 100 may be within a range of 10 kHz-18 kHz; the area-thickness ratio μ of the area Si of each of the hollow regions to the thickness Hi of the vibration diaphragm at the each of the hollow regions may be within a range of 150-700; the ratio γ of the area Ski to the area Sji of any two of the hollow regions of the clastic element 110 may be within a range of 0.25-4; and the ratio β of the transverse area of the plurality of groove structures of the reinforcing member 120 to the transverse area of the reinforcing member 120 may be within a range of 0.2-0.7. In some embodiments, by adjusting the count of the one or more ring structures 122, the third resonance peak of the vibration component 100 may be within a range of 10 kHz-18 kHz, and the area-thickness ratio μ of the area Si of each of the hollow regions to the thickness Hi of the vibration diaphragm at the each of the hollow regions may be within a range of 100-1000; the ratio γ of the areas Ski to the area Sji of any two of the hollow regions of the elastic element 110 may be within a range of 0.1-10; and the ratio β of the transverse area of the plurality of groove structures of the reinforcing member 120 to the transverse area of the reinforcing member 120 may be within a range of 0.1-0.8.

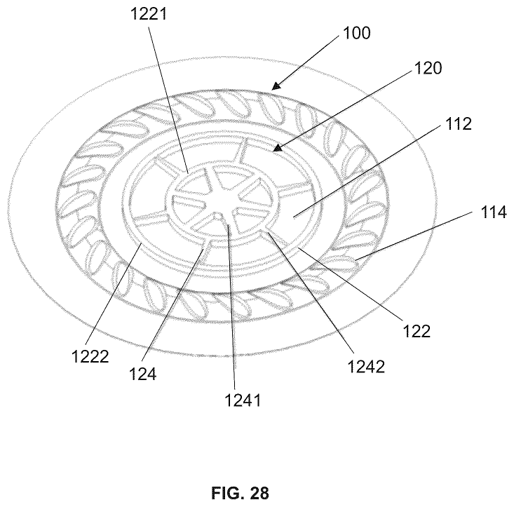

Referring to FIG. 28, FIG. 28 is a schematic diagram illustrating a vibration component including discontinuous strip structures corresponding to an inner ring and an outer ring according to some embodiments of the present disclosure. In some embodiments, when the vibration component 100 includes at least two ring structures, the two ring structures 122 may divide the one or more strip structures 124 into a plurality of region along a direction extending from the center to the surroundings, and the one or more strip structures 124 in the plurality of regions may be arranged continuously or discontinuously. For example, the one or more ring structures 122 may include a first ring structure 1221 and a second ring structure 1222 whose centroids coincide. A radial dimension of the first ring structure 1221 may be less than a radial dimension of the second ring structure 1222. The one or more strip structures 124 may include at least one first strip structure 1241 and at least one second strip structure 1242. The at least one first strip structure 1241 may be disposed at an inner side of the first ring structure 1221 and connected with the first ring structure 1221, and the at least one second strip structure 1242 may be disposed between the first ring structure 1221 and the second ring structure 1222 and connected with the first ring structure 1221 and the second ring structure 1222, respectively. In some embodiments, the at least one first strip structure 1241 and the at least one second strip structure 1242 may be connected at different positions of the first ring structure 1221. In some embodiments, a count of the first strip structure 1241 and a count of the second strip structure 1242 may be the same or different.

With the discontinuous setting of the one or more strip structures 124 in the inner and outer regions of the one or more ring structures 122, the counts of the one or more strip structures 124 in the inner and outer regions of the one or more ring structures 122 may be different, transverse widths of the one or more strip structures 124 in the inner and outer regions may be different, and transverse shapes of the one or more strip structures 124 in the inner and outer regions may be different, such that a mass, a stiffness, and a centroid distribution of the reinforcing member 120, and a count and areas of the hollow regions of the central region 112 may be adjusted in a wide range.

In some embodiments, by adjusting the mass of the reinforcing member 120, the total equivalent mass Mt may change, and a resonance frequency of the mass Mt-spring Kt-damping Rt system may change, which in turn causes a first-order resonance frequency of the vibration component 100 to change. By adjusting the stiffness of the reinforcing member 120, a resonance frequency of a flip movement of the Mt1-spring Kt1-damping Rt1 system may be adjusted, thereby causing a position of a second resonance peak of the vibration component 100 to change, such that stiffness distributions of different positions of the one or more strip structures 124 extending from the center to the surroundings may be different, and a second resonance peak of the vibration component 100 with an adjustable 3 dB bandwidth may be obtained. By adjusting the count and the areas of the hollow regions of the central region 112, a position of a third resonance peak and a sensitivity of the vibration component 100 may change.

In some embodiments, by discontinuously setting the one or more strip structures 124 in the inner and outer regions of the one or more ring structures 122, the third resonance peak of the vibration component 100 may be within a range of 10 kHz-18 kHz, the area-thickness ratio μ of the area Si of each of the hollow regions to the thickness Hi of the elastic element 110 at the each of the hollow regions may be within a range of 150-700, the ratio γ of the area Ski to the area Sji of any two of the hollow regions of the elastic element 110 may be within a range of 0.25-4, and the ratio β of the transverse area of the plurality of groove structures of the reinforcing member 120 to the transverse area of the reinforcing member 120 may be within a range of 0.2-0.7. In some embodiments, by discontinuously setting the one or more strip structures 124 in the inner and outer regions of the one or more ring structures 122, the third resonance peak of the vibration component 100 may be within a range of 10 kHz-18 kHz, the area-thickness ratio μ of the area Si of each of the hollow regions to the thickness Hi the elastic element 110 at the each of the hollow regions may be within a range of 100-1000, the ratio γ of the area Ski to the area Sji of any two of the hollow regions of the elastic element 110 may be within a range of 0.1-10, and the ratio β of the transverse area of the plurality of groove structures of the reinforcing member 120 to the transverse area of the reinforcing member 120 may be within a range of 0.1-0.8.

Referring to FIG. 29, FIG. 29 is a schematic diagram illustrating a vibration component including a plurality of ring structures according to some embodiments of the present disclosure. In some embodiments, spacing regions of the plurality of ring structures 122 may be adjusted by setting the plurality of ring structures 122, and a mass distribution of the reinforcing member 120 may be adjusted by setting a count of the one or more strip structures 124 in different spacing regions. It should be noted that the count of the one or more strip structures 124 disposed in different spacing regions of the plurality of ring structures 122 may be different, shapes of the one or more strip structures 124 disposed in different spacing regions may be different, and positions of the one or more strip structures 124 disposed in different spacing regions may not be corresponding.

In some embodiments, the one or more ring structures 122 may include, from the center outward, the first ring structure 1221, the second ring structure 1222, the third ring structure 1223, . . . and an nth ring structure. The strip structure 122 in a spacing region between the nth ring structure and an (n−1)th ring structure is an nth strip structure (e.g., the first strip structure 1241, the second strip structure 1242, and the third strip structure 1243). A count of the nth strip structure is defined as Qn, wherein n is a natural number. A physical quantity q is defined as a ratio of the count Qi of any ith strip structure to a count Qj of any jth strip structure:

$$q = Qi / Qj . \qquad ( Equation 11 )$$

In some embodiments, the ratio of the count Qi of any ith strip structure to the count Qj of any jth strip structure may be within a range of 0.05-20. In some embodiments, the ratio of the count Qi of any ith strip structure to the count Qj of any jth strip structure may be within a range of 0.1-10. In some embodiments, the ratio of the count Qi of any ith strip structure to the count Qj of any jth strip structure may be within a range of 0.1-8. In some embodiments, the ratio of the count Qi of any ith strip structure to the count Qj of any jth strip structure may be within a range of 0.1-6. In some embodiments, the ratio of the count Qi of any ith strip structure to the count Qj of any jth strip structure may be within a range of 0.5-6. In some embodiments, the ratio of the count Qi of any ith strip structure to the count Qj of any jth strip structure may be within a range of 1-4. In some embodiments, the ratio of the count Qi of any ith strip structure to the count Qj of any jth strip structure may be within a range of 1-2. In some embodiments, the ratio of the count Qi of any ith strip structure to the count Qj of any jth strip structure may be within a range of 0.5-2.

In some embodiments, shapes of the one or more ring structures 122 may include at least one of a circular ring, an elliptical ring, a polygonal ring, and a curved ring. By setting the one or more ring structures 122 with different shapes and/or different sizes, a mass and a stiffness of the reinforcing member 120 may be adjusted, and areas of hollow regions of the central region 112 may be adjusted.

In some embodiments, the reinforcing member 120 may achieve a certain bending deformation in a frequency band by adjusting a relationship between a dimension of the suspension region 1121 and an area of the central region 112, such that acoustic pressures of different regions of the elastic element 110 may be superimposed to increase or decrease each other, thus achieving a maximum sound pressure level output. In some embodiments, the ratio l of the horizontal projection area Sv of the suspension region 1121 to the horizontal projection area Sc of the central region 112 (also referred to as a central portion of a vibration diaphragm) of the vibration component 100 may be within a range of 0.05-0.7. In some embodiments, the ratio l of the horizontal projection area Sv of the suspension region 1121 to the horizontal projection area Sc of the central portion of the vibration diaphragm of the vibration component 100 may be within a range of 0.1-0.5. In some embodiments, the ratio l of the horizontal projection area Sv of the suspension region 1121 to the horizontal projection area Sc of the central portion of the vibration diaphragm of the vibration component 100 may be within a range of 0.15-0.35.

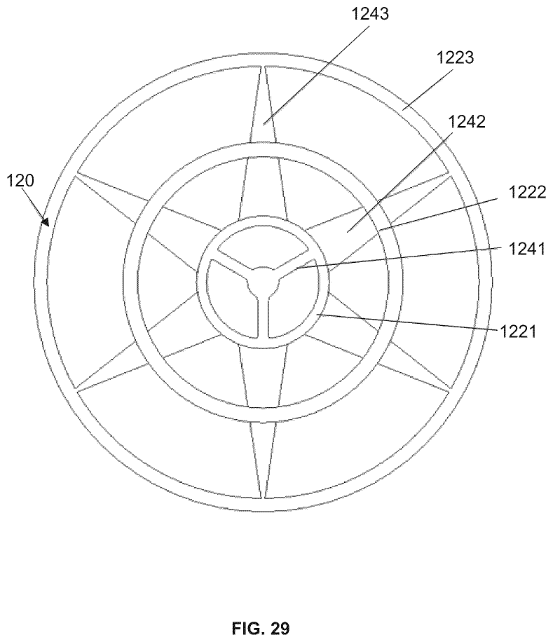

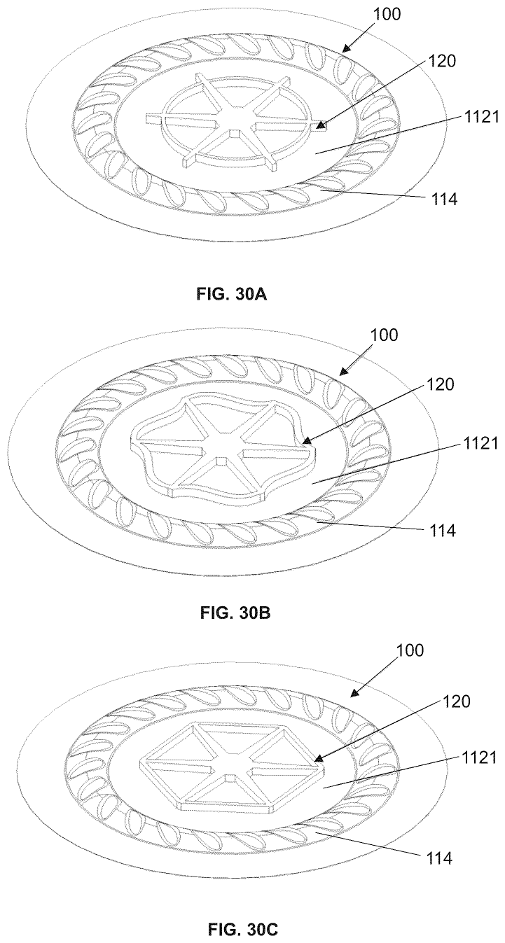

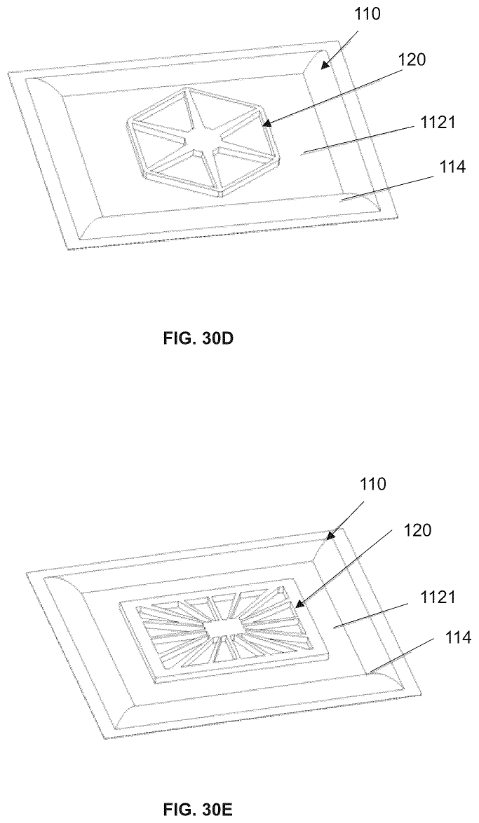

Referring to FIGS. 30A-30E, FIGS. 30A-30E are schematic diagrams illustrating vibration components having different structures according to some embodiments of the present disclosure. In some embodiments, an outer contour of the reinforcing member 120 may be a structure with outwardly extending spokes (as shown in FIG. 30A), a circular ring structure, an elliptical ring structure, or a curved ring structure (as shown in FIG. 30B), a polygonal shape, other irregular ring structures, or the like, wherein the polygonal shape may include a triangle, a quadrangle, a pentagon, a hexagon (as shown in FIG. 30C-30D), a heptagon, an octagon, an enneagon, a decagon, etc. In some embodiments, the clastic element 110 may also have a polygonal shape, such as a triangle, a quadrangle (as shown in FIG. 30D and FIG. 30E), a pentagon, a hexagon, a heptagon, an octagon, an enneagon, a decagon, or the like, or other irregular shapes. The reinforcing member 120 may be correspondingly set in a similar or non-similar structure, so as to control a shape of the suspension region 1121 through shapes of the reinforcing member 120, the central region 112, a folded ring of the folded ring region 114, thereby adjusting the performance of the vibration component 100.

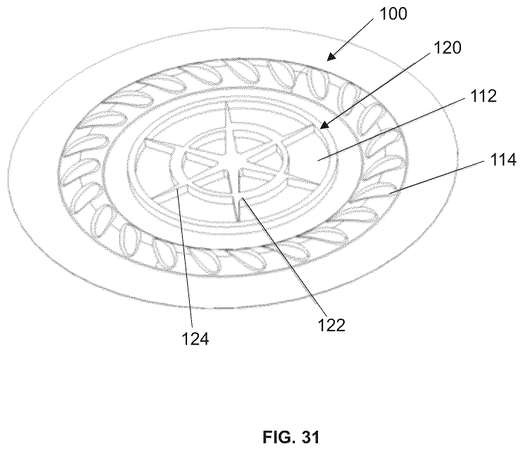

Referring to FIG. 31, FIG. 31 is a schematic diagram illustrating a vibration component including variable-width ring structures according to some embodiments of the present disclosure. In some embodiments, by setting local structures of unequal widths at different positions of any one of the one or more ring structures 122, a mass of the reinforcing member 120 may be effectively adjusted, the total equivalent mass Mt may change, and a resonance frequency of the mass Mt-spring Kt-damping Rt system may change, which in turn causes a first-order resonance frequency of the vibration component 100 to change. Meanwhile, by setting the local structures of unequal widths at different positions (e.g., adjacent positions) of any one of the one or more ring structures 122, a stiffness and a centroid distribution of the reinforcing member 120 may be adjusted, so as to adjust a resonance frequency of a flip movement of the Mt1-spring Kt1-damping Rt1 system, which causes a position of a second resonance peak of the vibration component 100 to change. The one or more strip structures 122 with unequal widths may make the one or more strip structures 124 extending from the center to the surroundings have different stiffness distributions at different positions, thereby obtaining the second resonance peak of the vibration component 100 with an adjustable 3 dB bandwidth. In addition, the setting of the one or more strip structures 122 with unequal widths may also adjust a count and an area of the suspension region of the central region 112, such that a position of a third resonance peak and a sensitivity of the vibration component 100 may change.

In some embodiments, by setting local structures with unequal widths at any position (e.g., adjacent positions) of any one of the one or more ring structures 122, the third resonance peak of the vibration component 100 may be within a range of 15 kHz-18 kHz, the area-thickness ratio μ of the area Si of each of the hollow regions to the thickness Hi of the clastic element 110 at the each of the hollow regions may be within a range of 150-700, the ratio γ of the area Ski to the area Sji of any two of the hollow regions of the elastic element 110 may be within a range of 0.25-4, and the ratio β of the transverse area of the plurality of groove structures of the reinforcing member 120 to the transverse area of the reinforcing member 120 may be within a range of 0.2-0.7. In some embodiments, by setting the local structures with unequal widths at any position of any one of the one or more ring structures 122, the third resonance peak of the vibration component 100 may be within a range of 15 kHz-18 kHz, the area-thickness ratio μ of the area Si of each of the hollow regions to the thickness Hi of the clastic element 110 at the each of the hollow regions may be within a range of 100-1000, the ratio γ of the area Ski to the area Sji of any two of the hollow regions of the elastic element 110 may be within a range of 0.1-10, and the ratio β of the transverse area of the plurality of groove structures of the reinforcing member 120 to the transverse area of the reinforcing member 120 may be within a range of 0.1 to 0.8.

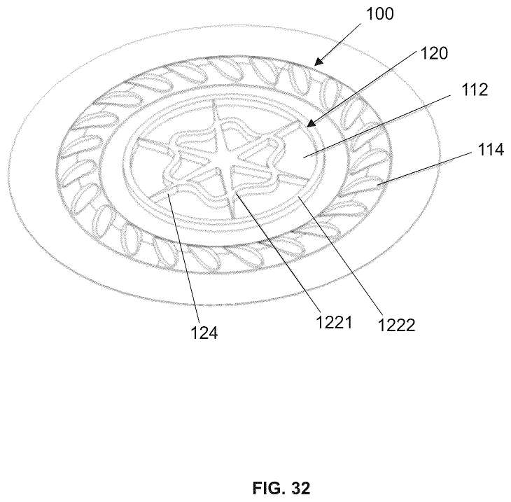

Referring to FIG. 32, FIG. 32 is a schematic diagram illustrating a vibration component including irregular ring structures according to some embodiments of the present disclosure. In some embodiments, by setting local structures of different positions of different ring structures 122, such as a circle, a rectangle, a square, a triangle, a hexagon, an octagon, and other polygons, an ellipse, and other irregular ring structures 122, dimensions, positions, and shapes of local regions of the one or more ring structures 122 may be more flexibly adjusted, a mass of the reinforcing member 120 may be effectively adjusted, and the total equivalent mass Mt may change, such that a resonance frequency of the system of the mass Mt-spring Kt-damping Rt may change, which in turn causes a first resonance frequency of the vibration component 100 to change. By adjusting a stiffness of the reinforcing member 120 and a centroid distribution of the reinforcing member 120, a resonance frequency of a flip movement of the Mt1-spring Kt1-damping Rt1 system may be adjusted, a position of a second resonance peak of the vibration component 100 may change, and stiffness distributions of different positions of the one or more strip structure 124 extending from a center to the surroundings may be different, thereby obtaining a second resonance peak of the vibration component 100 with an adjustable 3 dB bandwidth. Meanwhile, a count and an area of the suspension region of the central region 112 may be effectively adjusted, such that a position of a third resonance peak and a sensitivity of the vibration component 100 may change. In addition, by setting the irregular structures, the stress concentration may be effectively avoided, such that the deformation of the reinforcing member 120 may be smaller.

In some embodiments, referring to FIG. 32, the reinforcing member 120 may include a double ring structure. The double ring structure may include the first ring structure 1221 disposed at an inner side and a second ring structure 1222 disposed at an outer side. In some embodiments, shapes of the first ring structure 1221 and the second ring structure 1222 may be different. In some embodiments, the first ring structure 1221 may be a curved ring, and the second ring structure 1222 may be a circular ring. In some embodiments, by setting irregular ring structures 122, the third resonance peak of the vibration component 100 may be within a range of 15 kHz-18 kHz, the area-thickness ratio μ of the area Si of each of the hollow regions to the thickness Hi of the elastic element 110 at the each of the hollow regions may be within a range of 150-700, the ratio γ of the area Ski to the area Sji of any two of the hollow regions of the clastic element 110 may be within a range of 0.25-4, and the ratio β of the transverse area of the plurality of groove structures of the reinforcing member 120 to the transverse area of the reinforcing member 120 may be within a range of 0.2-0.7. In some embodiments, by setting the irregular ring structures 122, the third resonance peak of the vibration component 100 may be within a range of 15 kHz-18 kHz, the area-thickness ratio μ of the area Si of each of the hollow regions to the thickness Hi of the clastic element 110 at the each of the hollow regions of the clastic element 110 may be within a range of 100-1000, the ratio γ of the area Ski to the area Sji of any two of the hollow regions of the elastic element 110 may be within a range of 0.1-10, and the ratio β of the transverse area of the plurality of groove structures of the reinforcing member 120 to the transverse area of the reinforcing member 120 may be within a range of 0.1-0.8.

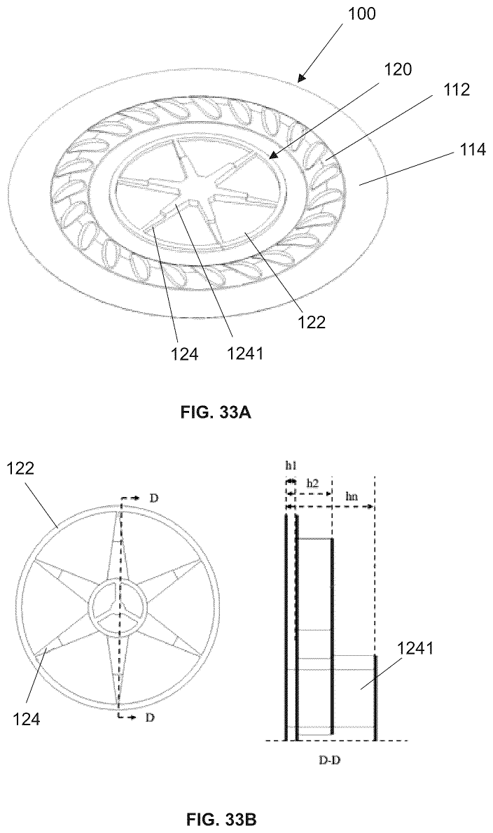

Referring to FIG. 33A-FIG. 33B, FIG. 33A is a schematic diagram illustrating a vibration component including one or more strip structures having step structures according to some embodiments of the present disclosure. FIG. 33B is a schematic diagram illustrating a vibration component including one or more strip structures having step structures according to some embodiments of the present disclosure. In some embodiments, referring to FIG. 33A, by setting the reinforcing member 120 including the one or more strip structure 124 having the step structures, a stiffness, a mass, and a centroid distribution of the reinforcing member 120 may be changed without changing hollow regions (affecting a third resonance peak of the vibration component 100) and the suspension regions 1121 of the central region 112, thereby effectively adjusting positions and bandwidths of a first resonance peak and a second resonance peak of the vibration component 100 without changing the third resonance peak of the vibration component 100. In such cases, different frequency response curves may be adjusted according to the actual application requirements.

In some embodiments, by setting thicknesses of different regions of the reinforcing member 120 in a thickness direction (i.e., in a vibration direction of the vibration component 100), a mass distribution according to the actual requirements may be obtained, and the stiffness of the reinforcing member 120 may be changed without changing or changing the mass of the reinforcing member 120, such that the stiffness Kt1 provided to the system by the reinforcing member 120 and the clastic element 110 may change, which causes a resonance frequency of a flip movement of the mass Mt1-spring Kt1-damping Rt1 system to change, thus causing the position of the second resonance peak of the vibration component 100 to change. Further, a 3 dB bandwidth of the second resonance peak of the vibration component 100 may be controlled.

As shown in FIG. 33 B, FIG. 33 B illustrates a structure of the reinforcing member 120 having the stepped strip structures 124, and a cross-sectional structure on a D-D cross section thereof. A thickness of a outermost step of the reinforcing member 120 is defined as h1, a thickness of a secondary step of the reinforcing member 120 is defined as h2 . . . , a thickness of a central step is defined as hn, and a physical quantity ϵ is defined as a ratio of thicknesses hj and hk (k>j) of any two steps:

$$ϵ = hj / hk . \qquad ( Equation 12 )$$

A physical quantity φ is defined as a ratio of the thickness h1 of the outermost step of the reinforcing member 120 to the thickness hn of the central step:

$$φ = h 1 / hn . \qquad ( Equation 13 )$$

In some embodiments, in order to ensure a strength of the reinforcing member 120, the ratio ϵ of the thicknesses hj and hk of any two steps may be within a range of 0.1-10. In some embodiments, in order to ensure the strength of the reinforcing member 120, the ratio ϵ of the thicknesses hj and hk of any two steps may be within a range of 0.1-8. In some embodiments, in order to ensure the strength of the reinforcing member 120, the ratio ϵ of the thicknesses hj and hk of any two steps may be within a range of 0.2-8. In some embodiments, in order to ensure the strength of the reinforcing member 120, the ratio ϵ of the thicknesses hj and hk of any two steps may be within a range of 0.1-7. In some embodiments, in order to ensure the strength of the reinforcing member 120, the ratio ϵ of the thicknesses hj and hk of any two steps may be within a range of 0.1-6. In some embodiments, in order to ensure the strength of the reinforcing member 120, the ratio ϵ of the thicknesses hj and hk of any two steps may be within a range of 0.2-6. In some embodiments, in order to ensure the strength of the reinforcing member 120, the ratio ϵ of the thicknesses hj and hk of any two steps may be within a range of 0.2-5.

Corresponding to a certain frequency response of the vibration component 100 requiring a low Q value and a broad bandwidth, a relatively large mass may be concentrated near a center of the reinforcing member 120. In some embodiments, in order to make the central region of the reinforcing member 120 have a relatively large mass, the ratio φ of the thickness h1 of the outermost step of the reinforcing member 120 to the thickness hn of the central step may be within a range of 0.1-1. In some embodiments, in order to make the central region of the reinforcing member 120 have a relatively large mass, the ratio φ of the thickness h1 of the outermost step of the reinforcing member 120 to the thickness hn of the central step may be within a range of 0.2-0.8. In some embodiments, in order to make the central region of the reinforcing member 120 have a relatively large mass, the ratio φ of the thickness h1 of the outermost step of the reinforcing member 120 to the thickness hn of the central step may be within a range of 0.2-0.6. In some embodiments, in order to make the central region of the reinforcing member 120 have a relatively large mass, the ratio φ of the thickness h1 of the outermost step of the reinforcing member 120 to the thickness hn of the central step may be within a range of 0.2-0.4.

Corresponding to a certain frequency response of the vibration component 100 requiring a high Q value and a narrow bandwidth, a relatively large mass may be concentrated in an edge region of the reinforcing member 120. In some embodiments, in order to make the edge region of the reinforcing member 120 have a relatively large mass, the ratio φ of the thickness h1 of the outermost step of the reinforcing member 120 to the thickness hn of the central step may be within a range of 1-10. In some embodiments, in order to make the edge region of the reinforcing member 120 have a relatively large mass, the ratio φ of the thickness h1 of the outermost step of the reinforcing member 120 to the thickness hn of the central step may be within a range of 1.2-6. In some embodiments, in order to make the edge region of the reinforcing member 120 have a relatively large mass, the ratio φ of the thickness h1 of the outermost step of the reinforcing member 120 to the thickness hn of the central step may be within a range of 2-6. In some embodiments, in order to make the edge region of the reinforcing member 120 have a relatively large mass, the ratio φ of the thickness h1 of the outermost step of the reinforcing member 120 to the thickness hn of the central step may be within a range of 3-6. In some embodiments, in order to make the edge region of the reinforcing member 120 have a relatively large mass, the ratio φ of the thickness h1 of the outermost step of the reinforcing member 120 to the thickness hn of the central step may be within a range of 4-6. In some embodiments, in order to make the edge region of the reinforcing member 120 have a relatively large mass, the ratio φ of the thickness h1 of the outermost step of the reinforcing member 120 to the thickness hn of the central step may be within a range of 5-6.

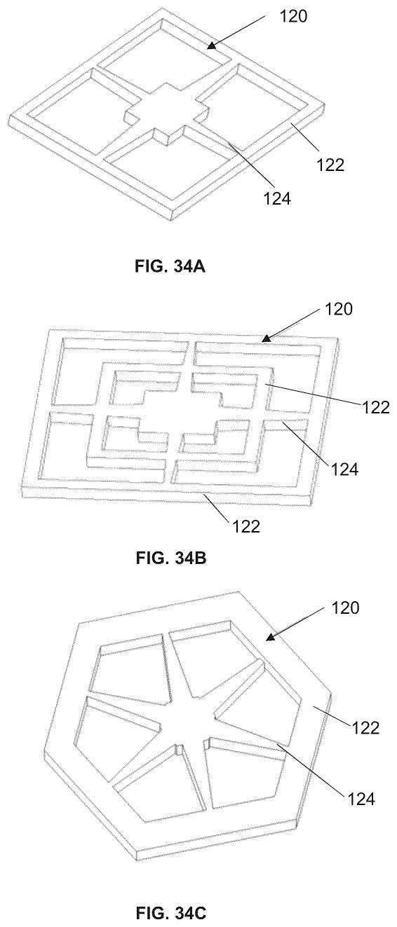

Referring to FIGS. 34A-34C, FIGS. 34A-34C are schematic diagrams illustrating vibration components including different shapes of reinforcing members according to some embodiments of the present disclosure. A shape of the reinforcing member 120 in FIG. 34A may be a rectangle, the one or more ring structures 122 may have a single ring rectangular structure, and the one or more strip structures 124 may have a trapezoidal structure. A shape of the reinforcing member 120 in FIG. 34 B may be a rectangle, the one or more ring structures 122 may have a double ring rectangular structure, and the one or more strip structures 124 may have a trapezoidal structure. A shape of the reinforcing member 120 in FIG. 34C may be a hexagon, the one or more ring structures 122 may have a single ring hexagonal structure, and the one or more strip structures 124 may have a trapezoidal structure. In some embodiments, the shape of the reinforcing member 120 of the vibration component 100 may match the shape of the elastic element 110. The structure of the clastic element 110 may also have various shapes, such as a circle, a square, a polygonal, or the like. The corresponding reinforcing member 120 may have different shapes, including, but not limited to, a circle, a square (e.g., a rectangle and a square), a triangle, a hexagon, an octagon, other polygons, an ellipse, and other irregular structures.

Different shapes of the reinforcing member 120 and different shapes of the elastic elements 110 may be flexibly set to change a mass and a stiffness of the reinforcing member 120, a mass and a stiffness of the vibration component 100, etc., so as to change a resonance frequency of the vibration component 100.

In some embodiments, the shape of the reinforcing member 120 and the shape of the clastic element 110 may both include various different shapes. In this case, the one or more strip structures 124 extending from the central region 112 to the surroundings may have different widths and different shapes in a transverse direction thereof. The one or more ring structures 122 may also have different shapes, counts, and dimensions. The one or more ring structures 122 may be set as a whole ring, or as a local ring structure 122. Different ring structures 122 may divide the one or more strip structures 124 into different regions. In the different regions, the one or more strip structures 124 of different regions extending from a center to the surroundings may be continuous or staggered, and counts of the one or more strip structures 124 of different regions may be the same or different. In some embodiments, the one or more ring structures 122 may also be a circle, a square (e.g., the rectangle and the square), a triangle, a hexagon, an octagon, other polygons, an ellipse, and other irregular structures.

In some embodiments, by setting the vibration component 100 including the reinforcing member 120 with different shapes, a third resonance peak of the vibration component 100 may be within a range of 10 KHz-18 kHz; the area-thickness ratio μ of the area Si of each of the hollow regions to the thickness Hi of the clastic element 110 at the each of the hollow regions may be within a range of 150-700; the ratio γ of the area Ski to the area Sji of any two of the suspension regions of the elastic element 110 may be within a range of 0.25-4; and the ratio β of a transverse area of the plurality of groove structures of the reinforcing member 120 to a transverse area of the reinforcing member 120 may be within a range of 0.2-0.7. In some embodiments, by setting the vibration component 100 including the reinforcing member 120 with different shapes, the third resonance peak of the vibration component 100 may be within a range of 10 kHz-18 kHz; the area-thickness ratio μ of the area Si of each of the hollow regions to the thickness Hi of the elastic element 110 at the each of the hollow regions may be within a range of 100-1000; the ratio γ of the area Ski to the area Sji of any two of the suspension regions of the clastic element 110 may be within a range of 0.1-10; and the ratio β of the transverse area of the plurality of groove structures of the reinforcing member 120 to the transverse area of the reinforcing member 120 may be within a range of 0.1-0.8.

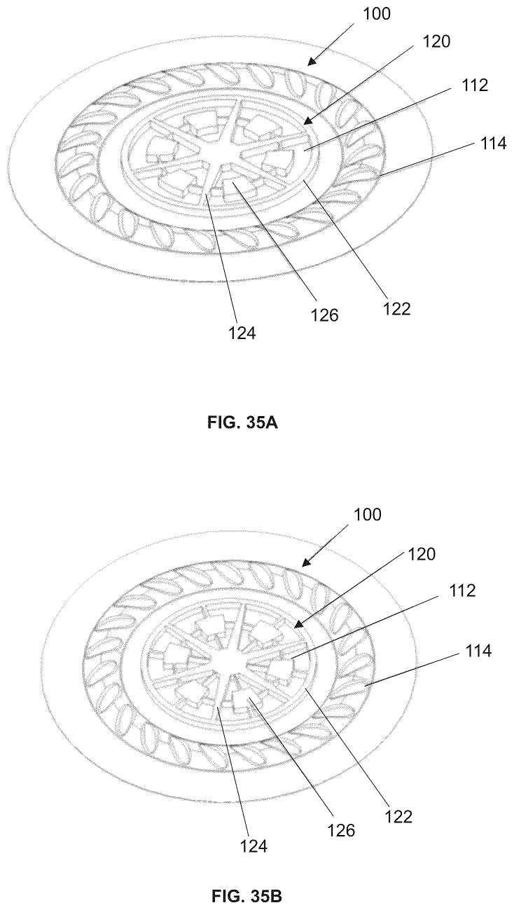

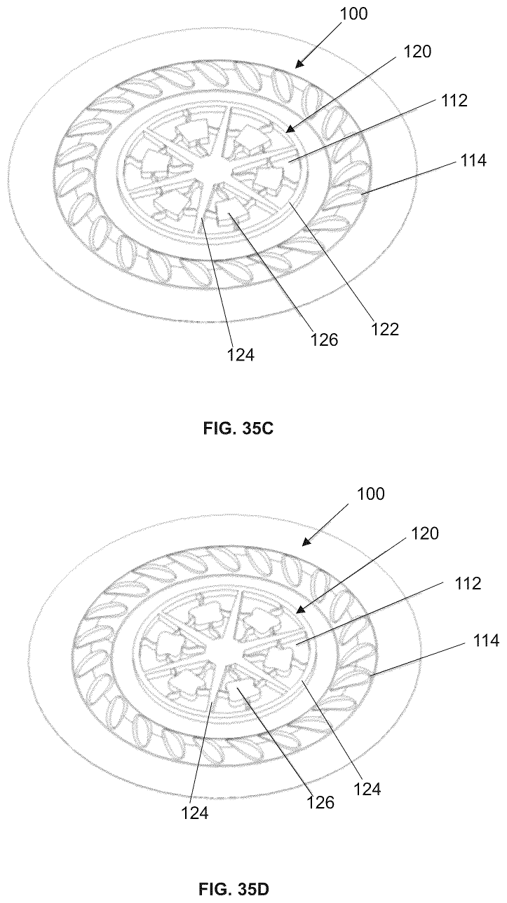

Referring to FIGS. 35A-35D, FIGS. 35A-35D are schematic diagrams illustrating vibration components including local mass structures according to some embodiments of the present disclosure. FIG. 35A illustrates local mass structures 126 of double clastic connection. FIG. 35B illustrates the local mass structures 126 of quadruple clastic connection. FIG. 35C illustrates local mass structures 126 of S-shaped quadruple elastic connection. FIG. 35D illustrates irregular local mass structures 126 of S-shaped quadruple elastic connection. In some embodiments, the equivalent mass Mmi, the equivalent stiffness Kai and Kai′, and the equivalent damping Rai and Rai′ of the hollow regions may be flexibly adjusted by setting the local mass structures 126 in the suspension regions of the central region 112, such that a third resonance peak of the vibration component 100 may be effectively adjusted. Meanwhile, by setting the local mass structures 126, a mass and a stiffness of the reinforcing member 120 may be adjusted in a relatively large range, thereby adjusting a first resonance peak and a second resonance peak of the vibration component 100.

In some embodiments, the local mass structures 126 may be annularly connected to the adjacent strip structures 124 (as shown in FIG. 31) through double elastic structures, or may be annularly connected to the adjacent ring structures 122 through the double elastic structures. In some embodiments, the local mass structures 126 may not be connected to the one or more strip structures 124 or the one or more ring structures 122, and may only be connected to the clastic element 110.

In some embodiments, the local mass structures 126 may also be connected to both the adjacent strip structures 124 and the adjacent ring structures 122 through quadruple clastic structures (as shown in FIG. 35B). In some embodiments, plane shapes of the clastic structures may be regular (as shown in FIG. 35A and FIG. 35B) or irregular (as shown in FIG. 35C). In some embodiments, the local mass structures 126 may have regular shapes (as shown in FIGS. 35A-35C) or may have arbitrary irregular shapes (as shown in FIG. 35D).

In some embodiments, by setting dimensions, positions, counts, and shapes of the local mass structures 126, and dimensions, positions, counts, and shapes of the elastic connection structures, a third resonance peak of the vibration component 100 may be within a range of 10 kHz-18 kHz; the area-thickness ratio μ of the area Si of each of the hollow regions to the thickness Hi of the clastic element 110 at the each of the hollow regions may be within a range of 150-700; the ratio γ of the area Ski to the area Sji of any two of the hollow regions of the clastic element 110 may be within a range of 0.25-4; and the ratio β of a transverse area of the plurality of groove structures of the reinforcing member 120 to a transverse area of the reinforcing member 120 may be within a range of 0.2-0.7. In some embodiments, by setting the dimensions, the positions, the counts, and the shapes of the local mass structures 126, and the dimensions, the positions, the counts, and the shapes of the clastic connection structures, the third resonance peak of the vibration component 100 may be within a range of 10 kHz-18 kHz; the area-thickness ratio μ of the area Si of each of the hollow regions to the thickness Hi of the clastic element 110 at the each of the hollow regions may be within a range of 100-1000; the ratio γ of the area Ski to the area Sji of any two of the suspension regions of the elastic element 110 may be within a range of 0.1-10; and the ratio β of the transverse area of the plurality of groove structures of the reinforcing member 120 to the transverse area of the reinforcing member 120 may be within a range of 0.1-0.8.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification arc not necessarily all referring to the same embodiment. Furthermore, the particular features, structures, or features may be combined as suitable in one or more embodiments of the present disclosure.

In addition, the order of processing elements and sequences, the use of numerical letters, or the use of other names described herein are not intended to qualify the order of the processes and methods of the present application unless expressly stated in the claims. Although the above disclosure discusses through various examples that are currently considered to be various useful embodiments of the disclosure, it is to be understood that such detail is solely for the purpose of illustration, and that the appended claims are not limited to the disclosed embodiments, but, on the contrary, are intended to cover modifications and equivalent combinations that are within the spirit and scope of the disclosed embodiments.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

1. A vibration component, comprising:
an elastic element including a central region, a folded ring region disposed at a periphery of the central region, and a fixed region disposed at a periphery of the folded ring region, wherein the elastic element is configured to vibrate in a direction perpendicular to the central region, the central region includes an elastic member and a reinforcing member stacked in a vibration direction, and the reinforcing member is provided with a plurality of groove structures whose openings face the elastic member.

2. The vibration component of claim 1, wherein a hollow structure is disposed in a region of the reinforcing member apart from the plurality of groove structures.

3. The vibration component claim 2, wherein in the vibration direction, a ratio of a projection area of the reinforcing member to a projection area of the central region is within a range of 0.15-0.8.

4. (canceled)

5. The vibration component of claim 2, wherein when vibrating, the vibration component has a resonance peak at least within a range of 10000 Hz-20000 Hz.

6. The vibration component of claim 1, wherein each of the plurality of groove structures has a height dimension in the vibration direction, a side wall of each of the plurality of groove structures has a thickness dimension, and a ratio of the height dimension to the thickness dimension is not less than 7.14.

7. (canceled)

8. The vibration component of claim 6, wherein
when vibrating, the vibration component has a resonance peak at least within a range of 5000 Hz-10000 Hz.

9. The vibration component of claim 1, wherein each of the plurality of groove structures has a height dimension in the vibration direction, and the height dimension is within a range of 50 μm-500 μm.

10. (canceled)

11. The vibration component of claim 1, wherein the side wall of each of the plurality of groove structures has a thickness dimension, and the thickness dimension is not greater than 50 μm.

12. (canceled)

13. The vibration component of claim 1, wherein a skirt structure extending along a surface of the elastic member is disposed around the opening of each of the plurality of groove structures, and a width of the skirt structure is within a range of 100 μm-300 μm.

14. (canceled)

15. The vibration component of claim 1, wherein a shape of each of the plurality of groove structures includes at least one of a U-shape, a T-shape, an I-shape, and a cone.

16. The vibration component of claim 1, wherein a Young's modulus of a material of the reinforcing member is greater than a Young's modulus of a material of the elastic member; or
the material of the reinforcing member is the same as the material of the elastic member.

17. (canceled)

18. The vibration component of claim 1, wherein a filling material is disposed in each of the plurality of groove structures, and a Young's modulus of the filling material is less than a Young's modulus of the material of the reinforcing member.

19. A vibration component, comprising:
an elastic element including a central region, a folded ring region disposed at a periphery of the central region, and a fixed region disposed at a periphery of the folded ring region, wherein the elastic element is configured to vibrate in a direction perpendicular to the central region, the central region includes an elastic region and a reinforcing region arranged side by side, and the reinforcing region is provided with a plurality of groove structures whose openings face the vibration direction.

20. The vibration component of claim 19, wherein in the vibration direction, a ratio of a projection area of the reinforcing region to a projection area of the central region is within a range of 0.15-0.8.

21. (canceled)

22. The vibration component of claim 20, wherein when vibrating, the vibration component has a resonance peak at least within a range of 10000 Hz-20000 Hz.

23. The vibration component of claim 19, wherein each of the plurality of groove structures has a height dimension in the vibration direction, a side wall of each of the plurality of groove structures has a thickness dimension, and a ratio of the height dimension to the thickness dimension is not less than 7.14.

24. (canceled)

25. The vibration component of claim 23, wherein when vibrating, the vibration component has a resonance peak at least within a range of 5000 Hz-10000 Hz.

26. The vibration component of claim 19, wherein each of the plurality of groove structures has a height dimension in the vibration direction, and the height dimension is within a range of 50 μm-500 μm.

27. (canceled)

28. The vibration component of claim 19, wherein the side wall of each of the plurality of groove structures has a thickness dimension, and the thickness dimension is not greater than 50 μm.

29. (canceled)

30. The vibration component of claim 19, wherein a skirt structure connected with the elastic region is disposed around the opening of each of the plurality of groove structures, and a width of the skirt structure is within a range of 100 μm-300 μm.

31-35. (canceled)
